(19) United States
(12) Patent Application Publication
(10) Pub. No.: US 2014/0095263 A1
(43) Pub. Date: Apr. 3, 2014

(54) COMPREHENSIVE COST MODELING OF SUSTAINABLY AUTOGENOUS SYSTEMS AND PROCESSES FOR THE PRODUCTION OF ENERGY, MATERIAL RESOURCES AND NUTRIENT REGIMES

(71) Applicants: Roy Edward McAlister, Phoenix, AZ (US); Richard Glenn Otto, Chandler, AZ (US)

(72) Inventors: Roy Edward McAlister, Phoenix, AZ (US); Richard Glenn Otto, Chandler, AZ (US)

(73) Assignee: McAlister Technologies, LLC, Phoenix, AZ (US)

(21) Appl. No.: 13/584,780

(22) Filed: Aug. 13, 2012

Related U.S. Application Data
(60) Provisional application No. 61/523,220, filed on Aug. 12, 2011.

(51) Int. Cl. G06Q 30/02

(52) U.S. Cl. CPC G06Q 30/0206
USPC 705/7.35

(57) ABSTRACT

A cost accounting system and method of promoting four organizing principles of sustainability measurement: (1) the principle of measuring “sustainably autogenous systems” (nature and behavior) for efficiency engineering to achieve measurable increases in EROEI; (2) the principle of measuring “full spectrum renewable energy technology” to include: (a) integrative design engineering for increased energy production capacity by the combination, synergy and aggregation of solar, wind, geothermal, moving water, biomass conversion; and (b) integrative design engineering to achieve measurable increases in economic capacity of produced capital by infrastructure engineering; (3) the principle of measuring hydrogen-carbon dissociation to achieve measurable increase in renewable energy value and measurable increase in renewable material resource value and (4) the principle of measuring the liberation of local economic talent by creating local jobs in sustainability programs and eliciting local leadership so as to achieve measurable increases in program governance, mission development, entrepreneurship, innovation, and community development.

### BACKGROUND

The present invention relates to the measurement and reporting of renewable energy availability and use in both macro- and micro-economic settings (e.g., “macro” means international, eco-region, national, state, city and town economies; “micro” means local neighborhood, household, corporate facility, and farm economies). This system and method introduces uniform and publicly transparent empirical methods that can be used to describe a broad range of technology selections and implementations to obtain accurate appraisals of Energy-Return-On-Energy-Invested (EROEI) viability. This provides the opportunity to develop an open public understanding of how “sustainability” is defined and achieved, as well as an open publicly replicable measurement and reporting system to establish public confidence that renewable energy sources can obtain economic results superior to traditional petrochemical and/or nuclear non-renewable energy production, including superior environmental protection. Social benefits accruing from sustainable production systems overcome inherently depletive, exploitative, and destructive impacts on the ecosystems upon which all life depends. This invention presents comprehensive cost accounting as an essential requirement for successful implementation of sustainable production methods in energy, industry, and agriculture for both developing and developed nations.

From the point of view of human ecology, the definition of non-sustainability is depletion of any finite resource to the point of exhaustion and/or pollution with toxic waste to the point of destruction and disease. Nature teaches what is not sustainable by feedback about damage done to the web of life. In order for human civilization to thrive and prosper, our economic, social and environmental practices must be sustainable for the long-term. The way to achieve a sustainable civilization is to develop use of renewable energy as our most fundamental economic resource.

Our human species must get this challenge right or we extinguish survivability of future generations by destroying environmental viability and wasting required resources. We must choose to stop the short-sighted approach of ravinously depleting finite resources, while indulging in prolific toxic-waste production. We must challenge the deeply rooted belief that depletion of finite energy and material resources is the only approach possible for economic development, especially the conviction that burning fossil fuels is the most efficient answer for energy consumption. We must challenge the idea that burning or burying are the best methods of waste management. Otherwise we doom the generations who come after us to live in a world of increasing poverty and poison. The alternative way forward is to build the scientific and technological capacity of renewable energy to advance sustainability practices for environmental protection, social progress, and economic prosperity. This is achieved by use of scientific methods of measurement, feedback, evaluation and management applied to technology selection, investment, efficiency improvement, and governance.

### BRIEF DESCRIPTION OF THE DRAWINGS

FIG. 1A shows World Energy Consumption (known and projected data) 1990 to 2035 in quadrillion Btu, in developing and developed nations.

FIG. 1B shows World Energy Consumption by Fuel Type (known and projected data) 1990 to 2035 in quadrillion Btu.

FIG. 1C shows World Energy Consumption by Sector (known and projected data) 1990 to 2035 in millions of barrels per day, in developing and developed nations.

FIG. 1D shows World Net Electricity Generation by Fuel Type (known and projected data) 1990 to 2035 in trillion kilowatt-hours, in developing and developed nations.

FIG. 2A shows World Oil Reserves by Country with U.S. Oil Shale Resources.

FIG. 2B shows U.S. Natural Gas Reserves versus Production 1944-2010.

FIG. 2C shows World Proved Oil Reserves versus Production 1980-2007.

FIG. 2D shows U.S. Proved Oil Reserves versus Production 1944-2010.

FIG. 2E shows U.S. Energy Flow Trends for 2002, Net Primary Resource Consumption ˜97 Quads (Lost Energy and Useful Energy).

FIG. 2F is a flow chart of U.S. Greenhouse Gas Emissions (GHG) 2003 data showing the human activities which lead to pollution affecting public health and environmental damage.

FIG. 3 shows U.S. Dept. of Agriculture: Grain for Food and Grain for Biofuels 2000-2010.

FIG. 4A shows “A Safe and Just Space for Humanity”: Ecological Boundaries whose transgression causes unacceptable environmental damage.

FIG. 4B shows Model of Nine Planetary Ecological Boundaries with Three Emergency Environmental Conditions: Climate Change, Biodiversity Loss and Nitrogen Cycle Damage.

FIG. 5A is a diagram of the interdependent relationship of economic activity within the context of social resources and environmental resources; diagram used as a basis for identifying Sustainability Indicators.

FIG. 5B is a diagram of the interdependent relationship of Economic Development (produced capital), Social Advancement (human capital and social capital), and Environmental Conservation and Protection (natural capital).

FIG. 5C is a diagram illustrating the definition of Sustainability as the interdependent outcome of Economic, Environmental, and Social processes working together.

FIG. 5D shows a model of Unsustainable Economy in which Growth Threatens Ecosystems (economic disaster).

FIG. 5E shows a model of Sustainable Economy in which Limited Growth Occurs (economic contraction).

FIG. 5F shows a model of Sustainable Economy in which Balanced Growth Occurs (economic expansion).

FIG. 6A shows a model of a Non-Autogenous System.

FIG. 6B shows a model of a Sustainably Autogenous System (with feedback system loops for energy, material resource and information transfer).

FIG. 7A shows a model of Full Spectrum Energy (FuSE) Technology Installation, with system integration of Energy Park, Industrial Park and Agribusiness Network).

FIG. 7B shows an array of Sustainability Indicators in the FuSE Model of autogenous systems and processes for production of energy, material resources and nutrient regimes.

FIG. 8A shows the Full Spectrum Integrated Production System

FIG. 8B shows the Full Spectrum Integrated Production System

FIG. 9 shows the Full Spectrum Functional Zones of the Land and Permafrost Embodiment

FIG. 10 shows the Full Spectrum Functional Zones of the FuSE Ocean Embodiment: SOTEC—solar ocean thermal energy conversions

FIG. 11 shows the FuSE Permafrost Embodiment: System and method for Collecting and Processing Permafrost Gases and for Cooling Permafrost

FIG. 12 is a flow diagram of the Comprehensive Cost Accounting and Audit for Sustainability System and Method.

FIG. 13 is a system diagram of the Comprehensive Cost Accounting and Audit for Sustainability: Computing and Communications Structures (i.e., five measurement modules, a report generation module, and a sustainability certification module).

FIG. 14 is an illustrative example of a conventional process for producing electrical energy as a useful product.

FIG. 15 is an illustrative example of an autogenous process for producing electrical energy as a useful product.

FIG. 16 is a flow diagram showing example inputs, outputs, and products of various sub-processes within a larger example autogenous system.

FIG. 17 is block diagram of a system for comprehensively modeling the cost of producing a functional unit of product by either a depletive or autogenous process.

FIG. 18 is flow diagram of a method for comprehensively modeling the cost of producing a functional unit of a primary product by either a depletive or autogenous process.

FIG. 19 is flow diagram of a method for modeling the direct pecuniary cost of producing a functional unit of primary product.

FIG. 20 is flow diagram of a method for modeling the environmental impact of producing a functional unit of a product.

FIG. 21 is flow diagram of a method for modeling the social impact of a functional unit of product.

FIG. 22 is a block diagram for illustrating the social and environmental impact of aspects of the disclosure.

FIG. 23 is a block diagram illustrating nuclear energy production.

FIG. 24 is a block diagram illustrating coal energy production.

FIG. 25 is a block diagram illustrating Module 7 used for Sustainability Certification.

### DETAILED DESCRIPTION

### 1. Overview

The present application incorporates by reference in their entirety the subject matter of each of the following U.S. patent applications, filed on Aug. 16, 2010 and titled: METHODS AND APPARATUSES FOR DETECTION OF PROPERTIES OF FLUID CONVEYANCE SYSTEMS (U.S. patent application Ser. No. 12/806,634); ELECTROLYTIC CELL AND METHOD OF USE THEREOF (U.S. patent application Ser. No. 12/806,633); SUSTAINABLE ECONOMIC DEVELOPMENT THROUGH INTEGRATED PRODUCTION OF RENEWABLE ENERGY, MATERIALS RESOURCES, AND NUTRIENT REGIMES (U.S. patent application Ser. No. 12/857,553); SYSTEMS AND METHODS FOR SUSTAINABLE ECONOMIC DEVELOPMENT THROUGH INTEGRATED FULL SPECTRUM PRODUCTION OF RENEWABLE ENERGY (U.S. patent application Ser. No. 12/857,541); SUSTAINABLE ECONOMIC DEVELOPMENT THROUGH INTEGRATED FULL SPECTRUM PRODUCTION OF RENEWABLE MATERIAL RESOURCES (U.S. patent application Ser. No. 12/857,554); METHOD AND SYSTEM FOR INCREASING THE EFFICIENCY OF SUPPLEMENTED OCEAN THERMAL ENERGY CONVERSION (SOTEC) (U.S. patent application Ser. No. 12/857,546); GAS HYDRATE CONVERSION SYSTEM FOR HARVESTING HYDROCARBON HYDRATE DEPOSITS (U.S. patent application Ser. No. 12/857,228); APPARATUSES AND METHODS FOR STORING AND/OR FILTERING A SUBSTANCE (U.S. patent application Ser. No. 12/857,515); ENERGY SYSTEM FOR DWELLING SUPPORT (U.S. patent application Ser. No. 12/857,502); ENERGY CONVERSION ASSEMBLIES AND ASSOCIATED METHODS OF USE AND MANUFACTURE (U.S. patent application Ser. No. 12/857,433); and REACTORS FOR CONDUCTING THERMOCHEMICAL PROCESSES WITH SOLAR HEAT INPUT, AND ASSOCIATED SYSTEMS AND METHODS (U.S. Pat. No. 8,187,550.

Described in greater detail herein are systems and methods for providing comprehensive cost modeling of autogenous systems used to produce energy, material resources, and/or nutrient regimes. The systems and methods may also be used to provide cost comparisons of autogenous systems with conventional depletive systems. Additionally, the systems and methods described herein may be utilized for sensitivity analyses, system/process design or optimization, Monte Carlo or similar probabilistic modeling, and “what-if” modeling.

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention may include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

The discussion herein provides a brief, general description of suitable environments in which aspects of the invention can be implemented. Those skilled in the relevant art will appreciate that aspects of the invention can be practiced with other communications, data processing, or computer system configurations, including: Internet appliances, hand-held devices (including personal digital assistants (PDAs)), wearable computers, all manner of cellular phones, mobile phones, and/or mobile devices, multi-processor systems, microprocessor-based or programmable consumer electronics, set-top boxes, network PCs, mini-computers, mainframe computers, and the like. The terms “computer,” “server,” “host,” “host system,” and the like are generally used interchangeably herein, and refer to any of the above devices and systems, as well as any data processor.

While aspects of the invention, such as certain functions, are described as being performed exclusively on a single device, the invention can also be practiced in distributed environments where functions or modules are shared among disparate processing devices, which are linked through a communications network, such as a Local Area Network (LAN), Wide Area Network (WAN), and/or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

### 2. A New Approach to Cost Accounting for Sustainability

The cost accounting system and method of the present invention is designed to promote four organizing principles of sustainability measurement: (1) The principle of measuring “sustainably autogenous systems” (nature and behavior) for efficiency engineering to achieve measurable increases in EROEI; (2) The principle of measuring “full spectrum renewable energy technology” to include: (a) Integrative design engineering for increased energy production capacity by the combination, synergy and aggregation of solar, wind, geothermal, moving water, biomass conversion, and more, so as to achieve measurable increases in thermodynamic capacity; and (b) Integrative design engineering to achieve measurable increases in economic capacity of energy, material resource, and nutrient regime production (i.e., increase produced capital by infrastructure engineering); (3) The principle of measuring hydrogen-carbon dissociation so as to achieve measurable increase in renewable energy value and measurable increase in renewable material resource value (i.e., increase natural capital by methods of protection, conservation and production); and (4) The principle of measuring the liberation of local economic talent by creating local jobs in sustainability programs and eliciting local leadership so as to achieve measurable increases in program governance, mission development, entrepreneurship, innovation, and community development (i.e., increase human and social capital).

These four sustainability practices, as disclosed by the inventor's several patented renewable energy embodiments and referenced herein, may be practiced as illustrative methods of EROEI enhancement of production, and thus used as key criteria for sustainability-evaluation cost accounting. The cost accounting system and method of the present invention is a synergistic compliment to the inventor's existing patent portfolio which has introduced inventions for increased production of renewable energy, material resources, and nutrient regime. Further, these examples illustrate the inventor's approach to accounting for the ubiquitous crisis problem of carbon pollution by preventing carbon from entering the ecosystem waste-stream through diverting carbon into forms of feedstock suitable for use in the manufacturing of durable goods (i.e., to transform carbon into highly positive economic values). This method for comprehensive cost accounting includes itemizing “replacement cost” whenever natural resources are depleted and long-term economic opportunity is subverted.

The accounting method has a social function to expose exploitation of apathetic public populations that have no understanding or appreciation of EROEI and therefore unwittingly participate in destruction of natural resource assets required by future generations for survival and prosperity. This function is not dissimilar to the role of financial accounting to protects against fraud, inaccuracy in reporting, egregious opportunistic greed and political corruption. Typically depletion of natural resources is motivated and justified by short-term economic gain to special interests, often at the expense of the larger public interest. Such profiteering and economic opportunism is unrestrained because there are no standard methods or tools of cost accounting of energy and natural resource use which assist the long-term view of sustainability for protection of the enduring public interest. As an alternative in the present invention, full life-cycle analysis of production methods aim at accounting for hidden externality costs and EROEI sensitivity analysis, such that informed consent and public confidence can be developed to provide focused long-term dedication to achievement of sustainable prosperity (which by necessity requires environmental protection and natural resource conservation in balance with economic development).

The comprehensive cost accounting method presented herein establishes an equal playing field of EROEI analysis to compare renewable and non-renewable systems for energy, material resource and nutrient production. In addition to emphasizing the vital importance of EROEI (which is a basic physics accounting of energy-in and energy-out), this method also practices ROI accounting (Return-on-Investment, a traditional financial accounting description of money-in and money-out), and EROI accounting (Energy-Return-on-Investment, which is cost-of-energy-in and money-out). This comprehensive approach to cost accounting directly addresses stakeholder needs for public confidence, funding confidence, entrepreneurial risk-taking confidence, and energy-security confidence in adoption of renewable energy technologies. The methodology is designed to articulate renewable energy practices that are technologically viable and societally optimistic solutions (near-term and long-term) in response to the unfolding crisis of increasingly unsustainable high-cost fuel and energy-insecurity due to dependence on traditional petroleum and nuclear. Two energy production means that are based in finite-resource depletion and toxic pollution damaging to local environments and globally by deterioration of climate, air and oceans. The widely-held fear of impending economic collapse due to depleted petroleum reserves is a position of economic pessimism in America¹ and internationally.² This economic fear and pessimism is fostered by a lack of empirical measures which prove that renewable energy production is an immediately available and viable solution that can match the previous century's benefits associated with “cheap oil” resources. Those benefits, upon which society has grown economically needful, include: (a) a societal economic engine of reliable expanding growth, (b) low-cost transportation fuel/electricity production which provides a generalized augmenting ripple-effect throughout an economy, and (c) progressive increase in human standard-of-living that follows from continuously increasing energy availability and use. ¹ Ruppert, Michael, Confronting Collapse: The Crisis of Energy and Money in a Post Peak Oil World, Chelsea Green Publishing, 2009, Chapter 4 “Reserve Estimates: Playing a Fool's Game with Numbers”, page 34; also, Martenson, Chris, The Crash Course: The Unsustainable Future of Our Economy, Energy, and Environment, Chapter 16 “Peak Oil”, page 141.² Diamond, Jared, Collapse: How Societies Choose to Fail or Succeed, Penguin Books, 2005-2011; Chapter 15 “Big Businesses and the Environment” page 441; also, Rifkin, Jeremy, The Third Industrial Revolution: How Lateral Power is Transforming Energy, The Economy, and the World, Palgrave Macmillan, 2011, Chapter 1 “The Real Economic Crisis Everyone Missed”, page 9.

The present invention addresses diverse measurement and reporting requirements which are appropriate for appraisal of the following widely dissimilar human activities: electricity generation, fuel production, industrial manufacturing, agricultural production, water production-conservation, carbon product development (i.e., as a financially and technologically beneficial alternative to carbon sequestration), waste management, and the various transport/logistics costs associated with these distinctive items. The present invention asserts that all of these economic activities are integral to one another in the following ways: (1) “sustainability” requires long-term technological interdependence in order to achieve human society survival, development and evolution; (2) meaningful measurement of any one of these components requires measurement-accounting of the other components to establish broad meaningful context, and finally, (3) “sustainable” use of energy (as measured by ROI, EROI, and EROEI) generates direct benefits at both macro- and micro-economic levels.

Therefore, the system and method of measurement and recording of the present invention is designed to satisfy multiple and contrasting needs (i.e., scientific, technological, fiscal, social, political, environmental, and economic) for appraisal-evaluation-accounting to generate public confidence within the widest possible audience of users and stakeholders to accelerate: (a) adoption and diffusion of new renewable energy technology-engineering; (b) adoption of renewable energy systems by economic institutions at international, national, regional, state, city, neighborhood, household, corporate and farm levels of implementation; (c) adoption of sustainability standards by government energy-security policy and planning; (d) adoption of sustainability standards by labor, education and research institutions, (e) adoption of sustainability standards for natural resource and ecosystem protection, (f) adoption of sustainability standards that are systematically inclusive of key indicators for environmental, social, economic, and governance, and (g) adoption of sustainability standards that support measurement of autogenous systems of production. The present invention aims at advancing the adoption of economic development which preserves and augments long-term natural resource management. One embodiment of this system and method is a measurement and reporting system which provides “sustainability certification” of corporations, organizations, projects, products and services by publishing and advocating standards that are applicable to the diverse economic production areas which have been enumerated, and then publicly reward successful implementation (i.e., Diamond Green™ figures of merit of sustainability).

### 3. Social Impact Measures

The advancement of human well-being, the reduction of human poverty, and the health/productivity of eco-systems are directly inter-linked economic problems; the solution of each requires energy availability and use. Policy decisions and programs which have as their goal to eradicate poverty must take into consideration every aspect of the energy supply chain.³ Each stage of the energy supply chain, including generation, distribution, and consumption of energy, has multiple impacts on economic, social, and environmental components of community development. Analysis of an effective way to eradicate poverty by ensuring access to reliable and sufficient energy to serve the needs of the chronically poverty stricken has not yet been efficiently accomplished. No government agency, nor any non-governmental organization (NGO), such as the United Nations and the World Bank, has been able to adequately analyze or effectively remediate the dynamics of chronic poverty as consequences of disenfranchisement from energy infrastructure.⁴ The World Bank has published some awareness of the scientific and social dimensions of the problem with the follow quotation: “How we measure development will drive how we do development” (emphasis added).⁵ Consistent failure for decades to successfully remediate chronic poverty demonstrates profound structural limitations in the current industrialization processes as practiced in both developed and developing nations (i.e., inadequate economic and political institution-functionality, and inadequate technology options for practical diffusion).⁶ Despite the “information technology age” in which we live, current institutions (whether of business, industry, academia, government, social welfare, religious, and community protection groups) lack the effective information means to (a) empirically quantify and evaluate energy infrastructure deficiencies, (b) establish the communication feedback by which to describe the deficiencies to target audiences/decision-makers, (c) prescribe effective means to close the infrastructure performance gaps, and (d) incentivize adoption of appropriate energy technology solutions at the local level of human experience to successfully mitigate starvation and privation. The present invention is designed to answer these overarching needs. ³ UN Millennium Project, Energy Services for the Millennium Development Goals, and http://www.unmillenniumproject.org/documents/MP_Energy_Low_Res.pdf⁴ Goldsmith, Edward, Pollution Costs, http://www.cdwardgoldsmith.org/page2944.html⁵ “Comprehensive Wealth Accounting”, Kirk Hamilton, Development Research Group, The World Bank, Online: http://data.worldbank.org⁶ Acemoglu, Daron, and James Robinson, Why Nations Fail: The Origins of Power, Prosperity and Poverty, Crown, 2012, Chapter 3 “The Making of Prosperity and Poverty, page 70.

Those caught in the trap of chronic poverty are precisely the populations who have benefited least from the economic development provided by the industrial revolution for the last two hundred years. They have been left behind in the technology free market because they are poor. Over 1.4 billion people in the developing world, basically one in four, live on less than a $1.25 a day—according to poverty estimates published by the World Bank in 2005.⁷ This segment of the world population lives in unremitting and intractable poverty with all that means in human suffering. Although numerous national and international policy and program efforts have been initiated to reduce or intervene in transient (short-term) poverty, few programs successfully offset chronic (long-term) poverty.⁸ Chronic poverty is extreme poverty that persists for a long time—many years, an entire life, or even across generations—with the primary characteristic being disenfranchisement from economic participation in energy, agricultural and industrial infrastructure. ⁷ The World Bank, Poverty Reduction and Equity, Online: http://web.worldbank.org/WBSITE/EXTERNAL/TOPICS/EXTPOVERTY/EXTPA/0,,EcontentMDK:201 53855˜menuPK:435040˜pagePK:148956˜piPK:216618˜theSitePK:430367,00.html⁸ United Nations, The Millennium Development Goals Report, Online: http://www.un.org/millenniumgoals/pdf/MDG%20Report%2020%20En%20En%20r15%20-low%20res%2020100615%20-.pdf#page=8

Chronic poverty describes the economic plight of many developing nations across the globe, and applies also to smaller but significant demographic groups within developed nations. “The world is facing a hunger crisis unlike anything it has seen in more than 50 years. 925 million people are hungry. Every day, almost 16,000 children die from hunger-related causes. That's one child every five seconds. There were 1.4 billion people in extreme poverty in 2005. The World Bank estimates that the spike in global food prices in 2008, followed by the global economic recession in 2009 and 2010 has pushed between 100-150 million people into poverty.”⁹ Such statistics denote wide-spread failure of energy resource delivery required for survival needs of food, water, clothing and shelter, as well as effective farming, communication, health care, community building, social stability and political stability. Poverty is hunger, lack of shelter, being sick and not being able to see a doctor, not having access to clean water, not having access to schools, not knowing how to read, and not having a job. Poverty is fear for the future, not being able to have one's voice heard, living one day at a time in powerlessness, lack of representation and lack of freedom. Fundamental to this privation is the lack of access to energy infrastructure with consequent lack of basic necessities for life, lack of sanitation, and exposure to public health diseases.¹⁰ ⁹ “Bread for the World”: Global Hunger, Online: http://www.bread.org/hunger/global/¹⁰ Over one billion people world-wide lack clean drinking supplies and over two billion people lack adequate sanitation which leads to disease and death.

Further, the enfolding environmental risk of this same situation is that efforts to remedy lack of energy infrastructure in developing nations will cause the same catastrophic damage to the environment and depletion of natural resources which developed nations have already incurred.¹¹ Also, the developing nations have consistently been the target of military conflict (internal civil war or external attack) particularly when petroleum natural resources have been identified. The danger is that this trend will increase under the prevailing approach to energy resource acquisition.¹² Under the current scenarios, beyond war-for-oil, war-for-water and war-for-food are also forecast as on the horizon.¹³ Given an unbending belief and vested interest in certain energy paradigms in the minds of many key politicians, war is often thought to be inevitable and strategically necessary; it has been argued that the concept of a “just war” be broadened to include economic necessity to preserve our way of life.¹⁴ Protection of the environment and publicly transparent valuation of natural resources are two uses of the present invention. ¹¹ Randers, Jorgen, 2052: A Global Forecast for the Next Forty Years, A Report to the Club of Rome Commemorating the 40^{th} Anniversary of The Limits to Growth, Chelsea Green, 2012, Chapter 6 “Food and Footprint to 2052”, page 130.¹² Klare, Michael, Resource Wars: The New Landscape of Global Conflict, Metropolitan/Owl Books, 2001, Chapter 2 “Oil, Geography and War: The Competitive Pursuit of Petroleum Plenty”, page 27¹³ Parenti, Christian, Tropic of Chaos: Climate Change and the New Geography of Violence, Chapter 3 “War for a Small Planet”, page 21.¹⁴ Greenspan, Alan, The Age of Turbulence: Adventures in a New World, Penguin Books, 2009, “I am saddened that it is politically inconvenient to acknowledge what everyone knows: the Iraq war is largely about oil. Thus, projections of world oil supply and demand that do not note the highly precarious environment of the Middle East are avoiding the eight-hundred-pound gorilla that would bring world economic growth to a halt. I do not pretend to know how or whether the turmoil in the Middle East will be resolved. I do know that the future of the Middle East is a most important consideration in any long-term energy forecast. Even though oil-use intensity has been significantly reduced, the role of oil is still such that an oil crisis can wreak heavy damage on the world economy. Until industrial economies disengage themselves from, as President George W. Bush puts it, ‘our addiction to oil’, the stability of the industrial economies and hence the global economy will remain at risk.”

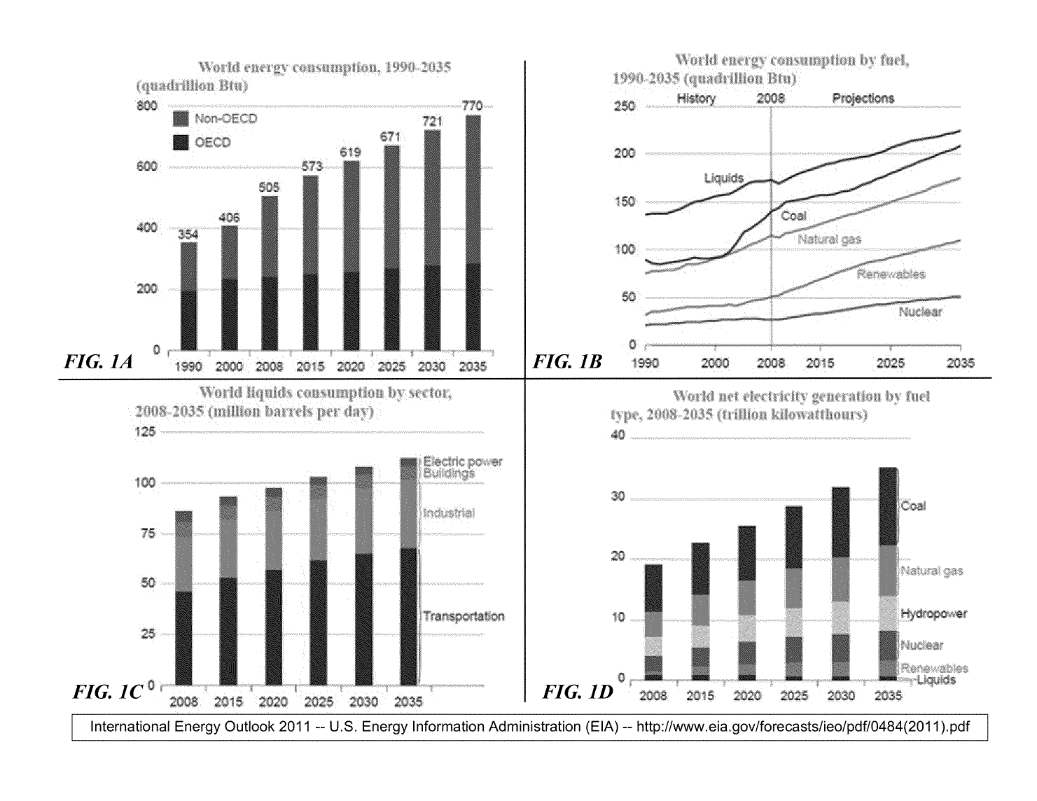

Note that FIG. 1A shows World Energy Consumption¹⁵ (known and projected data for the period 1990 to 2035) for developing and developed nations, and projects huge increases in energy consumption in the developing world. The consequence of this expectation is that increased petroleum and natural gas must fill the economic development gap regardless of cost accounting variables like supply, price, pollution impact, and climate change impact. FIG. 1B shows World Energy Consumption by Fuel Type (known and projected data for the period 1990 to 2035). Given this trend there is no confident scenario or stimulus by which renewables would suddenly change their slow rate of growth. Given this trend, there is no consensus view of viability which would warrant, or allow, economic displacement of petroleum by renewable energy. The present invention seeks to describe an economic model which can make the case for such a paradigm of disruptive innovation. ¹⁵ FIGS. 1A to 1D source: U.S. Energy Information Administration (EIA), “Annual Energy Outlook 2012 with Projections to 2035”, DOE/EIA-0383(2012), June 2012, Online: http://www.eia.gov/forecasts/aeo/pdf/0383(2012).pdf

FIG. 1C shows World Energy Consumption by Sector (known and projected data for the period 1990 to 2035) in developing and developed nations. The massive consumption profile in Transportation may very probably be altered by the dramatically increased availability of natural gas fuel¹⁶. Until now natural gas has not been the fuel of choice for heavy duty engines. The ability, then, to use natural gas resource for transportation and power generation to displace coal and liquid petroleum with a less polluting and abundant domestic fuel resource is a major economic and energy-security benefit that is aligned with long-term U.S. national energy policy. This opportunity presents a unique paradigm of rapid energy transition because inherent barriers have been overcome. Finally, FIG. 1D shows World Net Electricity Generation by Fuel Type (known and projected data for the period 1990 to 2035) in developing and developed nations. This data drives home the fact that under the current trend of technology adoption, renewable energy is currently in no position to answer the growing economic needs of the human population. The present invention seeks to describe an economic model which will incentivize rapid adoption of renewable energy. ¹⁶ “The Future of Natural Gas, An Interdisciplinary MIT Study, Interim Report”, Massachusetts Institute of Technology, 2010, pg. xi.

Therefore, It is imperative that an economic model be available which can articulate (both descriptively and prescriptively) the dynamics of the sustainable energy supply chain, including (a) power generation—electricity and transportation fuel, (b) materials resource production, (c) food production and water management, and (d) energy infrastructure for communities in both developed and developing nations. This knowledge empowers local governance, leadership, decision-making and choice to enable power (political, economic, social and technological) to be placed into the hands of individuals and groups so that they can determine their own destiny.

Energy is the life-blood of an economic system; energy circulates through the economic pathways of production, industry, commerce, transportation, agriculture, and more. Economic activity of natural capital and produced capital calls forth increased productivity in human and social capital—the liberation of local human talent to provide workforce, inventiveness, governance, and informed consent to grow toward prosperity, rather than toward economic and environmental catastrophe. This acknowledgement of the central function of human capital is essential, as well as the essential role of correct and timely information to increase its productivity. Without information-and-knowledge-flow, leadership, creativity, innovation, entrepreneurship, and the highest of mankind's callings to empathy, service and community do not occur.

Equally important is that information-and-knowledge-flow is also a determining catalyst of human potential (e.g., as embodied in individuals, groups, families, corporations, economic-social-political institutions, and culture). The currency of information moves through economic pathways enabling production, industry, commerce, transportation, agriculture, and more with unprecedented effect. Knowledge is anti-entropic by bringing order out of chaos and increasing productivity. Unlike other natural resources, knowledge is not used up, so it is a distinctive lever of civilization. The distinction between human beings fighting for economic survival at the lowest rung versus building for economic prosperity at higher rungs of living is achieved by knowledge and community (i.e., human beings can understand and actualize opportunity and options in energy, industry and agricultural production, and in so doing transform their world). However, human beings trapped in ignorance and fear from lack of adequate information may define their economic reality as an entrenched battle over scarce natural resources. This can drive societal behavior down to the lowest common-denominator of guns, knives, bombs, tribal rivalry and hatred. An alternative path is based in the knowledge that renewable energy resources are abundant and can increase through engineering, and that “win-win” economic scenarios can be successful and preferred (in contrast to “win-lose” economic games and political warfare which are the tools of early stage society). Because of the growing revolution in Information Communication Technology (ICT: information processing, computers, communications, internet, media, satellite global networks, smart phones, etc.), knowledge-transfer, access to education, social media collaboration, vision and inspiration sharing, is now occurring at a scale the world has never seen before, and with direct political consequences.

Specifically in the case of the present invention, information flow can advance civil society to let loose the human potential for transformative breakthroughs in science, technology and human collaboration.¹⁷ The intent of the present invention is to provide information-flow calculated to affect individual and group capability to meet and actualize fulfillment of their own hierarchy of human needs (i.e., Abraham Maslow's psychological model of motivation is widely applied in business and economics). Therefore, in concrete terms, information and knowledge which empowers users of distributed energy production, distributed information access, and distributed manufacturing, also leads to distributed democracy (i.e., governance distributed effectively to the local level through information-flow that enables community and personal decisions about energy, industry and agriculture). The intended practice of this invention is to liberate information-and-knowledge-flow and feedback in a manner calculated to increase human and social productivity. ¹⁷ Rifkin, Jeremy, ibid. Chapter 9 “Morphing the Industrial to the Collaborative Era”, pg. 259.

The power of the mathematical model enabled in this disclosure is to use an integrated set of Sustainability Performance Indicators (i.e., quantifiable indices, descriptors and formula) appropriate to a method of appraisal of energy supply chain production that may include installations, sites, facilities, programs, products and services. The mathematical model is used in political, economic, social and technological decision-making and communication in the following ways: (a) Evaluation and comparison (i.e., identifying and quantifying key sustainability performance indicators and their trends); (b) Prescriptive planning of engineering that is adaptable to local ecosystems, weather patterns, climate, and natural resource opportunities and constraints; (c) Prescriptive planning of policy that is adaptive to local human and financial resources, and known or anticipated problems of population density, waste, pollution, inefficiency, communicable disease, sanitation and other public health burdens; (d) Establishing certification standards for cost accounting of the energy supply chain so as to calculate the “true cost” of renewable energy. Such procedures can make visible hidden costs, clarify ambiguities, reveal unfair comparisons, inaccuracies, dis-information, manipulated statistics, and overcome the failure to take into account numerous environmental, social and economic impacts¹⁸; (e) Using certification standards and figures of merit to measure quality assurance to established confidence and positive expectations of performance. The producers of renewable energy must (i) persuasively demonstrate the ability to meet and surpass requirements of energy sufficiency, cost viability, scalability, and national energy security; (ii) counter vested-interests in the status-quo that are un-mindful of escalating harm to the environment and increasing energy costs which results in social harm to disenfranchised populations; and (iii) generate positive public confidence in scientific knowledge and new technology options that inspires action toward greater economic mobility and political power; (f) Establishing incentive programs to increase confidence by rewarding adoption of Sustainability Performance Standards, rewarding rapid adoption of new technology, and persuasively communicating the benefits of technology adoption (both short term and long term payoffs); (g) Using figures of merit (i.e., standards beyond just quality assurance) to calculate and communicate the following benefits: (i) potential Return-on-Investment (ROI), (ii) Energy-Return-on-Investment (EROI), (iii) Risk Mitigation to generate confidence to fund new projects, and (iv) Energy-Return-on-Energy-Invested (EROEI); and (h), producers of renewable energy must be able to persuasively explain the capital asset advantages of: (i) renewable energy production combined with materials resource extraction, (ii) sustainable materials production combined with zero-emissions manufacturing, and (iii) renewable nutrient regimes—production of food, water, fertilizer, irrigation and agriculture—combined with energy biomass-feedstock production. ¹⁸ Oreskes, Naomi and Erik Conway, Merchants of Doubt: How a Handful of Scientists Obscured the Truth on Issues from Tobacco Smoke to Global Warming, Bloomsbury Press, 2010, Chapter 1 “Doubt is our Product”, page 10; also, Lomborg, Bjorn, The Skeptical Environmentalist: Measuring the Real State of the World, Cambrid Press, 1998, Chapter 1 “Things are Getting Better”, page 3; Hoggan, James, Climate Cover-up: The Crusade to Deny Global Warming, Greystone Books, 2009, Chapter 9 “Junk Scientists”, page 99

The relationship of poverty to ecosystem health/productivity can be summarized in the following Table A of key indicators, which shows the effort of the United Nations programs to articulate the relationship between ecosystem services and human well-being.

Key Sustainability Indicators: Table A¹⁹

Ecosystem Services
Provisioning:
Food
Micro-organisms, plant and animation products
Genetic material, biochemicals and pharmaceuticals
Fuels/energy
Fiber
Non-living materials (minerals)
Fresh water
Regulating:
Purification of air and water
Mitigation of floods and droughts
Detoxification and decomposition of wastes
Generation of renewal of soil and soil fertility
Pollination of crops and natural vegetation
Control of vast majority of potential agricultural pests
Dispersal of seeds and translocation of nutrients
Maintenance of biodiversity, from which humanity has derived
key elements of its agricultural, medicinal and industrial enterprise
Protection from the sun's harmful ultraviolet rays
Partial stabilization of climate
Moderation of temperature extremes and the force of winds and waves
Enriching:
Spiritual uses and relationship of people to land and water
Aesthetic values
Social relations and values
Education and scientific value
Human Well-Being
Being able to be adequately nourished
Being able to live free from avoidable disease
Being able to live in an environmentally clean and safe shelter
Being able to have adequate and clean drinking water
Being able to have clean air
Being able to have energy to keep warm and cook
Being able to use traditional medicine
Being able to continue using natural elements found in ecosystems
for traditional culture and spiritual practices
Being able to cope against extreme natural events like floods, tropical
storms, and landslides
Being able to make sustainable management decisions that respect
natural resources and enable the achievement of sustainable income
¹⁹“Connecting Poverty and Ecosystem Services: Focus on Rwanda”, Duraiappah, et al, United Nations Environmental Programme and the international Institute for Sustainable Development, 2005—Online: http://www.iisd.org/pdf/2005/economics poverty rwanda.pdf; also: Millennium Ecosystem Assessment-“Ecosystems and Human Well-being: Synthesis Report” (2003) A Framework for Assessment—Online: http:/www.maweb.org/en/Framework.aspx Source: Duraiappah 2002, 2005

### 4. Energy Impact Measures

Petroleum, as the dominant energy resource, has economically defined the last century. The current historical transition has been characterized as the “end of cheap oil”²⁰ or the passing of “peak oil”²¹ due to depletion of this natural resource, the need to drill ever-deeper more expensive wells, and to drill in increasingly risky, therefore expensive, environments. As a result, disadvantageous petroleum EROEI has emerged, forcing increases in the price of oil. It takes greater and greater investment of energy-and-cost to produce each barrel of oil today. (Many researchers use the terms EROEI and EROI interchangeably with the same formula.) Energy Return on Energy Investment (EROEI) is the ratio of how much energy is gained from the energy production process compared to how much of that energy (or its equivalent from some other source) is required to make that energy available for use. EROEI is calculated from the following simple equation: ²⁰ O'Reilly, CEO, Chevron, quoted in Real Issues Ad campaign, Jul. 12, 2005, “Energy will be one of the defining issues of this century. One thing is clear: the era of easy oil is over. What we all do next will determine how well we meet the energy needs of the entire world in this century and beyond . . . . It took us 125 years to use the first trillion barrels of oil. We'll use the next trillion in 30 [years].” http://www.chevron.com/documents/pdf/realissuesadtrillionbarrels.pdf Retrieved May 27, 2009²¹ The concept of peak oil is derived from geophysicist Marion King Hubbert's “peak theory”. In 1956 Hubbert asserted the observed relationship between oil discovery and oil production generally follows a bell-shaped curve describing the volume of extraction growing exponentially until the rate peaks and then declines with the later phase of pumping having higher cost in energy and money. Because oil is a non-replenishing resource, there is a limit to how much oil can be extracted and refined. The rate of oil production reaches a maximum when approximately half of the original resource remains, and thereafter production goes into irreversible decline. This is a projection true for a single well, an aggregate of wells in field or region, or the oil industry as a whole. While significant oil resource still remains in the ground, eventually it costs more to extract a barrel of oil than its worth, and that is when an oil field is economically abandoned. See Hubert, M. K. “Energy Resources: Report to the Committee on Natural Resources” (National Academy of Sciences, Washington D.C., 1962), cited by Hall, et al, “Hydrocarbons and the Evolution of Human Culture”, 20 Nov. 2003, Nature Magazine, Vol 426, http://www.esf.edu/efb/hall/pdfs/OilandCulture.pdf.

$$EROEI = \frac{Energy gained}{Energy required to get that energy}$$

$$EROEI = \frac{{E}_{out} - {E}_{in}}{{E}_{in}}$$

The higher the EROEI ratio, the more “profitable” the energy resource (from an energy standpoint). If the EROEI drops below 1:1, it means that it takes more energy to produce the usable energy than is contained in the finished product. In 1930 it required investment of only one barrel of oil to produce one hundred barrels (EROEI=100:1); in 2010 one barrel of oil invested produced only three barrels (EROEI=3:1).²² Any analysis of oil proved reserves cannot be taken as a simple raw number total (quantity), but must be put into the context of EROEI (quality)—what the actual energy investment of harvesting that oil production will be. ²² Hall, Charles and Kent Klitgaard, Energy and the Wealth of Nations: Understanding the Biophysical Economy, Springer Media, 2012, Chapter 15 “Peak Oil, EROI, Investments, and our Financial Future” page 321 and Chapter 18 “Peak Oil, Market Crash, and the Quest for Sustainability: Economic Consequences of Declining EROI” page 369; also Online: http://www.cumberlandsustainable.org/files/Energy_Return_on_Investment.pdf

As the price of oil increases, the threat of energy disenfranchisement to poorer populations becomes greater. With approximately four billion persons world-wide living at the low income level (described as being at the “base of the economic pyramid”), this population is at increasing risk due to the economic and technology transition now occurring. Benefits from the current petroleum-based economy never reached these populations, and the increasing price of petroleum in this era simply threatens to expand poverty to an even larger population. Therefore, if emergence of a new economy powered by renewable energy (solar, wind, moving water, geothermal, and biomass energy conversions) is to successfully counter this economic threat, then adoption and diffusion of renewable energy must be implemented in a manner that is robust, scalable, reliable, and financially viable to serve the needs of the developing nations, and not just the developed nations which already have significant energy infrastructure in place. It is only through cost accounting that articulates these required characteristics that renewable energy and sustainable economics can constructively define the new century, just as petroleum defined the previous epoch.

For this reason, it is imperative that an adequate economic model of comprehensive cost accounting be available which can: (a) serve the differing situation of communities in both developed and developing nations, (b) articulate the “true cost” of each component of needed energy infrastructure (i.e., the energy supply chain of production and distribution that supports materials resource production and food production), and (c) illuminate the distinctions between a depletive-economic model based on finite natural resources and a sustainable economic model based on renewable energy.

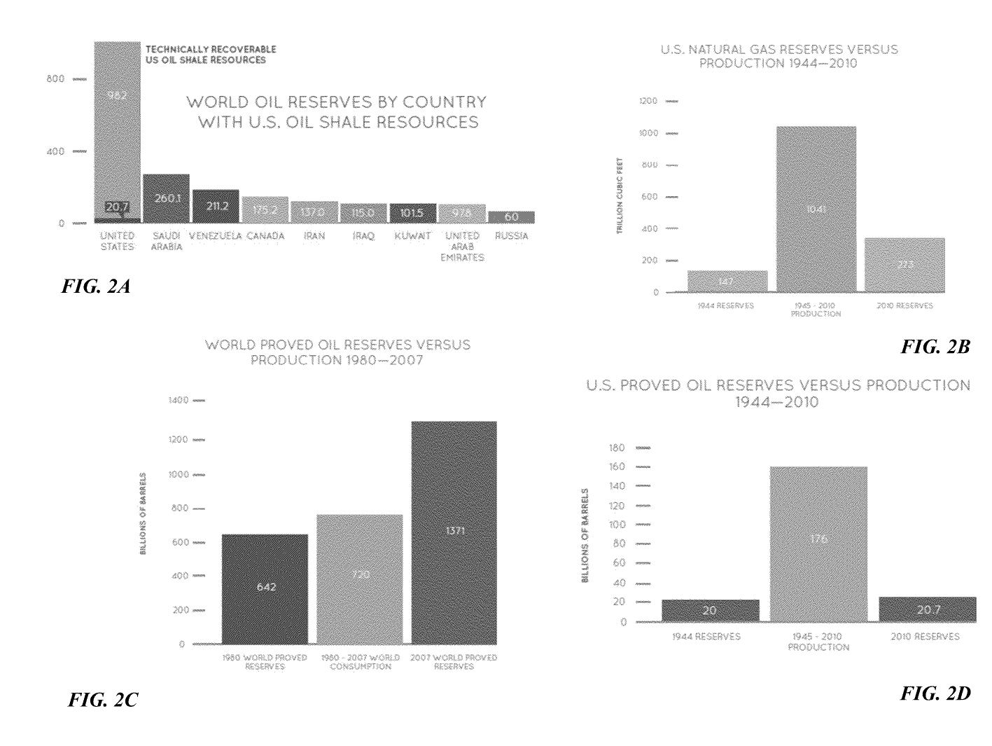

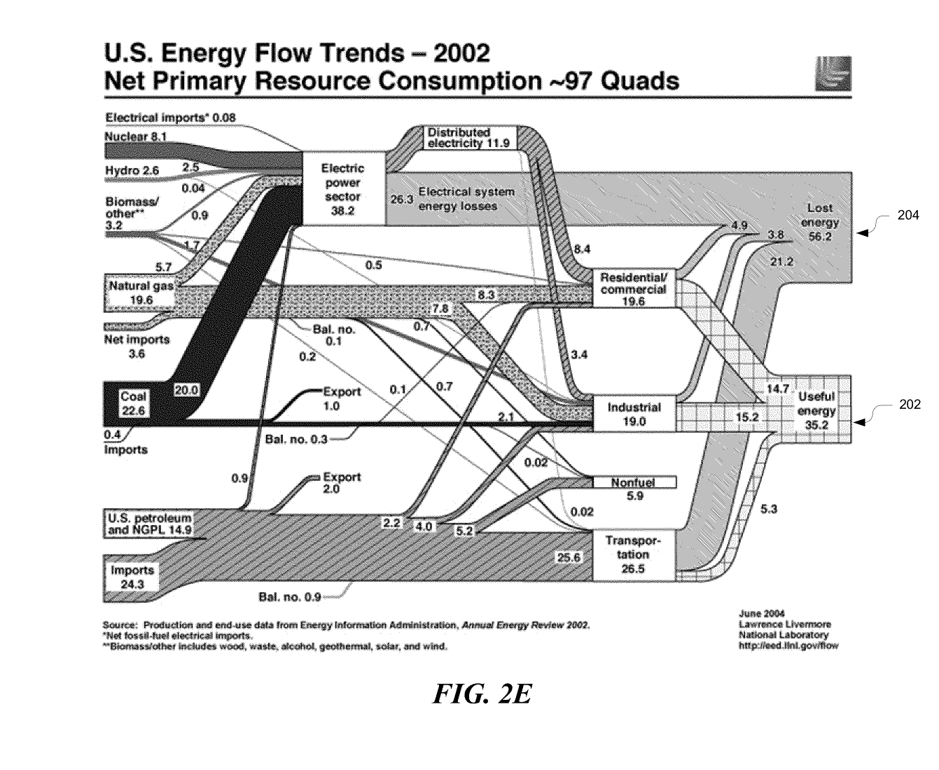

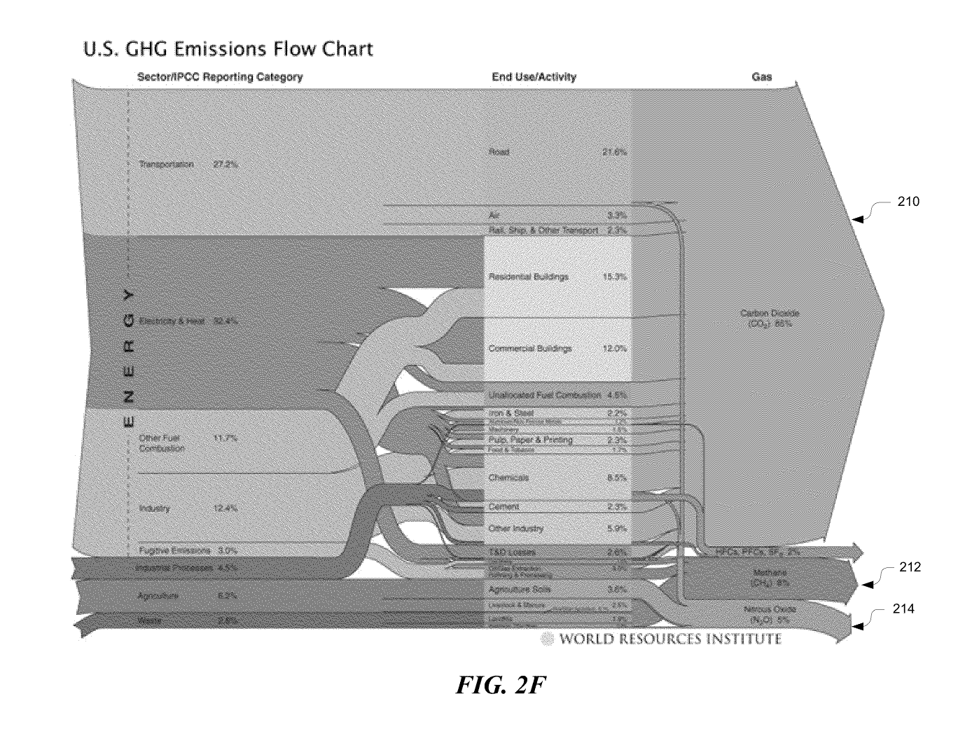

It has been said that the nature of economics is a “confidence game”. The four graphs of measurements shown in FIGS. 2A to 2D are published by the Institute for Energy Research, a non-profit petroleum industry association, and provide examples of energy information presentation from the viewpoint of the petroleum industry for the purpose of governmental lobbying. The data, (cited from U.S. Energy Information Agency—EIA), shows increased availability of 2012 proved petroleum reserves, based on improvements in drilling technology, including dramatically large discovery and production from unconventional natural gas in shale deposits. FIG. 2A shows the significant international economic advantage that the U.S. has gained from North American discovery and development of shale natural gas resources.²³ In 2011, the United States produced 23.0 trillion cubic feet of natural gas, making it the world's largest producer. The data shown in FIG. 2B asserts that current U.S. proved reserves of natural gas are currently greater than that which were proved in 1944 despite all the intervening years of productive output.²⁴. This data shows the potential energy transition from dependence on foreign oil imports toward domestic energy resources once again, a major inflection point in national energy-security. The data shown in FIG. 2C asserts that the world's proven oil reserves in 2007 are now about double as compared to world oil reserve estimates in 1980.²⁵ Further, U.S. data shown in FIG. 2D compares U.S. proved oil reserves in 1944 to U.S. oil reserves in 2010 as being basically equal despite all the intervening years of oil production output.²⁶ The petroleum industry narrative²⁷ accompanying this data presentation (aimed at an audience of energy policy-makers in the U.S. Congress) portrays (a) optimistic confidence that the current petroleum-based economy can continue to grow into the indefinite future as it has it the past, (a) although finite resource depletion and toxic pollution are real they are being managed successfully by the petroleum industry, (c) renewable energy (i.e., solar, wind, geothermal, biomass) is composed of immature technologies, risky, unreliable, and do not make economic sense in “true cost” terms when compared to petroleum, coal and natural gas. By this example, the practice of the present invention establishes a new context for interpreting of these important data examples (FIG. 2A thru 2D) by introducing: (a) use of a publicly transparent accounting method for energy and material resource accounting to validate accuracy of data, (b) systematically using sustainability indicators to capture long-term environmental, social, and economic values along-side immediate financial values in order to provide a more complete framework for analysis, planning and decision-making, and (c) insure the data of EROEI for each energy type (various depletive and renewable forms) is publicly auditable as essential information for use in business and government energy analysis, policy development, and decision-making. ²³ FIG. 2A SOURCE: EIA, INTERNATIONAL OIL OUTLOOK 2011 HTTP://WWW.EIA.GOV/FORECAST/EIO/TABLE5.CFM²⁴ FIG. 2B SOURCE: ENERGY INFOMRATION ADMINISTRATION, ANNUAL ENERGY REVIEW, HTTP://WWW.EIA.GOV/TOTALENERGY/DATA/ANNUAL/PDF/SEC6_{—}5.PDF ENERGY INFORMATION ADMINISTRATION, INTERNATIONAL ENERGY OUTLOOK 2011, HTTP://WWW.EIA.GOV/FORECASTS/IEO/TABLE7.CFM; ROBERT L. BRADLEY JR. & RICHARD W. FULMER, ENERGY: THE MASTER RESOURCE, P. 8B (2004).²⁵ FIG. 2C SOURCE: ENERGY INFORMATION ADMINISTRATION, INTERNATIONAL ENERGY STATISTICS: CRUDE OIL PROVED RESERVES, HTTP://TONTO.EIA.DOE.GOV/CFAPPS/IPDBPROJECT/IEDINDEXX3.CFM?TID=5&PID=57&AID=6&CID-REGIONS&SYID=1980&EYID=2010&UNIT=BB²⁶ FIG. 2D SOURCE: ENERGY INFORMATION ADMINISTRATION, ANNUAL ENERGY REVIEW, HTTP://WWW.EIA.GOV/TOTALENERGY/DATA/ANNUAL/PDF/SEC5 7.PDF; ENERGY INFORMATION ADMINISTRATION, INTERNATIONAL ENERGY OUTLOOK 2011, HTTP://WWW.EIA.GOV/FORECASTS/IEO/TABLE5.CFM; ROBERT L. BRADLEY JR. & RICHARD W. FULMER, ENERGY: THE MASTER RESOURCE, P. 88 (2004).²⁷ Institute for Energy Research (IER), “Hard Facts: An Energy Primer”, 2012, Online: http://www.instituteforeneryresearch.org/hardfacts/

FIG. 2E shows U.S. Energy Flow Trends for 2002, Net Primary Resource Consumption ˜97 Quads. A quad is a unit of energy equal to 10¹⁵ BTU, or 1.055×10¹⁸ joules (1.055 exajoules or EJ). Quad measure is used by the U.S. Department of Energy in discussing world and national energy budgets. FIG. 2E diagram was produced in June 2004 by Lawrence Livermore National Laboratory based on data from the U.S. Energy Information Administration (EIA). This diagram shows that current methods of energy production (petroleum, coal, natural gas, biomass, hydro, and nuclear) and current consumption modes (electrical power, residential commercial, industrial, non-fuel and transportation) result in a total of about 97 Quads of energy use. In this diagram arrow 202 points to the total useful energy in the flow as 35.2 Quad. Arrow 204 points to the total lost energy in the flow as 56.2 Quad which amounts to massive inherent losses in the U.S. energy system. A distinction must be made in energy-accounting for loss as an inherent price of energy-conversions due to the second law of thermodynamics and extreme inefficiencies and waste due to poor engineering choices and implementation methods. Much of this energy loss is due to inherent losses from the electrical grid, and waste heat loss from transportation engines. Systematically fixing in these efficiencies represents a major opportunity for improved energy economics, which must be measured and monitored by the cost accounting method of the present invention. One of the core principles in this measurement system is the use of sustainably autogenous systems to increase efficiency. The practice of the present invention seeks to expose critical details of this energy cost accounting—particularly by highlighting the energy efficiencies gained from renewable energy's typical pattern of distributed production and local use.

### 5. Environmental Impact Measures

FIG. 2F is a flow chart of U.S. Greenhouse Gas Emissions (GHG) 2003 data showing the human activities which generate pollution affecting public health and environmental damage. This flow chart, published by the World Resources institute, shows the sources and activities across the U.S. economy that produces greenhouse gas emissions.²⁸ Energy use is mainly responsible for the majority of greenhouse gas emissions. Most activities produce greenhouse gases both directly, through on-site and transport use of fossil fuels, and indirectly from heat and electricity that comes “from the grid.” Arrow 210 points to Carbon Dioxide emissions; arrow 212 points to Methane emissions; and arrow 214 points to Nitrous Oxide emissions. The practice of the present invention seeks to expose critical details of GHG environmental cost accounting—particularly by highlighting the present inventor's focus on renewable energy production methods intended to achieve “zero-emissions” or “minus-emissions” (cleaning the air) when hydrogen is used as fuel for internal combustion engines in transportation and power generation. Hydrogen “burned” in an internal combustion engine or in a fuel cell produces only safe water as a by-product. The four measurement principles of the present invention (enumerated in paragraph 0055) provide a new paradigm for GHG cost analysis and toxic emissions are an important application area of comprehensive cost accounting. ²⁸ Sources & Notes: Emissions data comes from the Inventory of U.S. Greenhouse Gas Emissions and Sinks: 1990-2003, U.S. EPA (using the CRF document). Allocations from “Electricity & Heat” and “Industry” to end uses are WRI estimates based on energy use data from the International Energy Agency (IEA, 2005). All data is for 2003. All calculations are based on CO2 equivalents, using 100-year global warming potentials from the IPCC (1996), based on total U.S. emissions of 6,978 MtCO2 equivalent. Online: http://www.wri.org/chart/us-greenhouse-gas-emissions-fiow-chart

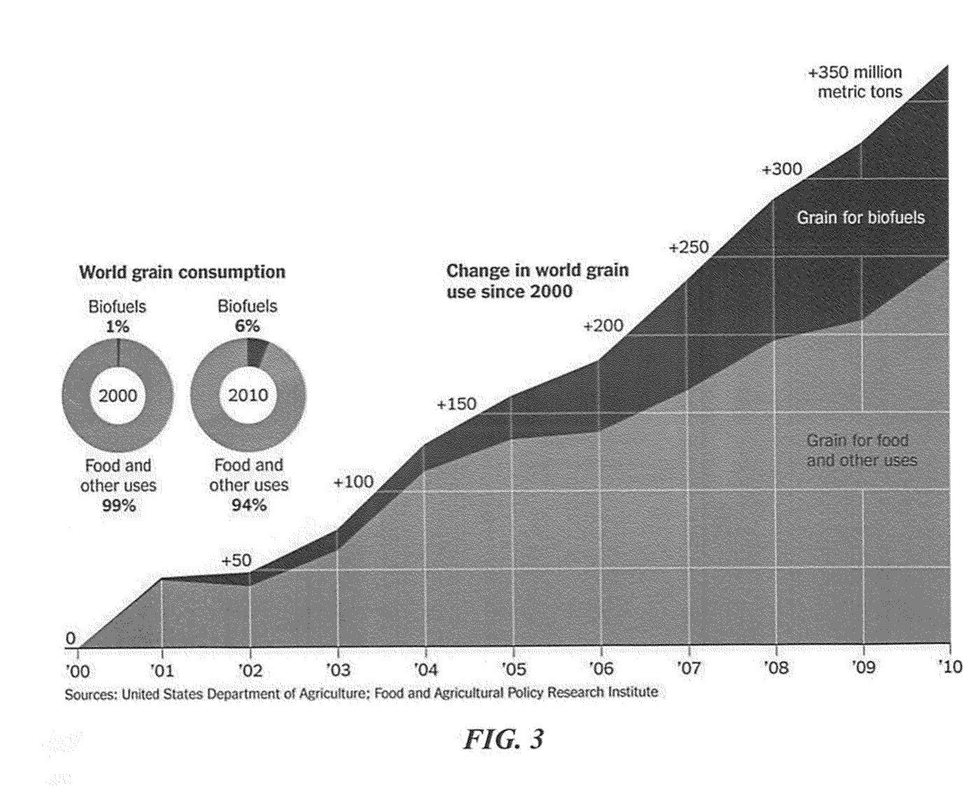

FIG. 3 shows U.S. Dept. of Agriculture: Grain for Food and Grain for Biofuels 2000-2010. The use of grain for biofuel production rather than food consumption is a critical subject for comprehensive cost accounting. Critics of ethanol production has been shown certain processes to yield an EROEI of 1:1 which means that those approaches are not cost effective, and divert needed agricultural resources away from food and water in order to put fuel in the gas tank.²⁹ In this “food vs. fuel” cost analysis there are important distinctions between methods for cellulosic ethanol production and starch-based grain ethanol production. The four measurement principles of the present invention (enumerated in paragraph 0055) provide a new paradigm for ethanol cost analysis and “food vs. fuel” is an important application area of comprehensive cost accounting. ²⁹ Online: http://www.sfgate.com/news/article/UC-scientist-says-ethanol-uses-more-energy-than-2659237.php

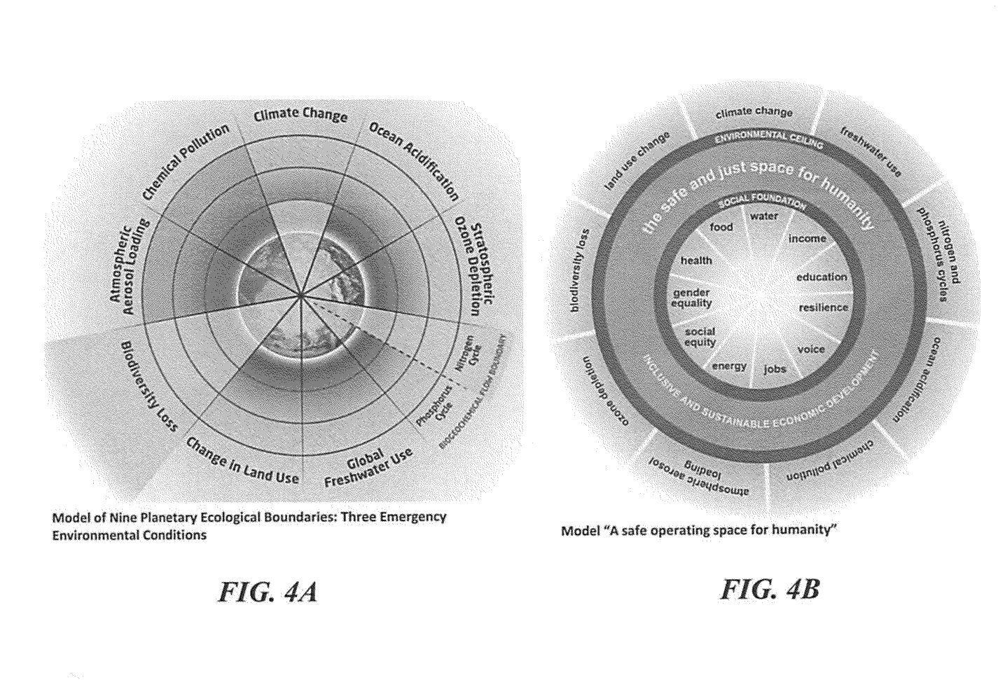

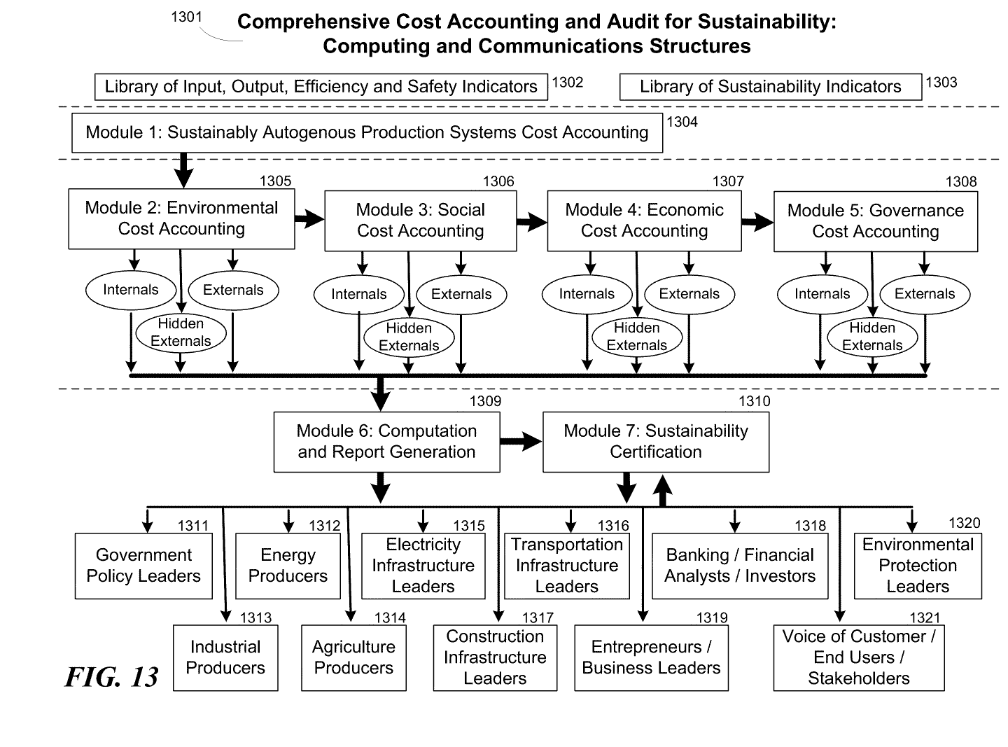

FIG. 4A shows a Model of Nine Planetary Ecological Boundaries with Three Emergency Environmental Conditions: Climate Change, Biodiversity Loss and Nitrogen Cycle Damage. The original research publication is entitled “Planetary Boundaries: Exploring the Safe Operating Space for Humanity”.³⁰ The model is responsive to the International Panel on Climate Change (IPPC) and the Millennium Ecosystem Assessment, and has identified nine planetary boundaries which may be damaging or even catastrophic due to the “risk of crossing thresholds that will trigger non-linear, abrupt environmental change within continental-to-planetary-scale systems.” The planetary boundaries include: 1. climate change (CO2 concentration in the atmosphere <350 ppm and/or a maximum change of +1 W m-2 in radiative forcing); 2. ocean acidification (mean surface seawater saturation state with respect to aragonite 80% of pre-industrial levels); 3. stratospheric ozone (<5% reduction in 03 concentration from pre-industrial level of 290 Dobson Units); 4. biogeochemical nitrogen (N) cycle (limit industrial and agricultural fixation of N2 to 35 Tg N yr-1) and phosphorus (P) cycle (annual P inflow to oceans not to exceed 10 times the natural background weathering of P); 5. global freshwater use (<4000 km3 yr-1 of consumptive use of runoff resources); 6. land system change (<15% of the ice-free land surface under cropland); 7. rate at which biological diversity is lost (annual rate of <10 extinctions per million species); 8. chemical pollution and 9. atmospheric aerosol loading. Three of these boundaries are in emergency condition based on their criteria. The researches state the importance of this model as follows: “The Earth has entered a new epoch, the Anthropocene, where humans constitute the dominant driver of change to the Earth System. The exponential growth of human activities is raising concern that further pressure on the Earth System could destabilize critical biophysical systems and trigger abrupt or irreversible environmental changes that would be deleterious or even catastrophic for human well-being. This is a profound dilemma because the predominant paradigm of social and economic development remains largely oblivious to the risk of human induced environmental disasters at continental to planetary scales.” This environmental threat model has been adopted by a European working group called “Environmental Pillar” composed of twenty-seven national environmental NGOs with the stated goals: “Promote the protection and enhancement of the environment, together with the creation of a viable economy and a just society; without compromising the viability of the planet on which we live for current and future generations of all species and ecosystems.” FIG. 4B shows a “A Safe and Just Space for Humanity” in which needed social requirements are listed in order to establish space with a “social foundation” and an “environmental ceiling” within which an “inclusive and sustainable economic development” is achieved. This set of environmental and social variables are components in the “Library of Sustainability Indicators” shown in block 1303, of FIG. 13 (Comprehensive Cost Accounting and Audit for Sustainability) of the present invention. ³⁰ Rockström, J., W. Steffen, K. Noone, Å. Persson, F. S. Chapin, III, E. Lambin, T. M. Lenton, M. Scheffer, C. Folke, H. Schellnhuber, B. Nykvist, C. A. De Wit, T. Hughes, S. van der Leeuw, H. Rodhe, S. Sörlin, P., K. Snyder, R. Costanza, U. Svedin, M. Falkenmark, L. Karlberg, R. W. Corell, V. J. Fabry, J. Hansen, B., Walker, D. Liverman, K. Richardson, P. Crutzen, and J. Foley. 2009. “Planetary Boundaries: Exploring the safe operating space for humanity”. Ecology and Society 14(2): 32. Online: http://www.ecologyandsociety.org/vol14/iss2/art32/

### 6. Triple Bottom Line Measures

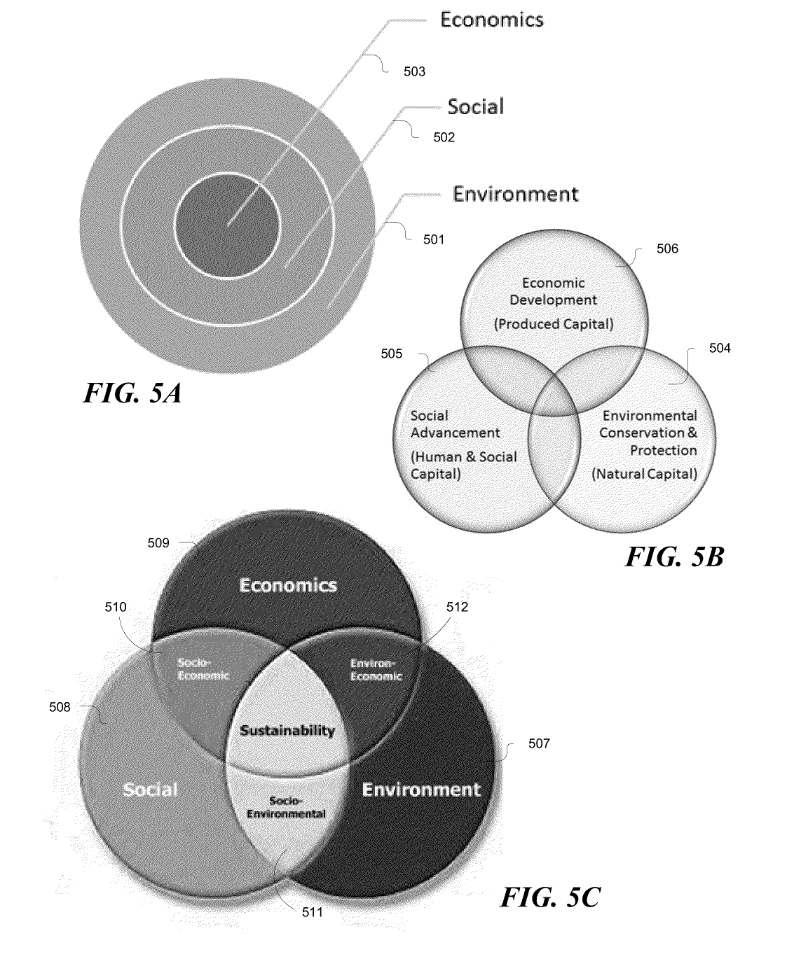

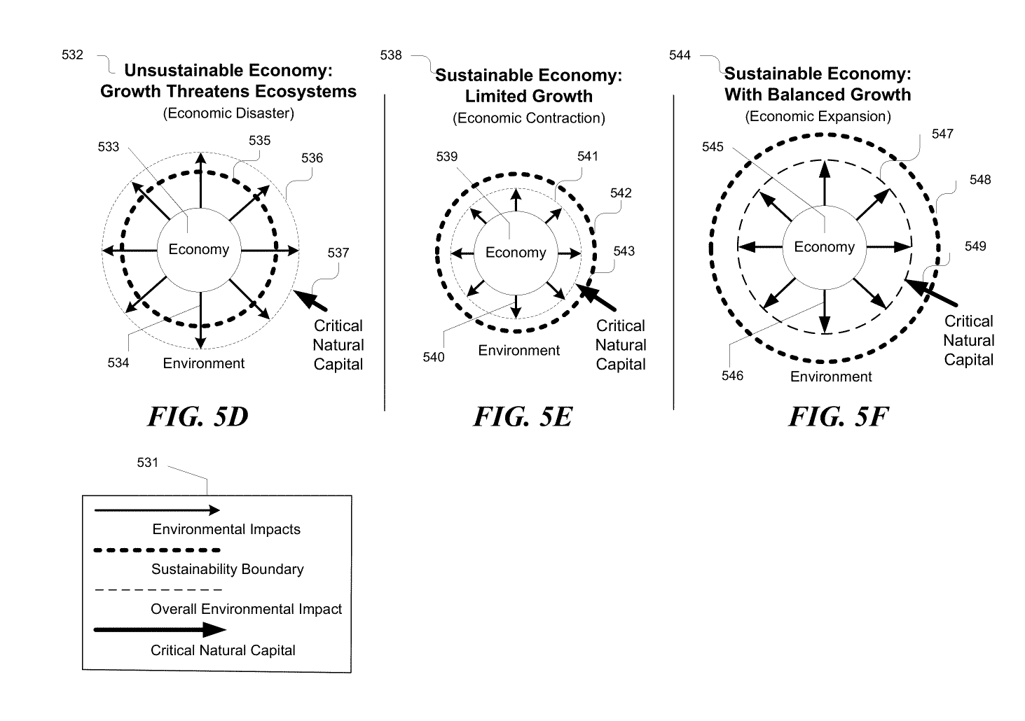

Since earliest planning of sustainability programs, such as the Bruntland Commission of the United Nations in 1987, the concept of “sustainable development” has consistently been described as having three important domains—the environment, economics, and its socio-cultural context—and that these must be treated interdependently for a sustainable balance to occur.³¹ FIGS. 5A, 5B, and 5C provide a clarifying context for the Definition of Sustainability as provided by the 1987 UN Conference: sustainable development is those that “meet present needs without compromising the ability of future generations to meet their needs” (WECD, 1987). FIG. 5A illustrates the commonly understood paradigm that the economic domain lives within the social domain, and the social domain within the environmental domain. Each of these offers unique dynamics in its own domain, but the deeper meaning of “sustainability” requires their interdependence. Unless the environmental and social domains are healthy and maintained, the economic domain cannot flourish, and vice-versa. The term “Triple Bottom Line” refers to the increasingly used approach of including social, environmental, and economic measures in business accounting.³² ³¹ “The Five Domains: A Paradigm for Urban Management,” Joslyn institute for Sustainable Communities http://nslw.org/five_domains.pdf³² Savitz, Andrew, The Triple Bottom Line: How Today's Best Run Companies are Achieving Economic, Social and Environmental success, Jossey-Bass Books, 2006.

FIG. 5A illustrates a natural hierarchy of value which is reflected in order and weight of Sustainability Indicators as practiced in the present invention: all economic human activity (produced capital) takes place within the biosphere and depends upon natural resources (natural capital), and within a social context (human and social capital). Both economy and society are constrained by environmental limits.³³ A great dilemma occurs when this natural hierarchy of value is inverted in practice and environmental resources are seen as only as objects for exploitation to serve a short-term economic agenda, or that of special interests that have gained control of natural resource extraction. Ecological economists are concerned with establishing inter-generational availability of natural resources through (a) conservation practices and (b) environmental protection against waste, pollution and exploitation. This ecological model is expressed in a quote from Gandhi: “Earth provides enough to satisfy every man's need, but not every man's greed”; or to put another way, it is the Golden Rule: “Do unto future generations as you would have them do unto you.” The contribution of Ecological economics, as practiced in the present invention, is to offer to each of the other schools of economic theory (e.g., Keynesian, Austrian, Monetarist, Biophysical, etc.) a demonstration of how the three domains (environmental, social, economic) work together synergistically by the use of Sustainability Indicators to explicitly define socio-economic “equity”, environ-economic “viability” and socio-environmental “bearability”. ³³ Scott Cato, M. (2009). Green Economics. London: Earthscan, pp. 36-37. ISBN 9781-84407-571-3.

Since biological “carrying capacity” of any ecosystem (including the planet earth as a whole system) is limited, in order to bear the burden of human economic activity that burden must not be so great to destroy ecosystem resilience, recoverability and survivability. For instance, population density, excessive extraction of natural resources, destruction of habitat and biodiversity, toxic pollution of air, streams, oceans, aquifers, systemic ocean acidification, over-fishing, poisoning the lower food chain such that contaminants/carcinogens are taken up into the higher food chain, etc., are all key indicators used in the present invention that show whether the carrying capacity of an ecosystem is being undermined. An effective model (for energy and resource production and ecosystem protection) must be able to describe the impacts of all of these domains using the language of economics. In addition, conventional petroleum-based production of energy, goods, and food often results in pollution and the release of by-products that have adverse environmental effects. The relationship between environment and the economics of energy production, materials resource production and food production are an essential consideration. These relationships and risk factors are essential for the “true cost” accounting of conventional energy production and use, and must be articulated for wise public policy and effective engineering solutions to be put in place.³⁴ ³⁴ “Pelosse, Helene. The True Costs of Conventional Energy” Online: http://www.un.org:80/wcm/content/site/chronicle/home/archive/issues2009/pid/5089

FIG. 5B is a diagram of the interdependent relationship of Economic Development (produced capital), Social Advancement (human capital and social capital), and Environmental Conservation and Protection (natural capital). A comprehensive cost accounting method, as in the present invention, computes the role of four types of capital:³⁵ (1) Manufactured Capital. Manufactured (or human-made) capital is what is traditionally considered as capital: produced assets that are used to produce other goods and services. Some examples are machines, tools, buildings, and infrastructure. (2) Natural Capital. In addition to traditional natural resources, such as timber, water, and energy and mineral reserves, natural capital includes natural assets that are not easily valued monetarily, such as biodiversity, endangered species, and the ecosystems which perform ecological services (e.g. air and water filtration, and tilth/soil development). Natural capital can be considered as the components of nature that can be linked directly or indirectly with human welfare. (3) Human Capital. Human capital generally refers to the health, well-being, and productivity potential of individual people. Types of human capital include mental and physical health, education, motivation and work skills. These elements not only contribute to a happy, healthy society, but also improve the opportunities for economic development through a productive workforce. (4) Social Capital. Social capital, like human capital, is related to human well-being, but on a societal rather than individual level. It consists of the social networks that support an efficient, cohesive society, and facilitate social and intellectual interactions among its members. Social capital refers to those stocks of social trust, norms and networks that people can draw upon to solve common problems and create social cohesion. Examples of social capital include neighborhood associations, civic organizations, and co-operatives. The political and legal structures which promote political stability, democracy, government efficiency, and social justice (are beneficial for productivity as well as being desirable sustainability values as such) are also part of social capital. ³⁵ ‘Evaluating the Contribution of the EU Structural Funds to Sustainable Development’, Professor Paul Ekins, Policy Studies Institute and James Medhurst, GHK, June 2003 Presented at the Fifth European Conference on Evaluation of Structural Funds http://europa.eu.int/comm/regional_policy/sources/docgener/evaluation/radio_en.htm

FIG. 5C illustrates a definition of Sustainability as the interdependent outcome of Economic, Environmental, and Social processes working together in balance and synergy.

TABLE B
Sustainability criteria indicated in FIG. 5C, and in FIG. 13 block 1303-
“Library of Sustainability Indicators” for classes of measurement.

| Economic Domain | Environmental Domain | Social Domain |
|---|---|---|
| Prosperity | Planet | People |
| Growing economy; | Protect the environment | Life-sustaining; |
| Equitable opportunities | for viability and | dignified, peaceful |
| for satisfying | ecological resilience; | and equitable |
| livelihoods | Protect natural resource | existence |
| | base for future | |
| | generations | |
| Development, growth; | Resource conservation, | Equity, justice; human |
| prosperity, continuity; | development; | well-being; human |
| profit; commerce | stewardship; protect the | concern for all living |
| viability; quality | functions and viability | things; safe, healthy, |
| assurance | of natural systems on | high quality of life |
| | which all life depends | for current and future |
| | | generations |
| Energy production | Product stewardship | Economic freedom |
| Industrial production | Bio-diversity | Corporate governance |
| Agricultural production | Climate change | Political governance |
| Efficiency | Finite resource protection | Responsible marketing |
| Resource use | Emissions | Working conditions |
| Reputation | Waste management | Human rights |
| Risk management | Pollution control and | Diversity |
| Intellectual capital | remediation | Educational |
| Market share | | opportunity |
| Supply chain | | Freedom of speech |
| Eco-efficiency | | Access to information |
| | | Labor practices |
| | | Community |
| | | development |
| | | Health and Safety |
| | | Rights of indigenous |
| | | people |
| Maintenance of decent | Maintenance of decent | Maintenance of decent |
| standard of living; | environmental quality; | social quality (e.g., |
| Improving economic | Improving environmental | vibrant community |
| quality | quality | life); Improving |
| | | social quality |

### 7. Carrying Capacity Measurement and Autogenous Systems

FIG. 5D shows an Unsustainable Economy: Growth Threatens Ecosystems (economic catastrophe). In this scenario the carrying capacity of world ecosystems default to unrestrained finite resource depletion, increasing toxic pollution, and waste overburden until key ecosystems fail (see FIG. 4A). This is the default future of a U.S. economic engine unwilling to recognize the limitations of world ecosystems (air, ocean, aquifers, soil, nitrogen cycle, carbon cycle, water cycle, climate, etc.).

FIG. 5E shows a Sustainable Economy: With Limited Growth (economic contraction). In this scenario the carrying capacity of world ecosystems are protected by adherence to planetary boundary standards, and human resource needs are met within limits imposed by productive use of natural resources (see FIG. 4B). This approach marks the end of “conventional economic growth” as defined by the previous century's unrestrained addiction to petroleum, and the unremitting expectation of continuous, exponential growth. In response to this economic precipice, the economist Kenneth Boulding was quoted as saying: “Anyone who believes exponential growth can go on forever in a finite world is either a madman or an economist.” The alternative mode of economic reality is based on realism to adapt to renewable energy resources.^{36 37 38} FIG. 5F shows a Sustainable Economy: With Balanced Growth (economic expansion). This depiction conveys that ecosystem carrying capacity can be expanded through renewable energy and renewable material resource engineering.³⁹ (Paragraph 0048 introduced these patented technologies by reference.) The tool of comprehensive cost accounting, as practiced in the present invention, is intended to articulate the engineering design options and impacts which can achieve this goal of rapidly expanding renewable energy production to a scale which equals and then exceeds current fossil fuel production. ³⁶ Heinberg, Richard, The End of Growth: Adapting to Our New Economic Reality, New Society Publishers, 2011.³⁷ Martenson, Chris, The Crash Course: The Unsustainable Future of Our Economy, Energy, and Environment, Wiley Books, 2011³⁸ Brown, Lester, Eco-Economy: Building an Economy for the Earth, Norton, 2001 (Earth Policy Institute)³⁹ McAlister, Roy, The Solar Hydrogen Civilization: The Future of Energy is the Future of Our Global Economy, Hydrogen Association, 2006

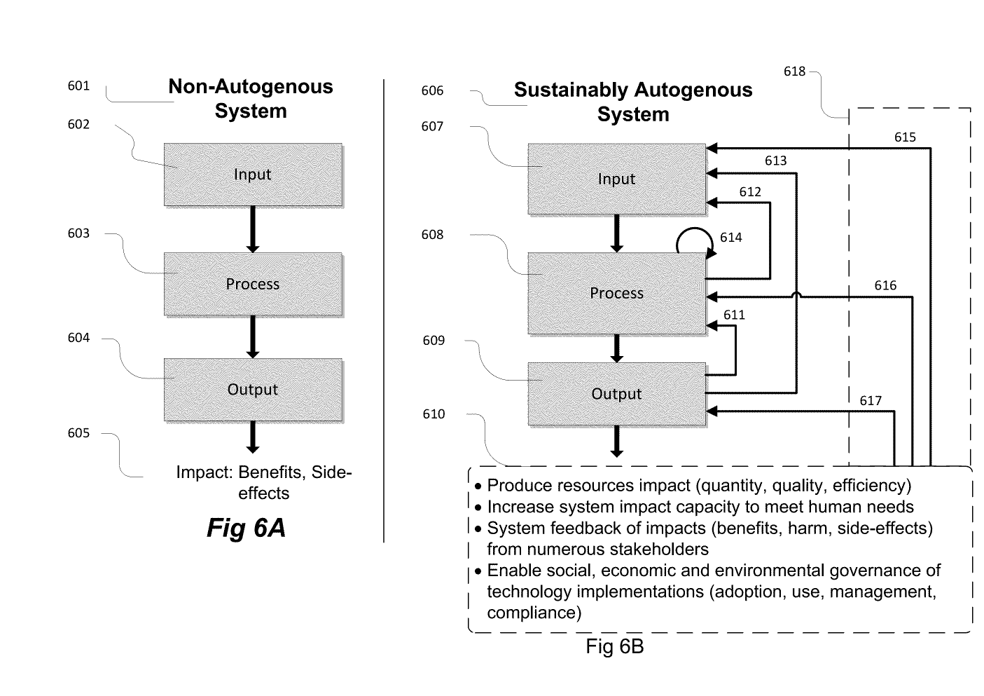

FIG. 6B shows a Sustainably Autogenous System. Autogenous systems and processes are energy systems which take on the efficiency characteristics of self-generating, self-renewing, self-sustaining functionality by use of renewable energy as illustrated in FIG. 6B. The distinction between non-autogenous systems and sustainably autogenous systems is shown graphically in FIGS. 6A and 6B. The engineering design of autogenous systems creates information feedback shown in block 618, for feedback loops 617, 616, and 615 for the purpose of (a) increasing productivity impact and benefits (quantity, quality, efficiency), (b) increasing system capacity scale in order to meet specific human needs, (c) adjusting to feedback from numerous stakeholders regarding benefits, harm and side-effects of technology functioning, (d) enable social, economic and environmental governance of technology (including adoption, diffusion, use, management and compliance). Equally important, loops 611, 612, 613, and 614 may involve transfer of energy such as recapturing waste heat or recirculating materials being processed, as well as information feedback. Sustainably autogenous systems can liberate greater natural resource capability at lower “true cost” than can be achieved by using conventional, depletive economic methods.

Human economic activity such as the conventional production of useful energy, goods, and food typically results in the release of byproducts that have adverse environmental effects. For example, human economic activity produces substantial quantities of greenhouse gas (“GHG”) emissions that cause substantial climate change. The IPAT equation, shown in Eqn. 1, generally credited to ecologist Paul Ehrlich,⁴⁰ describes the environmental impact of human activity (I) as being the product of population (P), affluence (A), and technology (T). ⁴⁰ The Encyclopedia of Earth: IPAT equation, Online: http://www.eoearth.org/article/IPAT_equation

I=PAT (Eqn. 1)

Expressed in the slightly different fashion shown in Eqn. 1B, the IPAT equation illustrates that for a fixed population (P) and fixed environmental impact (I), affluence (A) can increase only if the portion of environmental impact attributable to technology (T) is reduced. Expressed in this way, the IPAT equation illustrates how sustainable technologies such as autogenous systems and methods can increase the effective carrying capacity of the earth by increasing affluence, as measured by increased production and consumption of food/nutrients, energy, and durable products.

$$A = \frac{I}{P} \frac{1}{T} \qquad ( Eqn . 1 B )$$

The Kaya Identity, shown in Eqn. 2, is an equation that relates factors that establish the level of emissions of the greenhouse gas (“GHG”) carbon dioxide (CO2). The Kaya Identity can be thought of as a refinement of the IPAT equation. The Kaya Identity states that the total carbon emission level (C) can be expressed as the product of four variables or drivers: population (P), gross domestic product (GDP) per capita or average income (P/GDP), the energy intensity of the economy (E/GDP), and the carbon intensity of energy (C/E). Although the Kaya Identity was developed to describe the variables that influence GHG emissions, the equation reasonably captures the key drivers of other pollutants produced by human economic activity, e.g., waterborne, soil borne, and solid waste disposal pollutants.

C=P*(GDP/P)*(E/GDP)*C/E (Eqn. 2)

H. Hummel has proposed a refinement of the Kaya Identity, shown in Eqn. 3, that further distinguishes and mathematically decomposes the energy intensity and carbon intensity factors as separate issues.

C=P*(GDP/P)*(FE/GDP)*(PE/FE)*(TC/PE)(C/TC) (Eqn. 3)

As described in Hummel's Ph.D. dissertation⁴¹, in the decomposed Kaya Identity, PE refers to the primary energy, which is, generally speaking, the energy in fuels at the point of extraction, and FE refers to final energy, which is the energy that is actually available for a productive end use. In Eqn. 3, FE/GDP is the final energy intensity of economic activity, PE/FE is the energy supply loss factor, TC/PE is the carbon intensity of primary energy, and C/TC is the fraction of total carbon that is released into the atmosphere. As Hummel explains in his dissertation, the energy supply loss factor reflects the efficiency of energy supply conversion, the balance of demand for final energy sources, and the balance of primary energy fuels for each final energy type. Assuming population and average income continue to increase monotonically in the future, only four variables remain for reducing total atmospheric carbon emissions and other pollutants. These drivers are the final energy intensity of the economy, the energy supply loss factor, the total carbon intensity of primary energy, and the fraction of total carbon that is released into the atmosphere. ⁴¹ L. Holmes Hummel, “Interpreting Global Energy and Emissions Scenarios: Methods for Understanding and Communicating Policy Insights” (December 2006) (unpublished Ph.D. dissertation, Stanford University), available at www.stanford.edu/˜hummel/Dissertation.htm.

As described in greater detail herein, autogenous or self-generating systems hold the promise of reducing these critical Kaya variables, and thus reducing overall emissions of various forms of atmospheric carbon and other pollutants. Autogenous systems intentionally capture the byproducts of a production sub-process and locally utilize the captured byproducts to create useful co-products. For example, an autogenous system may capture the CO₂ that results when a gaseous fuel product such as methane is generated by a first production process. In contrast to pure sequestration techniques, an autogenous system then locally utilizes the captured CO₂ byproduct as an input to a second production process within the same system to create one or more additional useful co-products (e.g., the carbon dioxide component of closed-cell foam insulation, or carbon dioxide erected floats for harnessing wave energy, or carbon-based coatings). An autogenous system may then utilize the byproducts of the subsequent production processes as inputs to additional production processes within the system, and so on. Since autogenous systems avert emissions by creating useful co-products instead, they may have a lower fraction of total carbon and other pollutants that is disposed to the environment. Additionally, since more useful products are produced for the same quantity of final energy, autogenous systems may reduce the final energy intensity of economic activity.

Furthermore, an autogenous system typically uses abundant energy and material resources such as carbon waste streams, solar energy, and wind energy. Utilization of renewable energy sources reduces the total carbon intensity of primary energy. The use of renewable materials prevents the depletion of finite resources, such as finite mineral and oil reserves. Furthermore, autogenous systems that use renewable waste streams as feedstocks or inputs provide the ability and facilitate profitable opportunities to remove pollutants from the environment.

A “decoupled” autogenous system further reduces critical Kaya factors. A decoupled autogenous system is a system that decouples from the global supply chain by utilizing local renewable inputs and producing multiple outputs, such as fuel/energy, nutrient/agrarian products, and durable goods that are usable by a local population. A decoupled autogenous system primarily utilizes inputs that are potentially plentiful and subject to production near the autogenous system. For example, a decoupled autogenous system may use a locally available and constantly replenished carbon-based waste stream as feedstock, instead of utilizing and being dependent upon finite fossil fuel resources obtained by energy-intensive transportation from distant sources such as imports from foreign nations. Decoupled autogenous systems may also recycle locally-available finite resources, for example, by repurposing locally-available scrap engines, rather than using virgin resources. Illustratively, repurposing used vehicle engines by replacement of worn parts and components to enable extended life for utilizing locally produced renewable fuels to produce electrical energy and various forms of heat for applications such as manufacturing operations can greatly reduce the direct energy cost and environmental impact for anti-inflationary local production of goods and services. In many instances the energy utilization efficiency can be doubled compared to conventional Rankine-cycle central utilities that generate heat by expenditures of coal or uranium that requires trans-continental or trans-oceanic transport. Further, conventional power plants reject up to two units of energy in order to develop one unit of electrical energy that is distributed to distant customers by the electric grid. Central utilities generate ash and/or radioactive wastes that are disposed of by further expenditures of finite fuel and material resources.

The decentralized approach to sourcing/recycling inputs (including energy inputs) and utilizing outputs may reduce the energy supply loss factor at least in part by reducing energy distribution costs. The decentralized approach also averts the need for (1) the long-haul transportation of raw inputs from a global supply chain to the site of production, and (2) the long-haul transportation of finished products from the site of production to global customers. The decentralized approach thus has the potential to reduce the final energy intensity of the economy. In addition the decentralized approach justifies greater job development potentials because of the anti-inflationary benefit of more efficiently exploiting renewable instead of finite resources and using recycled finite resources over virgin finite resources. In short, decentralized, autogenous systems have the potential to substantially reduce pollutant emissions by reducing Kaya factors, even as the population and economic activity increases.

In addition to environmental benefits, autogenous systems have greater potentials for new innovations to reduce the direct monetary or pecuniary cost of products. Autogenous systems reduce pecuniary costs by producing a useful product from abundant and less-expensive resources (i.e., local carbon-based inputs and renewable energy sources) instead of from scarce, which can be more expensive to obtain, and more-expensive resources (i.e., petrochemical inputs). Additionally, autogenous systems create larger quantities of useful co-products instead of producing large quantities of waste. These co-products permit manufacturers to generate additional sales for the same fixed quantity of inputs and to avoid the cost of waste disposal. In short, autogenous systems provide a greater energy and material return on the raw energy and material invested into the system, making the potential for profits much higher.

Furthermore, autogenous systems have socially desirable effects. For example, by making local energy and manufacturing operations economically viable, decoupled autogenous systems can create and well afford skilled-labor jobs in rural or other areas that are currently economically depressed. Additionally, the energy and manufacturing operations provide demand for improved educational and training systems to create a local workforce that aspires to participate in cutting-edge energy, materials, and manufacturing technologies. Furthermore, by avoiding finite inputs that are localized in a handful of regions, such as petrochemicals and scarce rare earth and precious metals autogenous systems avoid the military and social costs created by material exploration, extraction, and wasteful exploitation.

Making the switch from conventional production systems to autogenous production systems may require a significant shift in economic and energy policies. Each autogenous system site may also require significant up-front costs, such as capital investments in new autogenous system infrastructures and personnel investments. Therefore, it is desirable to have a succinct but comprehensive economic cost model that quantifies the three-prong benefits of autogenous systems: reduced environmental impacts, reduced pecuniary production costs, and increased social benefits. Such an economic model may stimulate the policy and capital investments needed for switching to autogenous production systems.

Such a cost model could, for example, demonstrate that the three-prong reduction in costs achieved by autogenous systems makes such systems highly suitable for large scale (e.g., terawatt) domestic, green energy production.

### 8. Full Spectrum Energy Production Systems

An example of large scale renewable energy production is the Renewable Energy Park design elaborated in patent applications: SUSTAINABLE ECONOMIC DEVELOPMENT THROUGH INTEGRATED PRODUCTION OF RENEWABLE ENERGY, MATERIALS RESOURCES, AND NUTRIENT REGIMES (U.S. patent application Ser. No. 12/857,553); SYSTEMS AND METHODS FOR SUSTAINABLE ECONOMIC DEVELOPMENT THROUGH INTEGRATED FULL SPECTRUM PRODUCTION OF RENEWABLE ENERGY (U.S. patent application Ser. No. 12/857,541); and SUSTAINABLE ECONOMIC DEVELOPMENT THROUGH INTEGRATED FULL SPECTRUM PRODUCTION OF RENEWABLE MATERIAL RESOURCES (U.S. patent application Ser. No. 12/857,554), which we will refer to as FuSE, meaning Full Spectrum Energy technology and community installation.

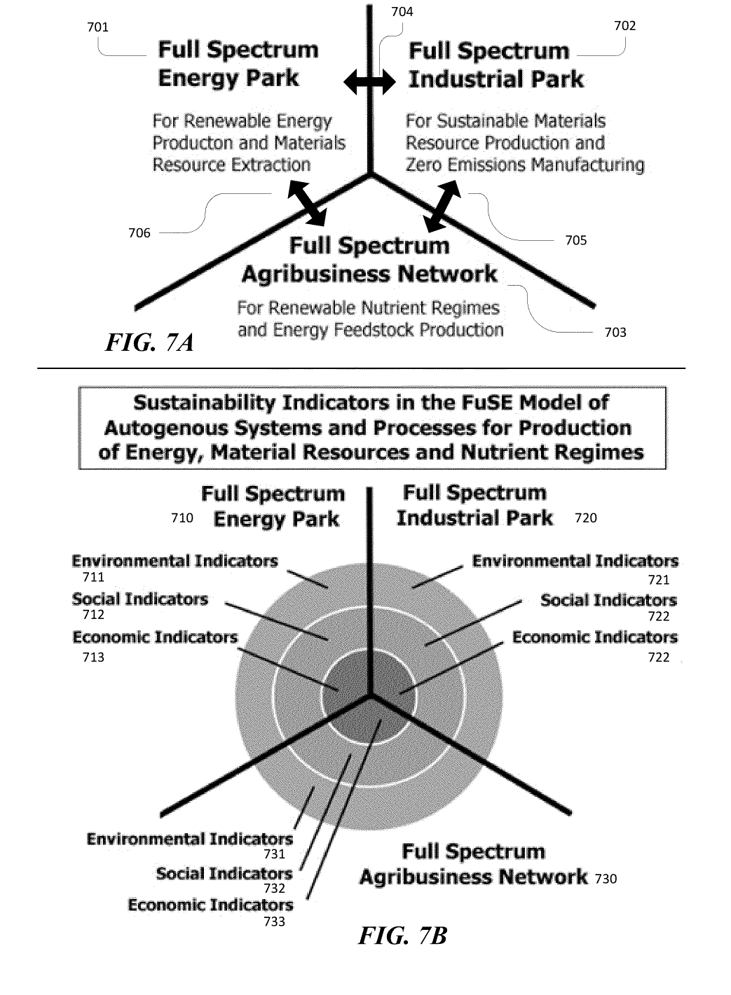

FIG. 7A shows the FuSE installation as the integration of 1. a Renewable Energy Park (shown in block 701) for generation of electricity, production of fuel, and extraction of material resource from biomass feedstock, 2. an Industrial Park (shown in block 702) for sustainable materials resource production and zero emissions manufacturing), and 3. Agribusiness Network (shown in block 703) for production of a variety of agricultural products including food, water, animal feed, and biomass energy feedstock. The uniqueness of design is to increase renewable energy production capacity by combining, synergizing, and aggregating the variety of renewable energy types which are appropriate to a particular geographic location in order to achieve a measurable increase in thermodynamic capacity. The energetic linkage of solar thermal and geothermal by way of working fluids enables an incredible volume of renewable energy to be harvested daily. In addition, the generation of microclimate enables artificial wind production (driven by solar heat during the day, and retrieval of banked heat at night) and optimized biomass growing zones. Solar heat is used to harvest and purify water. The dynamic interaction between the three systems (energy park, industrial park and agribusiness network interact synergistically) enabling new capacity for economic production to be established. Energy, material resource extraction (particularly carbon), biomass feedstocks, and finished goods to enhance production are exchanged in business processes shown in Arrows 706, 704 and 705. Such an installation can be placed into virtually any geographic location, and adapt its design parameters to the climate and natural resource environment. Thus, it provides a means to create permanent jobs which cannot be outsourced, which are based in renewable energy community development. The output of the FuSe system is Energy, Material Goods built from Carbon, Food and Water.

FIG. 7B shows an array of Sustainability Indicators used in the FuSE Model of autogenous systems and processes for production of energy, material resources and nutrient regimes. The FuSE grid shown in FIG. 7A is combined with the natural value hierarchy of FIG. 5A to organize use of a Library of Sustainability Indicators shown in FIG. 13, block 1303: to include Environmental Indicators 711, 721, and 731; Social Indicators 712, 722 and 732, and Economic Indicators 713, 722, and 733. The successful adaptation of a FuSE installation to a local setting (community, geography, ecosystem, natural resources, and climate) optimally requires use of the Comprehensive Cost Accounting system and method of the prevent invention in order to enable data-driven design and implementation decisions, and long-term monitoring of facility effectiveness and efficiency.

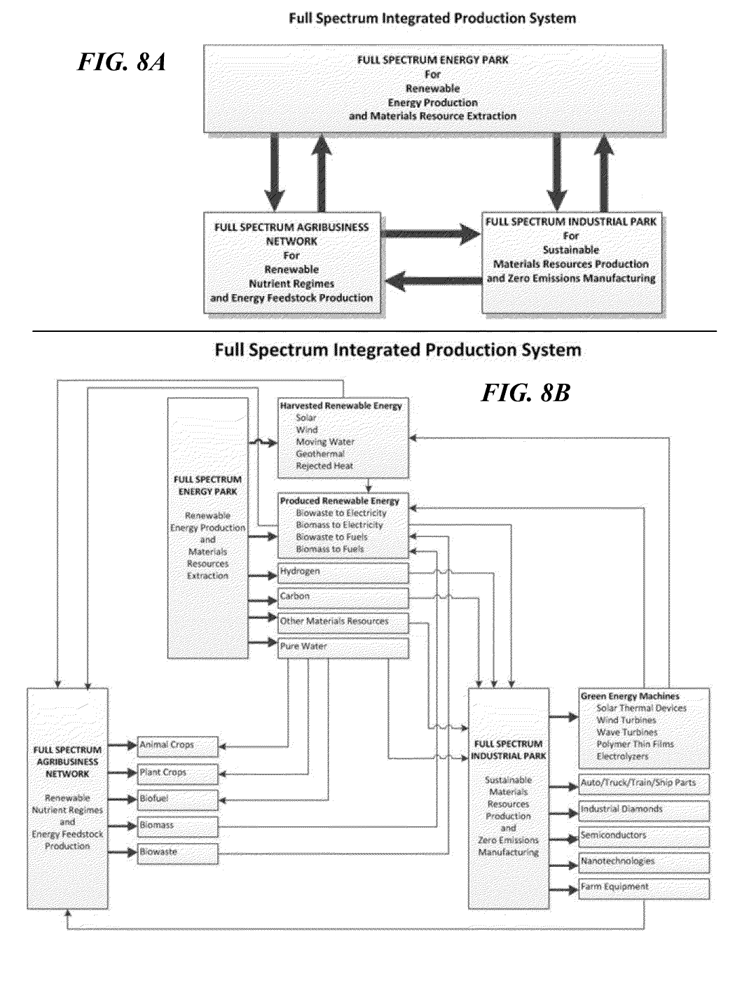

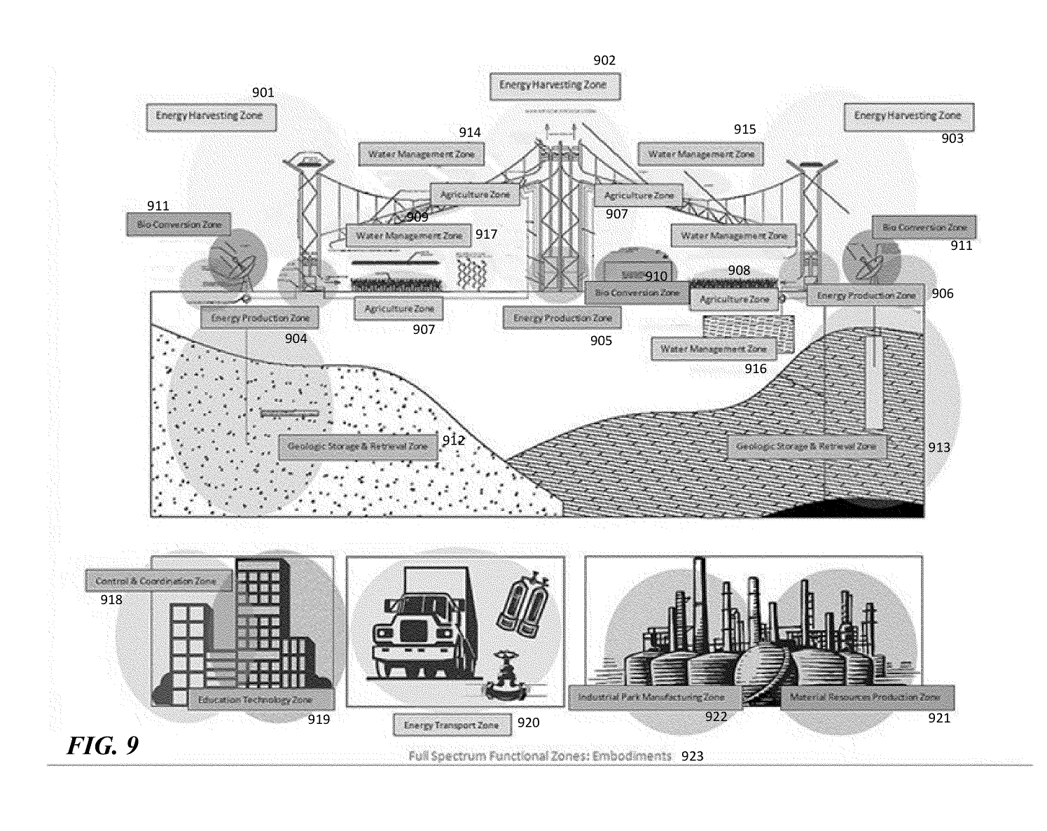

FIGS. 8A and 8B show the Full Spectrum Integrated Production System as presented the patent applications. FIG. 9 shows the Full Spectrum Functional Zones applicable for Land and Permafrost Embodiments. The Functional Zones enable adaptive ecological engineering applied to work zones (integrating facility, infrastructure, equipment, human workflow, energy transfers, and automation). Work Zones include: Energy harvesting zone, Energy production zone, Water management zone, Agriculture zone, Bio conversion zone, Geological storage and retrieval zone, Energy transport zone, Industrial park manufacturing zone, Material resources production zone, Education technology zone, and Control and coordination zone. While a small FuSE installation such as a rural farm would not typically require all of these work zones, a large scale installation, as in a major renewable energy park would typically integrate all of these zones. Sustainability indicators provide measures for each of these zones of work. Also, FIG. 13, block 1302 shows a Library of Input, Output, Efficiency and Safety Indicators which are also provide measures for these zones of work. The large central artificial wind plant is shown as block 902 in FIG. 9. Geothermal banking (storage and retrieval of thermal energy) is shown in block 913. Solar Thermal Harvesting is shown in blocks 904 and 906. Biomass conversion, including wastewater electrolysis, is shown in block 910. Renewable energy park installations capitalize on the dynamic benefits of various renewable energy resources available at a particular site: Solar (thermal, photovoltaic), Wind, Geothermal, Moving Water/Hydro-dynamics, Biomass/Biowaste, and so forth.

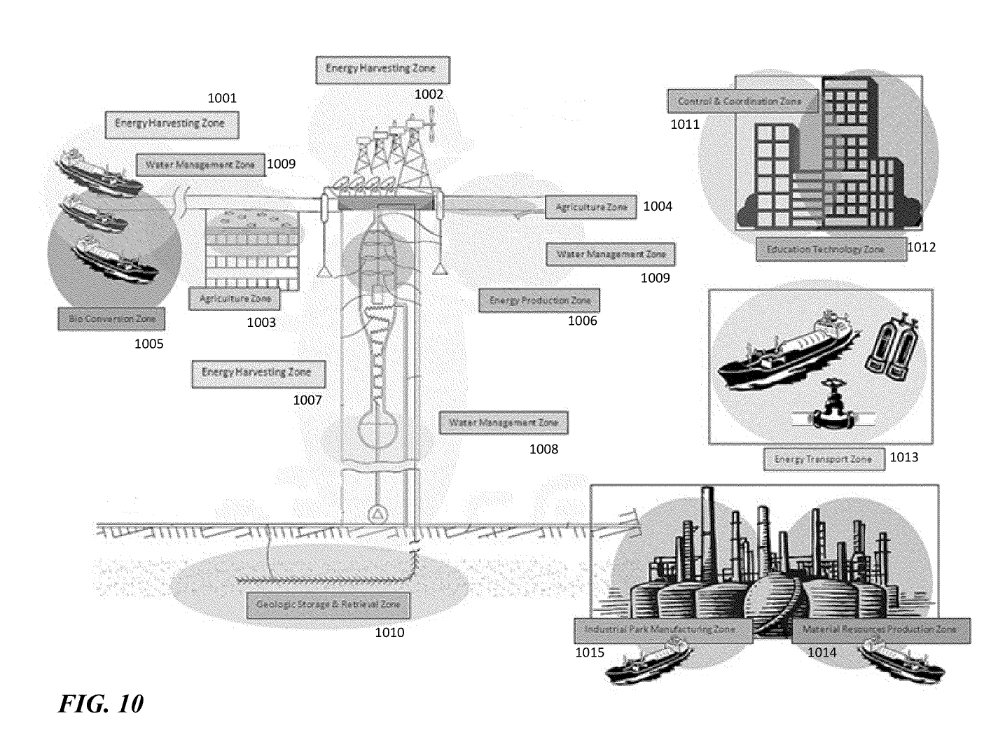

FIG. 10 shows the Full Spectrum Functional Zones of the FuSE Ocean Embodiment, as taught in the patent application: METHOD AND SYSTEM FOR INCREASING THE EFFICIENCY OF SUPPLEMENTED OCEAN THERMAL ENERGY CONVERSION (SOTEC) (U.S. patent application Ser. No. 12/857,546). The floating platform of the SOTEC system integrates all three elements of the FuSE model, applying the sustainable production methods for energy, material resource and nutrient regimes with the resulting outputs: electricity generation, fuel production, biomass conversion, solar thermal and geothermal linkage, carbon extraction for manufacturing, manufacturing, growing zones for food, fish, algae biomass, water harvesting and purification, and more.

The renewable energy harvesting potential of the ocean is vast. In addition, to the general FuSE design elements, ocean installations enable solar ocean thermal energy conversions (SOTEC). The SOTEC installation also offers a platform for Methane Hydrate Harvesting as taught in patent application: GAS HYDRATE CONVERSION SYSTEM FOR HARVESTING HYDROCARBON HYDRATE DEPOSITS (U.S. patent application Ser. No. 12/857,228). Methane Hydrates are the most extensive natural gas energy resource in the world with conservative estimates that reserves of methane hydrates are double the amount of fossil hydrocarbon fuels.⁴² U.S. Geological survey estimates the United States has about 320,000 Tcf of methane hydrate resources. Comprehensive Cost Accounting for ocean installations provides an integrative model of sustainability indicators that includes: FuSE, SOTEC and Methane Hydrate harvesting. ⁴² U.S. Geologic Survey, U.S. Dept. of Interior, “Natural Gas Hydrates: Vast Resource, Uncertain Future,” Online: http://pubs.usgs.gov/fs/fs021-01/fs021-01.pdf

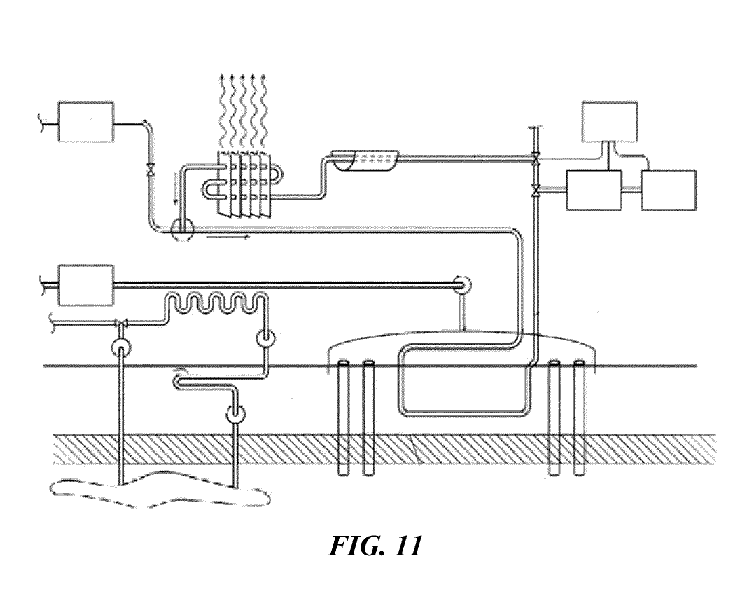

Extreme warming FIG. 11 shows the FuSE Permafrost Embodiment: System and method for Collecting and Processing Permafrost Gases and for Cooling Permafrost. xxx⁴³ ⁴³ The Environment Times, “The UN issues an early warning about melting permafrost” http://www.grida.no/publications/et/at/page/2545.aspx

### 9. Comprehensive Cost Modeling System and Method

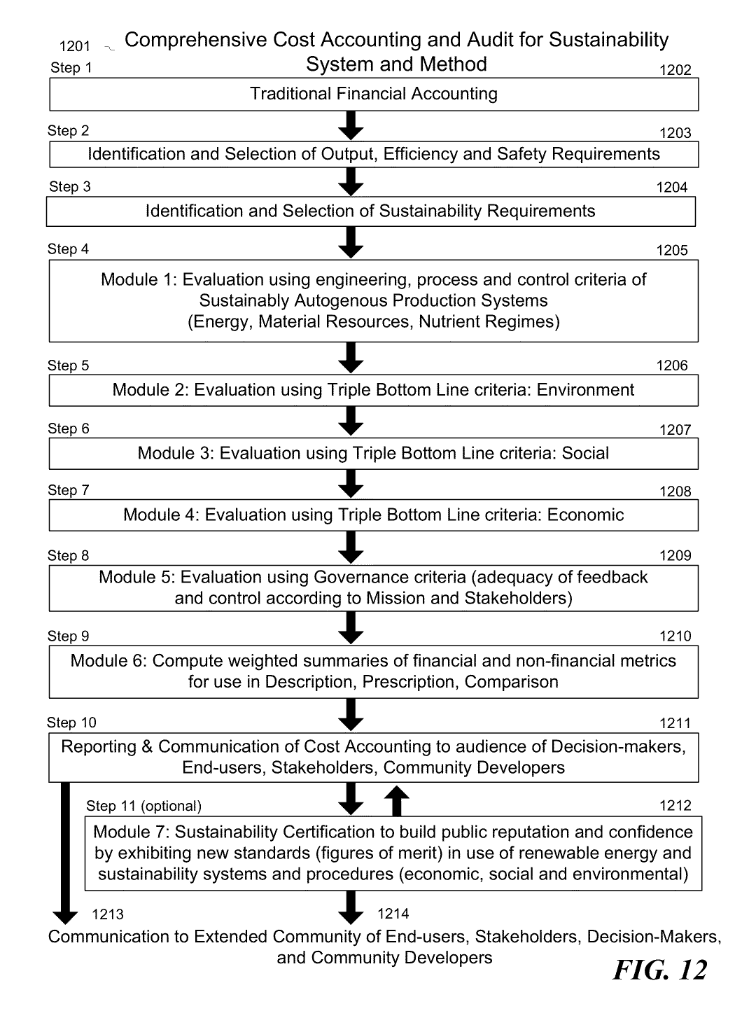

FIG. 12 is a flow diagram of the system and method of Comprehensive Cost Accounting and Audit for Sustainability, shown in block 1201, with the process steps as follows: Step 1 in this method is to conduct Traditional Financial Accounting to establish sound fiscal management, planning, and budget controls, as shown in block 1202. Step 2 is to identify and select Output, Efficiency and Safety Requirements which will accomplish fundamental engineering, shown in block 1203. Step 3: identify and select Sustainability Requirements which describe the mission, implantation requirements, program constraints, outcome, performance, and conditions of satisfaction, shown in block 1204. Step 4: use Module 1: to conduct evaluation using engineering, process and control criteria of Sustainably Autogenous Production Systems (i.e. particularly to evaluate production methods to achieve Energy, Material Resources, and Nutrient Regimes outcomes), shown in block 1205. Step 5: use Module 2: to conduct evaluation using Triple Bottom Line criteria: Environmental sustainability measures, shown in block 1206. Step 6: use Module 3: to conduct evaluation using Triple Bottom Line criteria: Social sustainability measures, shown in block 1207. Step 7: use Module 4: to conduct evaluation using Triple Bottom Line criteria: Economic sustainability measures, shown in block 1208. Step 8: use Module 5: to conduct evaluation using Governance criteria (to insure adequacy of feedback and control according to goals of the program mission and the needs and requests of stakeholders), shown in block 1209. Step 9: use Module 6: to compute weighted summaries of financial and non-financial metrics to develop program summary Description, Prescriptive scenarios of possible methods and outcomes, and Comparison of existing and potential outcomes, shown in block 1210. Step 10: deliver reports and communication of Cost Accounting or Audit to the audience of various Decision-makers, End-users, Stakeholders, and Community Developers, shown in block 1211. Step 11 is optional: use Module 7: to conduct a Sustainability Certification process which is designed to build public reputation and confidence in the program being approved and recognized for exhibiting standards of performance in the use of renewable energy and sustainability systems and procedures (economic, social and environmental), shown in block 1212. The final event in the process is Communication to the Extended Community of End-users, Stakeholders, Decision-Makers, and Community Developers about the program results and benefits, and areas of needed improvement or risks.

FIG. 13 shows system diagram of Comprehensive Cost Accounting and Audit for Sustainability, emphasizing computer program structures and communications protocols, shown in block 1301,

The Library of Input, Output, Efficiency and Safety Indicators, shown in block 1302, is a digital catalogue of engineering measures and assessment criteria to serve as guides in planning and evaluation of input, output, efficiency and safety. The Library of Sustainability Indicators, shown in block 1303, is a digital catalogue of numerous environmental, social, economic and governance measures and assessment criteria which serve as templates and guides for a wide-variety of programs, installations, products and/or services.

Module 1:

Sustainably Autogenous Production Systems Cost Accounting, shown in block 1304, is a computer software program that supports evaluation, planning and assessment focused on the following primary criteria: (a) efficiency engineering to achieve measurable increases in EROEI; (b) integrative design engineering to achieve increased energy production capacity by combination, synergizing and aggregation of solar, wind, geothermal, moving water, biomass conversion, and/or other modalities of renewable energy harvesting and production; integrative design engineering to achieve measurable increases in economic capacity of energy, material resource and nutrient regime production; (d) infrastructure engineering of hydrogen-carbon dissociation to achieve measurable increases in renewable fuel value and measurable increases in renewable material resource value; (e) measuring economic impact of human resources (measure may include items such as job creation, local leadership activity, program governance, mission development, entrepreneurship, innovation, and community development).

Module 2:

Environmental Cost Accounting, shown in block 1305, is a computer software program that supports evaluation, planning and assessment of environmental impacts, ecosystem health, and natural resource use. Criteria include measures of ecological impact, resource conservation, protection of bio-diversity, finite resource protection, emissions monitoring, climate change influence, waste management procedures, pollution control and remediation procedures.

Module 3:

Social Cost Accounting, shown in block 1306, is a computer software program that supports evaluation, planning and assessment of social impact, including individual and community dignity, peace, social justice and equity; the role and status of the individual, groups and families in building healthy workplaces and community. Criteria include inclusive concern for all living things (people, animals, plants, ecosystems), safety, health, quality of life, future generation resources, economic freedom, corporate governance and rights, political governance and rights, human rights, responsible marketing, working conditions, diversity, educational opportunity, freedom of speech, access to information, labor practices, and community development.

Module 4:

Economic Cost Accounting, shown in block 1307, is a computer software program that supports evaluation, planning and assessment of economic process, particularly related to sustainability practices in energy, material resource and nutrient regime. This module is designed to address any energy sustainability issues which were not captured in Module 1. Criteria includes economic development for prosperity, continuity, profit, commercial viability; energy production, industrial production, agricultural production, efficiency measures, resource use, reputation, risk management, development of intellectual capital, market share, supply chain, quality assurance and eco-efficiency.

Module 5:

Governance Cost Accounting, shown in block 1308, is a computer software program that supports evaluation, planning and assessment in the adequacy of participation in management, budget, leadership, access to information, transparency of financial accounting, transparency of natural resource accounting, and transparency of reporting processes. The goal of this module is to insure communication and feedback systems are functioning effectively, with quality and with sensitivity to the needs of a wide variety of stakeholders.

Module 6:

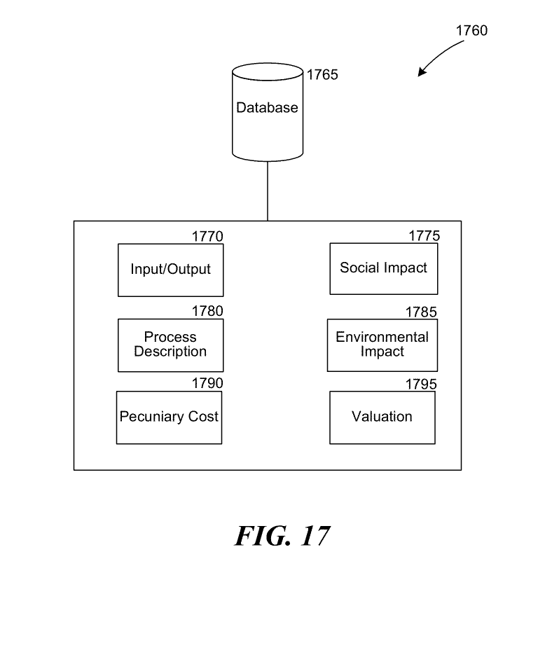

Computation and Report Generation, shown in block 1309, is a computer software program that compiles, and integrates scores across the different domains and from all other modules. The program pulls data in from the baseline of Traditional Accounting reports, and links this data to the extended information externality costs identified through the other modules: Autogenous Production System cost accounting in Module 1, environmental cost accounting in Module 2, social cost accounting in Module 3, economic cost accounting in Module 4, and governance cost accounting in Module 5 in order to provide meaningful and contextualized computation of ROI, EROI and EROEI. The program summarizes the results for evaluation, planning and assessment; computes weighted scores. These weighted scores force visibility of resource depletion, waste, and gross inefficiency practices, and replacement cost calculations are performed. Beneficial weighted scores are provided by sustainability practices that harvest carbon as a value for manufacturing, and thereby prevent carbon from being burned or entering the ecological waste-stream. Beneficial weighted score also results from local and regional adaptive engineering to maximize geographical and community advantages. The software automation publishes a digital report and graphs of the summary. FIG. 17 provides a system block diagram of these computer software structures to include integration of data sets, weighted scoring and report generation by way of the following named software and hardware structures: database, input/output means, process description, pecuniary cost algorithm, social impact algorithm, environmental impact algorithm, and valuation algorithm.

Module 7:

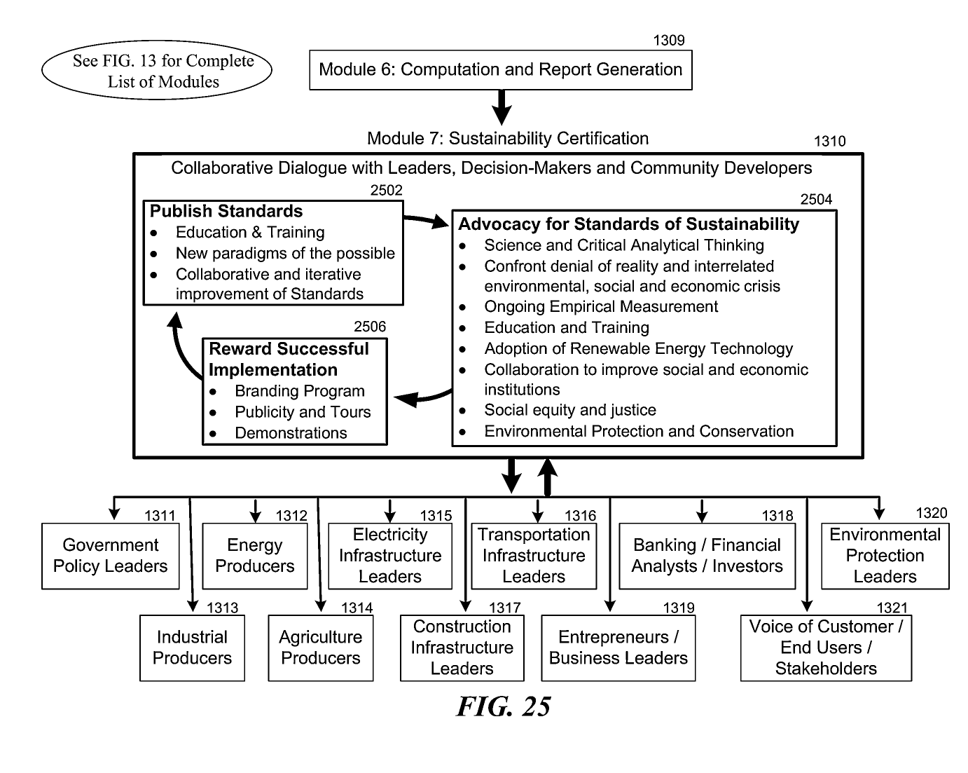

Sustainability Certification, shown in block 1310, is a computer software program that supports evaluation, planning and assessment leading to approval and public recognition certification status. FIG. 25 of this invention provides expanded description of this process, which shows publishing sustainability standard, advocacy for sustainability standards and rewarding successful implementation of sustainability standards.

Engagement with participants in the Cost Accounting and Audit for Sustainability involves reporting and communication with potentially a wide-variety of stakeholders with different information needs such as: scientific, technological, fiscal, business, commerce, educational, research, social, political environmental and economic. The potential stakeholder audiences include: Government Policy Leaders, shown in block 1311; Energy Producers, shown in block 1312; Industrial Producers, shown in block 1313; Agriculture Producers, shown in block 1314; Electricity Infrastructure Leaders, shown in block 1315; Transportation Infrastructure Leaders, shown in block 1316; Construction Infrastructure Leaders, shown in block 1317; Banking/Financial Analysts/Investors, shown in block 1318; Entrepreneurs/Business Leaders, shown in block 1319; Environmental Protection Leaders, shown in block 1320; Voice of Customer/End Users/Corporate Stakeholders, and Community Stakeholders, shown in block 1321.

### 10. An Introduction to the Costs of Depletive Production Systems and Processes

Comprehensive cost models should have equal applicability to conventional systems in order to permit ready and meaningful comparisons between conventional systems and autogenous systems. For this reason, provided herein is an introduction to the typical costs of conventional production systems, including the costs associated with depleting finite inputs and releasing adverse byproducts into the environment.

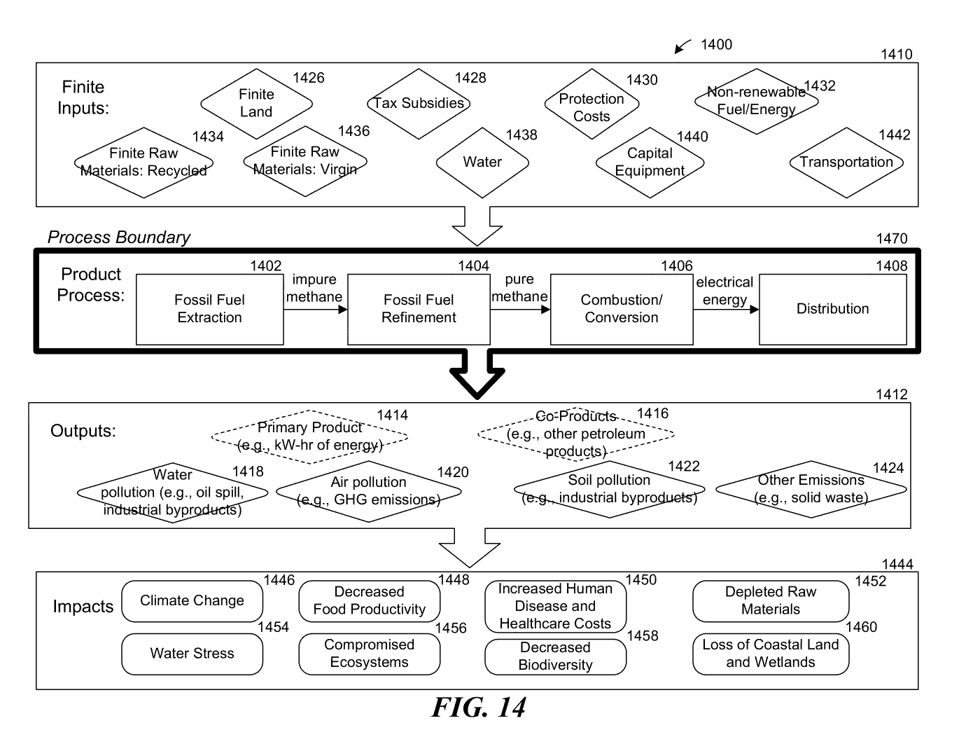

FIG. 14 shows an illustrative example of a conventional process for producing electrical energy as a useful product; as shown, the process is comprised of four distinct sub-processes. As shown, in the example process, a finite fossil fuel resource such as methane gas is extracted, refined, and then combusted. Some thermodynamically limited percentage of the combustion energy is then converted into electrical energy, and finally some fraction of the electrical energy product according to the efficiency of the distribution system is delivered to end consumers. Thus, customers of central utilities typically pay the utility to reject two units of energy to the environment for each unit of electrical energy that is received by the customer. In addition to rejecting heat into the environment large amounts of water may be heated and/or evaporated to do so by the Rankine-cycle steam condensers at the central power plant.

As shown at the top portion of FIG. 14, each sub-process requires several finite inputs that may include: finite raw material (virgin and/or recycled; e.g., natural gas); non-renewable fuel or another energy source to drive operations; water; capital equipment; finite land, and transportation services. For example, capital equipment may include: drilling/extraction equipment, refining equipment, a generator, and an electrical distribution system (e.g., sub-stations and overhead electrical wires). As another example, transportation may be required to transport raw, impure hydrocarbon extracts to a refinery and to transport a refined product (e.g., more pure diesel fuel or methane after some degree of removal of sulfur and heavy metal contaminants) to the site of combustion. Furthermore, inherently, the conventional system may also indirectly derive additional economic inputs in the form of tax subsidies and/or protection costs. Additionally, although not shown in FIG. 14, each of the inputs to the energy production process is created by an upstream process that consumes additional finite material resources and non-renewable energy. For example, the drilling equipment needed for energy production may be created from an upstream process involving extraction (e.g., of finite iron ores), refinement (e.g., smeltering), and the manufacture and assembly of drilling components. As another example, the fuel used to power the drilling, production and beneficiation equipment must be extracted, refined and distributed. Similarly, downstream uses of the product may also consume finite resources and/or utilize energy.

As shown in FIG. 14, each sub-process produces several outputs, including a primary product that is measured in terms of a functional unit (“FU”). In the example, the FU of primary product may be a kilo-Watt-hour (kW-hr) of electrical energy derived from the combustion of methane. The process may also result in the production of useful co-products other than the primary product, such as petroleum products extracted in conjunction with the methane. Additionally, each sub-process may produce undesirable outputs or byproducts such as water pollution (e.g., oil spills or effluents from an extraction and/or refinement sub-process), air pollution (e.g., atmospheric CO2 emissions at the site of combustion), soil pollution (e.g., from runoffs at the extraction and refinement sites), solid wastes, or other undesirable emissions. Undesired outputs result not just from the main process shown in FIG. 14, but also upstream processes used to create the inputs to the main process and/or downstream processes occurring after the primary product has been distributed to the end user.

FIG. 14 also shows the various economic and social impacts caused when the conventional process consumes finite resources and produces undesired outputs or byproducts. For example, the process may cause climate change, decreased production of agricultural products (e.g., food), increased human disease and healthcare costs, the depletion of finite raw materials (such as ore and petroleum reserves), water shortages or stress, compromised ecosystems such as acidic oceans, decreased biodiversity, and the loss of coastal land, wetlands, and other sensitive environments. Although much progress has been made, Civilization's present economy is temporary because it is dependent upon burning more than one million years' of fossil accumulations each year. In addition to potentially degrading the environment to adversely impact all forms of life, the present economy forces inflation and strife between “have-nots” and “haves” by depletion of essential resources.

A comprehensive cost model of a production process should correctly capture the economic cost of utilizing finite (i.e., scarce) inputs as well as the economic cost of the environmental pollutants and social impacts. To make a comprehensive cost model meaningful, a “process boundary” should be identified. The boundary identified defines the scope of the costs reflected by the model. For example, in the process shown in FIG. 14, a suitable boundary might limit the model to the costs associated with extraction, refinement, combustion/conversion, and distribution sub-processes. The model might ignore or otherwise make simplifying assumptions about the costs associated with the processes that fall upstream or downstream of the boundary.

### 11. An Introduction to the Costs of Autogenous Production Systems and Processes

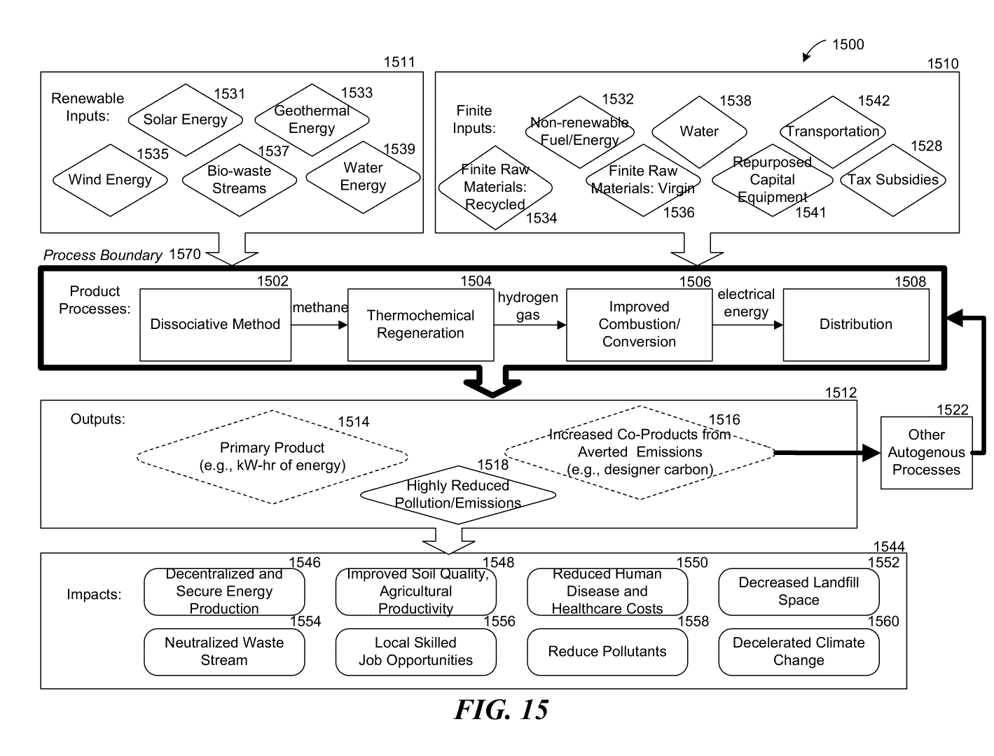

FIG. 15 illustrates an example of an autogenous process for producing electrical energy as a useful product. In this example, like the example shown in FIG. 14, the functional unit (FU) of primary product produced is a unit of electrical power (e.g., a kW-hr of usable energy). However, as described in greater detail herein, the autogenous process used to produce the FU produces significantly different co-products, waste outputs, and impacts.

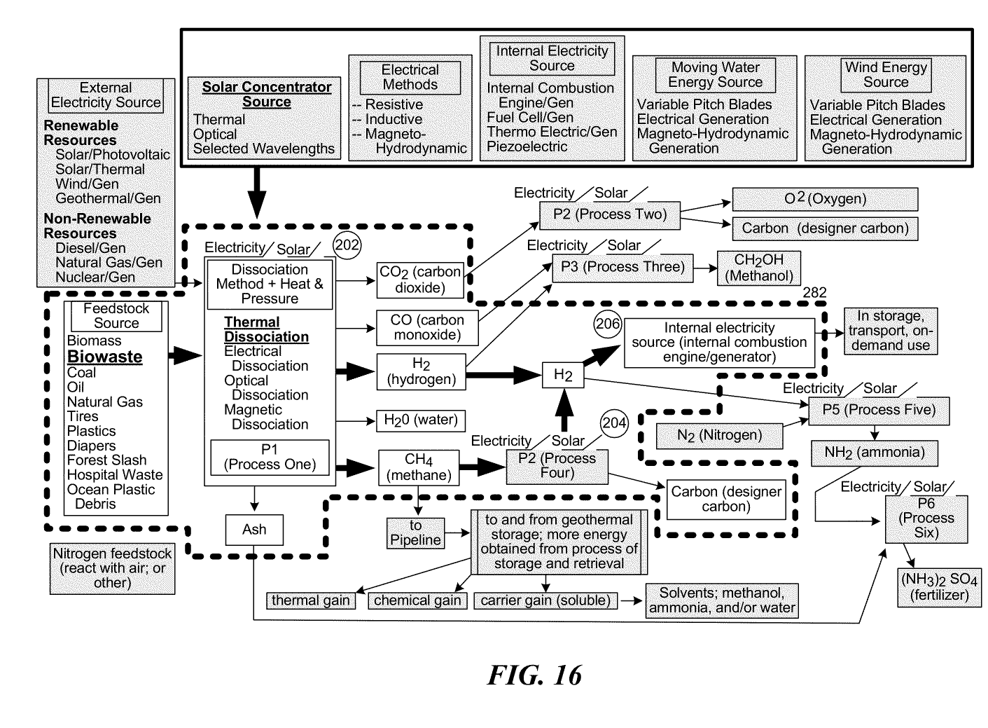

The example process shown in FIG. 15 may form a portion of a larger autogenous system and process. For example, the process of FIG. 15 may correspond to the portion of the larger autogenous system and process shown in FIG. 16 that is demarcated by a heavy dashed outline. The larger autogenous system and process of FIG. 16 is described in greater detail herein.

Returning to FIG. 15, during the example autogenous energy production process, a renewable feedstock resource (e.g., biowaste) is converted via a first dissociation sub-process into methane, which is then converted via thermochemical regeneration (TCR) into hydrogen gas. The hydrogen gas is then efficiently combusted and converted into electrical energy, which is distributed to local consumers.

As shown at the top-left portion of FIG. 15, the autogenous system primarily utilizes renewable material sources and renewable energy sources to drive the sub-processes. For example, the primary feedstock provided to the dissociation sub-process may be biowaste generated from local farms and communities. As another example, renewable energy sources such as solar power may drive both the dissociation and TCR sub-processes. The use of renewable materials and energy greatly reduces or eliminates the quantity of finite materials (virgin and/or recycled) and non-renewable energy needed to drive the process of FIG. 15. Additionally, by utilizing locally-generated feedstock such as local biowaste, the process of FIG. 15 requires very little energy-intensive transportation of inputs to the autogenous system. Finally, the use of a biowaste product or other waste stream (e.g., spilled oil) may remove pollutants from the environment and/or prevent the emissions of pollutants into the environment. For example, by utilizing the biowaste, the autogenous system prevents the slow decomposition of the biowaste into emitted methane and/or carbon dioxide and commensurate contamination of ground water, rivers, lakes, or sea-coast areas.

Furthermore, in some examples, an autogenous process may utilize repurposed capital equipment, which further reduces the environmental and monetary cost of the autogenous process. To illustrate, the combustion sub-process may be implemented by internal combustion engines recycled from locally scrapped automobiles. Normally, a conventional recycling process would require transporting the engines to a smelter, re-smeltering the scrapped engines to metal, energy-intensive operations for remanufacturing the metal into a newly produced engine, and transporting the new engine back to the combustion site. In a decoupled autogenous system, the combustion engines are instead re-fitted locally with components that permit the engine to cleanly and efficiently combust hydrogen fuel in order to drive loads such as electrical energy generators. Additionally, the re-purposing of capital equipment may be performed locally, resulting in skilled jobs in the local community including those associated with electronically controlled and optimized service to local customers and smart grid participation.

As shown in FIG. 15, an autogenous system also captures byproducts and utilizes them to reduce environmental emissions and produce useful co-products. For example, the dissociation and TCR processes used to generate the intermediary products of methane and hydrogen gases may also produce highly concentrated and pure forms of carbon, carbon dioxide, trace minerals, carbon monoxide for manufacturing polymers and other high value chemicals, and ash that are used to restore tilth to local farm soils and for hydroponic operations. At a minimum, by isolating these byproducts for highest local value and on-going utilizations, the autogenous system readily sequesters what would otherwise produce GHG and other pollutants to reduce total emissions resulting by the process. Furthermore, in some autogenous systems some or all of these pure byproducts may be usable in subsequent industrial or agrarian processes. For example, pure carbon produced by the TCR sub-process may be utilized to create carbon-based coatings or materials that have desirable characteristics such as improved electrical, thermal, catalytic or other desired reactivity properties. Accordingly, these byproducts have economic value and thus may be treated as co-products in a comprehensive cost model. Illustratively carbon can be extracted by solar powered dissociation of methane. Hydrogen can be considered to be a very low cost byproduct in instances that such carbon is utilized to reinforce components of equipment to harness renewable solar, wind, moving water and geothermal resources to produce thousands of times greater amounts of energy such as electrical energy compared to the one-time burning of such carbon in a conventional central power plant.

Table C below shows the example inputs/outputs at each sub-process in the process of FIG. 15. In the table, the “**” symbol next to an output indicates that the output is a useful co-product or an input to another sub-process. The “++” symbol next to an input indicates a renewable energy source. The “˜˜” symbol indicates a renewable material source or a material derived from another sub-process within the autogenous system. The “̂̂” symbol indicates an external waste stream that is used as an input to an autogenous system; the use of such a waste stream may result in a net reduction of environmental pollutants.

TABLE C
inputs/outputs of the sub-processes shown in FIG. 15.

| Sub-Process | Inputs | Outputs |
|---|---|---|
| (1) Dissociation | Solar concentrator | Methane** |
| | (capital equipment) | Hydrogen gas ** |
| | Solar Energy++ | Water** |
| | Biowaste ~~ [symbol] | Carbon Dioxide ** |
| | | Carbon monoxide** |
| | | Ash** |
| | | Neutralized wastestream** |
| (2) Thermo- | Solar concentrator | Hydrogen gas** |
| chemical | (capital equipment) | Pure ″designer″ carbon ** |
| Regeneration | Solar Energy ++ | |
| (TCR) | Methane~~ | |
| (3) Internal | Repurposed automobile | Electrical energy (FU) |
| Combustion | internal combustion engine | Useful heat** |
| and Conversion | (capital equipment) | |
| | Hydrogen gas~~ | |
| (4) Local | Capital equipment | |
| Distribution | | |

Some co-products may also be “re-invested” into the autogenous system in a regenerative fashion. For example, other renewable processes may convert a pure carbon co-product of the TCR sub-process into industrial components, e.g., into engine components. Those engines components might then be utilized to extend the lifetime of the initial capital equipment used in the energy generation process.

FIG. 15 shows the various economic and social impacts caused when an autogenous approach reduces the amount of finite resources consumed and the environmental emissions. Using autogenous approaches instead of depletive approaches may result, for example, in decentralized and secure energy production, improved soil quality and agricultural productivity, reduced human disease and healthcare costs, decreased landfill space, neutralized waste streams, decelerated climate change, and local skilled employment opportunities.

A comprehensive cost model for a sustainably autogenous production system or process should correctly capture the economic value of preserving finite material resources. The model should also capture the economic value of co-products, averted emissions, and reduced pollutants.

Furthermore, as described previously, to make a comprehensive cost model meaningful, a “process boundary” in the autogenous system should be adopted. For example, for the example process shown in FIG. 15, a suitable boundary might be limited to the costs associated with the dissociation, TCR, combustion/conversion, and distribution sub-processes. The model might ignore or otherwise make simplifying assumptions about the costs associated with the processes that fall upstream or downstream of the boundary. If a cost model is used to compare an autogenous system to a depletive system, similar process boundaries should be utilized when evaluating the cost of each system. A similar boundary permits easier and more balanced comparisons between the two types of systems.

Although the previous examples of FIGS. 14 and 15 have compared depletive and autogenous processes of energy production, one having skill in the art will appreciate that the principles described previously apply equally well to the production of other types of products, such as material products or agricultural products. For example, conventional processes that produce consumer goods will similarly deplete finite inputs, produce substantial pollutants, and result in similar detrimental impacts. As another example, autogenous processes for producing consumer goods would utilize fewer finite inputs, reduce emissions, produce more useful co-products, and result in similar benefits. Accordingly, the cost models described herein have equal applicability to processes for producing non-energy products, such as durable goods, finished materials, and agricultural products.

FIG. 16 shows the processes implemented by a larger example autogenous system. The larger system may integrate an autogenous energy-production subsystem (demarcated with a dashed line) such as the one described with respect to FIG. 15. Those blocks representing the energy-production sub-processes are shown in white. The circled number indicates how a block in FIG. 16 is related to a sub-process shown in FIG. 15. For example, the circled “2” indicates that Process Four (P4) of FIG. 16 may be performed at the second TCR step shown FIG. 15. The heavy arrows indicate approximately the same flow of inputs and outputs that is shown in FIG. 15. Other sub-processes external to the energy-production subsystem are shaded gray. Lighter arrows indicate other inputs and outputs that are utilized to produce other products of the larger system.

The figure also shows the renewable and non-renewable material and energy inputs and outputs to the various sub sub-processes. In addition to producing energy products, the system of FIG. 16 may be capable of producing solvents (including pure water), agricultural products (e.g., fertilizers and nutrients), and/or industrial or consumer products and components (e.g., carbon-based materials or products). Table D below summarizes the material and energy inputs and outputs of the various sub-processes shown in FIG. 16 that were not already described with respect to FIG. 15. The “**” symbol next to an output indicates that the output is a useful co-product or input to another process shown in FIG. 16. The “++” symbol next to an input indicates a renewable energy source. The “˜˜” symbol indicates a renewable material source or a material derived from another sub-process within the autogenous system. The “̂̂” symbol indicates an external waste stream that is used as an input to an autogenous system; the use of such a waste stream may result in a net reduction of environmental pollutants.

TABLE D
inputs/outputs of the sub-processes shown in FIG. 16.

| Sub-Process | Inputs | Outputs |
|---|---|---|
| Process One | Electrical energy ++ | CO2** |
| (Dissociation) | Solar++ | CO** |
| | Feedstock Biomass~~ | H2** |
| | Biowaste~~ [symbol] | H20 |
| | Coal | CH4** |
| | Oil | Ash** |
| | Natural Gas | |
| | Tires [symbol] | |
| | Plastics [symbol] | |
| | Diapers [symbol] | |
| | Forest Slash [symbol] | |
| | Hospital Waste [symbol] | |
| | Ocean Plastic Debris [symbol] | |
| | Spilt oil [symbol] | |
| Process Two | CO2 | O2 |
| (Dissociation) | Electrical energy ++ | C** |
| | Solar++ | |
| Process Three | CO | CH30H |
| (Generate | H2 ~~ | |
| additional fuel | Electrical energy ++ | |
| resource) | Solar++ | |
| Process Four | CH4 ~~ | H2** |
| (Dissociation) | Electrical energy ++ | C** |
| | Solar++ | |
| Process Five | H2 ~~ | NH3** |
| (Generate | Nitrogen | |
| additional | Electrical energy ++ | |
| resources) | Solar ++ | |

Of course, the inputs and the outputs shown in Table D may vary in both quantity and type depending on:
the design variant used (e.g. whether an internal combustion engine or fuel cell is used for electrical energy production)
the feedstock chosen (e.g., biowaste versus harvested biomass),
the operational conditions of the system.

Thus Table D is provided only to give examples of inputs/outputs of the system of FIG. 16.

Further details of similar autogenous systems and autogenous sub-processes are provided in the applicant's co-pending applications, which are listed and incorporated above in paragraph 0048.

For improved clarity, the remainder of this application describes comprehensive cost modeling systems and methods in the context of the example systems described with respect to FIGS. 14, 15, and 16. For example, in subsequent discussion, a cost model is developed in greater detail for the functional unit of a kW-hour produced by the process of FIG. 15. A more detailed model is also developed on the assumption that the process shown in FIG. 15 is integrated with a larger autogenous system, such as the one shown in FIG. 16 so that the outputs of the process in FIG. 15 may be utilized by other sub-processes shown in FIG. 16. However, one having skill in the art will appreciate that the comprehensive cost modeling systems and methods described herein could be applied to other sub-processes shown in FIG. 16 or to other autogenous systems and processes. Similarly, the cost models described herein could be developed for a functional unit other than a kW-hour of energy, including another type of functional unit of energy, a functional unit of industrial or consumer products, a functional unit of agrarian products, and/or a functional unit that combines two or more of these types of products.

### 12. Example Comprehensive Cost Modeling System

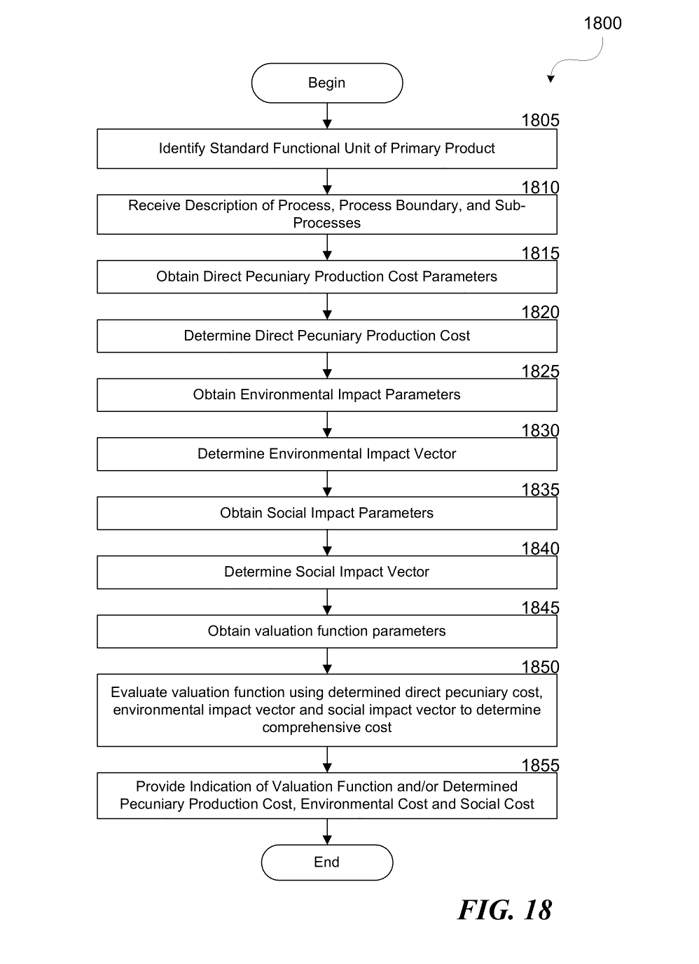

FIG. 17 illustrates a logical block diagram of a comprehensive cost modeling system (“modeling system”). The comprehensive cost modeling system may be utilized to determine the comprehensive cost of an autogenous or depletive process and may implement the methods shown in FIGS. 18 thru 21. Aspects of the modeling system may be implemented as special purpose hard-wired circuitry, programmable circuitry, or as a combination of these. As will be described in additional detail herein, the modeling system includes a number of modules to implement the functions of the modeling system. The modules and their underlying code and/or data may be implemented in a single physical device or distributed over multiple physical devices and the functionality implemented by calls to remote services. Assuming a programmable implementation, the code to support the functionality of the modeling system may be stored on a computer readable medium such as an optical drive, flash memory, or a hard drive. One skilled in the art will appreciate that at least some of the individual modules may be implemented using application-specific integrated circuits (ASICs), programmable logic, or a general-purpose processor configured with software and/or firmware. In some examples, some of the modules may be implemented in whole or in part using commercially available or customized life cycle inventory or analysis software, as described herein.

As shown in FIG. 17, the modeling system may include an input/output module, a process description module, a pecuniary cost module, a social impact module, an environmental impact module, and a valuation module. The modeling system may also include one or more databases configured to store user and system preferences, settings and policies. The database may also include data that is related to autogenous systems or processes, economic studies, economic input/output tables, emission information, pollutant information, valuation weights, valuation functions, and/or other information that permits the calculation or generation of pecuniary costs, environmental impact vectors, social impact vectors and the evaluation of valuation functions, as described herein.

The input/output module is configured to receive and interpret inputs from a user (e.g., from input devices such as a pointing device or keyboard) and/or to present results to a user (e.g., by providing text, graphical, sound or other types of outputs). The input/output module may, for example, be configured to provide comparative information about the comprehensive cost of different production processes to a user in a textual or graphical format. The input/output module is also configured to retrieve or store data in the database or another location.

The process description module is configured to permit a user to define a standard functional unit and to describe a process, process boundary, and sub-processes, as described in greater detail herein. For example, the process description module may be configured to permit a user to indicate the inputs, outputs, efficiencies, and other parameters associated with productive processes.

The pecuniary cost module, environmental impact module and social impact modules are configured to calculate or generate a direct economic cost, an environmental impact vector, and a social impact vector, respectively, for a functional unit of product produced by a particular process, as described in greater detail herein. The valuation module is configured to determine a comprehensive cost of a production process using a valuation function, as described in greater detail herein.

### 13. Comprehensive Cost Modeling Method

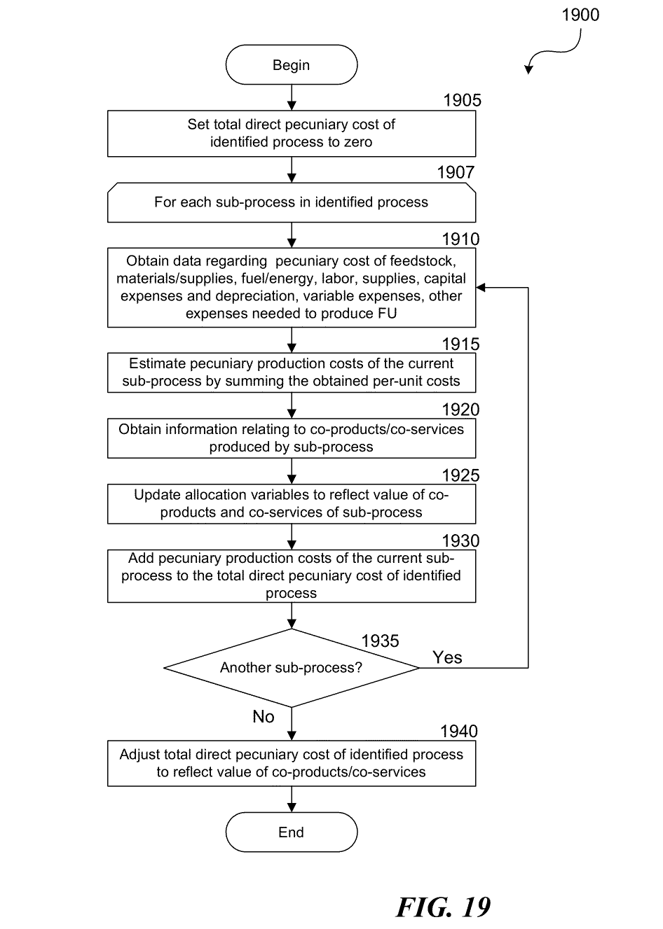

FIG. 18 illustrates a method 1800 for comprehensively modeling the cost of an autogenous or depletive production process or system. The modeling method 1800 and other methods shown in FIGS. 19-20-21, may be implemented in computer-readable medium and may be performed or executed by the modeling system shown in FIG. 18 or by another system or component.

The process 1800 begins at block 1805 when the modeling system identifies the primary product and the functional unit (“FU”) that will be utilized as the basis for a cost model. For example, the modeling system may receive an indication that a cost model should be developed for the FU of a kW-hour of electrical energy. Other non-exhaustive examples of a FU include a gallon of methane or a kilogram of pure, refined carbon.

Next, at block 1818, the modeling system identifies the productive process used to create the functional unit of primary product, the desired boundaries of the cost model, and the discrete sub-processes that fall within the boundaries of the cost model.

The modeling system may also receive or otherwise obtain input and output information for some or all sub-process within the desired model boundary. The information may include the quantity and quality of inputs consumed and the quantity and quality of outputs produced. For example, the modeling system may receive an indication of which inputs are finite versus renewable and an indication of which outputs will be utilized as a co-product instead of being released as waste. For example, when modeling the costs of the process shown in FIG. 15, the modeling system may receive information similar to that conveyed by Table C, supplemented by information that indicates the quantities of inputs and outputs that are consumed or produced.

In some examples, the modeling system may also receive additional information relating to the models that should be used for the approximate costs generated upstream or downstream of the model boundary.

At blocks 1805 and 1810, the modeling system may identify some or all of the described information by analyzing user input and/or by accessing preferences, policies and/or other data stored in the database or another source. The modeling system may store some or all of the information identified at blocks 1805 and 1810 in the database or another location for later retrieval.

In subsequent blocks, the modeling system generates a comprehensive cost model for producing the identified FU of primary product via the production process identified at block 1805 (herein, “the identified process”). The cost model generated may be limited to those costs that fall within the identified boundary.

At block 1815, the modeling system obtains the parameters that influence the direct pecuniary cost of producing a FU of the primary product via the identified process. At block 1820, using these parameters, the modeling system determines the direct pecuniary cost (herein represented by the variable “M”) of producing a FU of the primary product via the identified process. Blocks 1815 and 1820 are described in greater detail herein with respect to FIG. 19.

At block 1825, the modeling system obtains the parameters that influence the environmental impact or cost of the identified process. At block 1830, the modeling system uses the obtained parameters to generate an environmental impact vector (herein “V”) that is representative of the environmental cost of producing a FU via the identified process. Each entry in the vector V represents (1) the depletion of a finite resource, and/or (2) the release of a byproduct into the environment, that results from producing a single FU of primary product via the identified process. For example, an entry in the vector V may represent the number of metric-tons of CO2 that results when a single FU of electrical energy is produced by the identified process. Useful co-products should not appear in the environmental impact vector, even if under a conventional approach they would be considered pollutants. For example, if the majority of CO2 output from a sub-process is harnessed and put to downstream practical use (i.e., it is a co-product) and only a fraction of the CO2 output is emitted into the environment, then only the fraction that is emitted should be reflected in the environmental impact vector.

Table E below gives examples of environmental impacts that may be reflected in the environmental impact vector V (i.e., impacts that reflect either the depletion of finite resources or polluting outputs). These examples are not intended to be exhaustive; one having skill in the art will appreciate that any depletion or emissions may be included in the vector, including for example, all of the types of emissions accounted for in the U.S. EPA Toxic Release Inventory. The particular set of environmental inputs/outputs that are included in the environmental impact vector may be specified by a user or retrieved from a data source, such as the database.

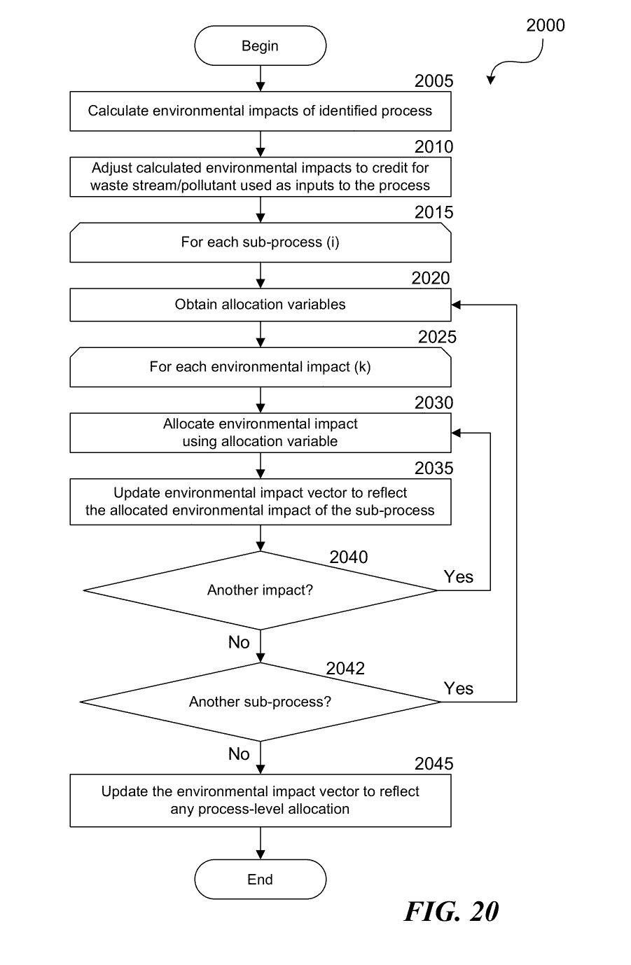

Blocks 1825 and 1830 and the generation of an environmental impact vector V are described in greater detail herein with respect to FIG. 20.

TABLE E
Non-exhaustive example of an environmental impact vector.
Example Environmental Impact Vector

| | |
|---|---|
| Depleted Finite Resources: | Iron Ore |
| Virgin and/or Recycled | Crude Oil |
| | Natural Gas |
| | Coal |
| | Wood |
| | Water (River) |
| | Water (Ocean) |
| | Uranium |
| | Land use |
| | . . . |
| Air pollutants | CO2 Emitted |
| | Nitrous Oxide Emitted |
| | CH4 Emitted |
| | . . . |
| Water Pollutants | Benzene |
| | Chromium |
| | Ethylene Glycol |
| | . . . |
| Soil pollutants | Lead |
| | Nickel |
| | . . . |
| Solid Waste | Sludge |
| | Landfill use |
| | . . . |

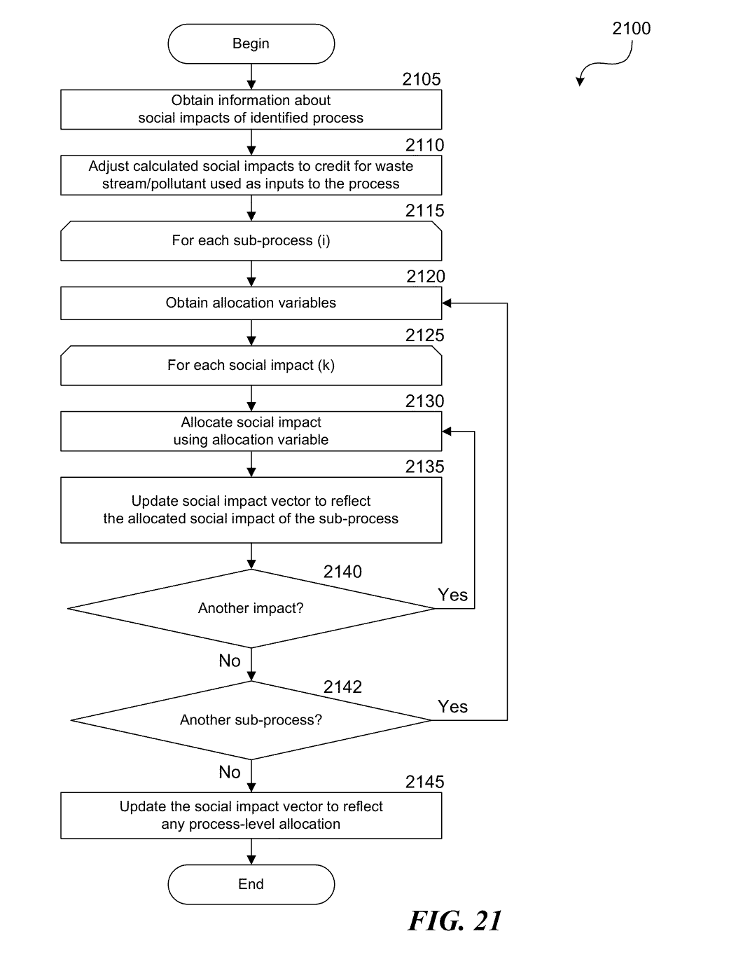

At block 1835, the modeling system obtains the parameters that influence the social impacts of the identified process. At block 1840, the modeling system uses the obtained parameters to generate a social impact vector (herein “S”) that is representative of the societal impacts of producing a FU via the identified process. Each entry in the vector S represents either a social benefit or cost that results from producing a single FU via the identified process. For example, the first entry in the vector S may represent the fractional number of skilled FTE jobs that are newly created by producing an FU via the identified process instead of via a conventional, baseline process. Table F below gives non-exhaustive examples of social impacts that may be reflected in the social impact vector S. The specific social impacts that are included in a particular cost model may be specified by a user or retrieved from a data source, such as the database. Blocks 1835 and 1840 and the social impact vector S are described in greater detail herein with respect to FIG. 21.

TABLE F
Non-exhaustive example of a social impact vector.
Example Social Impact Vector

| | |
|---|---|
| Economic Stimulation | New low-skill FTE jobs created |
| | New manufacturing FTE jobs created |
| | New high-technology FTE jobs created |
| | . . . |
| Government Costs | Federal Tax Subsidies/Deductions (e.g., R&D, |
| | transportation, exploration subsidies) |
| | Lost State Tax Income |
| | Military protection costs |
| Human Health Costs | Incidence of waterborne disease |
| | Cancer Incidence |
| | Incidence of Birth Anomalies |
| | Life Expectancy |
| | Developmental Damage |
| | Food Supply |
| | Death Rate |
| | Mental Health |
| | Respiratory Disease |
| | . . . |

At block 1845, the modeling system obtains the parameters for evaluating a valuation function. At block 1850, the modeling system evaluates the valuation function using the determined direct pecuniary production cost, the environmental impact vector and the social impact vector to determine the comprehensive cost of a FU produced by the identified process.

A valuation function (herein “F”) combines the direct pecuniary cost M, the environmental vector V, and the social impact vector S into a single value that is representative of the true economic cost of producing the identified FU of primary product via the identified process.

In some embodiments, the valuation function is a function of V, M, and S that can be expressed as shown below in Eqn. 4.

F(M,V,S)=·M+Wv·V+Ws·S Eqn. 4

In Eqn. 4, Wv and Ws are vectors comprised of various weights and the dot operator indicates an inner product of two vectors. The i-th entry in weighting vector Wv (“Wvᵢ”) represents the approximate economic cost attributable to the i-th entry in the environmental impact vector V (“Vᵢ”). For example, an entry Wvᵢ may reflect the approximate economic cost of depleting a unit of a particular finite resource; alternatively it may reflect the economic cost of outputting a unit of a particular pollutant into the environment. Similarly, the i-th entry in weighting vector Ws (“Wsᵢ”) represents the approximate economic cost or benefit attributable to the i-th entry in the social impact vector S (“Sᵢ”). To illustrate, Ws, may reflect the approximate economic cost of military conflict. As another example, Ws, may reflect the approximate economic benefit (expressed as a negative weight) of new job creation. Typically, the units of each entry in a weighting vector will cancel the units of the corresponding entry of the impact vector V or S in order to reduce the overall valuation function F to monetary units or alternatively, to a unitless value. The application of the weighting vectors may be applied using conventional life-cycle analysis programs described herein.

One having skill in the art will appreciate that at block 1845, the weights may be obtained from any suitable source. The modeling system may obtain each weight either from user input or by obtaining the value from an external data source, including the database. The weights may, for example, be estimates of economic costs that were generated by empirical and/or theoretical economic studies of environmental and/or social impacts. For example, the weights associated with the depletion of a finite resource may be determined in part by economic studies designed to determine resource rent or depletion costs using methodologies such as net price, EI-Serafy depletion cost, imputed income, sustainability price, transaction value, replacement cost, resource rent, or similar methodologies that quantify the depreciation of natural capital. For example, the system may use results produced by methodologies such as those described in the following footnoted references.⁴⁴ As another example, the weights may be determined by economic studies of the external costs of particular pollutants, such as the studies listed in the following footnote.⁴⁵ As yet another example, the weights may be determined by economic studies about the external costs associated with social impacts, such as human health impacts, military conflict, tax or other government subsidies, job creation/loss, or other social impacts. For example, the system may use results from studies such as those listed in the following footnote, which have linked pollutants to adverse human health effects.⁴⁶ Alternatively, or additionally, some or all of the weights may be chosen to reflect the subjective preferences or priorities of a user. ⁴⁴ Estrella V. Domingo and Edward Eugenio P. Lopez-Dee, Valuation Methods of Mineral Resources, Paper Prepared for the 11th Meeting of the London Group Meeting (Mar. 26-30, 2007), available at http://oilnipseerug.59.to/unsd/envaccounting/londongroup/meeting11/LG11_{—}14a.pdf.George D. Santopietro, Alternative methods for estimating resource rent and depletion cost: the case of Argentina's YPF, 24 Resources Pol'y 39 (1998).⁴⁵ “What is the Price of Carbon? Five definitions,” available at http://sapiens.revues.org/.“The Social Cost of Carbon,” available at http://www.e3network.org/papers/SocialCostOfCarbon_SEI_{—}20100401.pdf.“A Perspective Paper on Methane Mitigation as a Response to Climate Change,” available at http://fixtheclimate.com/uploads/tx_templavoila/PP_Methane_Johansson_Hedenus_v.2.0.pdf.⁴⁶Leslie Rubin et al., Environmental Health Disparities: Environmental and Social Impact of Industrial Pollution in a Community—The Model of Anniston, A L, 54 Pediatric Clinic of N. Am. 375 (2007), available at http://www.iceh.org/pdfs/LDDI/2007Series/EnvHealthDisparities2007.pdf.Dennis W. Carlton & Jeffrey M. Perloff, Chapter 3: Competition, in Modern Industrial Organization (4th ed. 2000), available at http://wps.aw.com/aw_carltonper_modernio_{—}4/21/5566/1424945.cw/content/index.html.Pollution Costs, in Can Britain Survive (Edward Goldsmith ed., 1971), available at http://www.edwardgoldsmith.org/page294.html.Nathan Nankivell, The Jamestown Found., China's pollution and its threat to domestic and regional stability (Dec. 3, 2005), available at http://www.asianresearch.org/articles/2758.html.

Alternatively, the modeling system may combine M, V, and S using a different type of valuation function F. For example, the system may utilize a valuation function that reflects non-linearity in the true economic cost of various environmental and social impacts. In some examples, at block 1845, the modeling system may obtain an indication of the mathematical operators that should be applied to the M, V, and S variables. The system may receive such an indication from either user input and/or stored preferences or settings.

In some examples, the modeling system may repeat blocks 1810-1850 for one or more different processes that produce the same FU. For example, the modeling system may perform blocks 1805-1850 to first model the cost of producing a kW-hr of electrical energy using the autogenous system shown in FIG. 15. The modeling system may then repeat blocks 1805-1850 to model the cost of producing a kW-hr of electrical energy using the depletive system shown in FIG. 14. In such examples, it is preferred that the modeling system utilize similar process boundaries, generate social and environmental impact vectors that reflect similar impacts in a similar manner, and apply identical valuation functions, including, for example, identical weighting vectors.

At block 1855, the modeling system provides an indication of the comprehensive cost, and/or the determined direct pecuniary production cost, the environmental impact vector, and the social impact vector. For example, the modeling system may display one or more of these variables to the user, output them to a file, or provide them to another software program. As another example, the modeling system may provide or display a comparison of these variables for two or more different processes that produce the same FU of primary product. For example, the modeling system may provide a comparison of the differences in comprehensive cost between an autogenous system and a depletive system. The method 1800 then ends.

### 14. Modeling Direct Pecuniary Production Cost

FIG. 19 is flow diagram of a method 1900 for modeling the direct pecuniary production cost M of a functional unit of primary product. For the example system shown in FIG. 15, the value of M should reflect the direct expense of producing a kW-hr of electrical energy after accounting for the added benefit of useful-co-products shown in Table G, such as water, carbon dioxide, carbon monoxide, and ash. In this example, the value of M should also reflect the monetary value of neutralizing a waste stream, which can be considered a useful “co-service” provided by the process.

In some examples, during the method 1900, the system calculates the total direct pecuniary production cost M of a functional unit of primary product as shown in Eqn. 5.

$$M = {\sum }_{i} {α}_{i} {\sum }_{j}^{{N}_{i}} {M}_{i , j} \qquad ( Eqn . 5 )$$

In Eqn. 5, the value

$${\sum }_{j}^{{N}_{i}} {M}_{i , j}$$

is the total direct pecuniary cost of all of the Nᵢ different inputs to the i-th sub-process, including, for example, feedstock, labor, fuel/energy, operating expenses, and capital expense inputs. The allocation variable αᵢ represents the relative ratio between the production of (1) useful outputs of the i-th sub-process that will be subsequently utilized to produce an FU (e.g., via downstream processing), to (2) the production of all of the useful outputs of the i-th sub-process, including co-products, co-services, and the outputs listed in (1).

To illustrate: as shown in Table C, the first dissociation sub-process shown in FIG. 15 may result in useful outputs of methane, hydrogen, pure ash, carbon dioxide, carbon monoxide, and water. The process also results in the neutralization of a noxious waste stream. Only the methane and hydrogen will be used to subsequently create an FU of a kW-hr of electrical energy. However as shown in FIG. 16, the pure ash, carbon dioxide, carbon monoxide, and water have commercial usefulness as inputs to the other processes that fall outside the chosen model boundary. The neutralization of a waste stream may also represent a “co-service” since it has economic value to others. Thus, these outputs can be considered useful co-products (or co-services) to which some portion of the direct pecuniary cost should be attributed. Assuming the first dissociation process produces (1) 60% methane and hydrogen, and (2) 30% ash, carbon dioxide, carbon monoxide, and water, the value of a, will be 0.67 (=0.6/(0.6+0.3)). The fraction αᵢ may, for example, be determined by the relative economic value, weight, volume, molar quantity, economic value, and/or other suitable metric of the various outputs.

Alternatively, in some examples, during method 1900, the system calculates the total direct pecuniary production cost M of an FU of primary product more simply as shown in Eqn. 6.

$$M = α {\sum }_{i} {\sum }_{j}^{{N}_{i}} {M}_{i , j} \qquad ( Eqn . 6 )$$

In this equation, all of the pecuniary costs of all of the inputs to all of the sub-processes are calculated by simply summing the various costs as follows:

$${\sum }_{i} {\sum }_{j}^{{N}_{i}} {M}_{i , j} ,$$

where Mi,j is the j-th pecuniary cost (e.g., labor cost) associated with the i-th sub-process (e.g., a dissociation sub-process). Then, the total cost of the entire process is allocated to the FU using a scalar allocation variable α, which represents the relative ratio between (1) the production of an FU of primary product, to (2) the production of all of the useful outputs of all of the sub-processes, including the FU, co-products, and co-services.

Returning to the previous example of FIG. 15, the useful co-products and co-services from the entire process are: methane, hydrogen gas, water, carbon dioxide, carbon monoxide, ash, neutralization of a waste stream (a co-service), hydrogen gas, pure “designer” carbon, and useful heat. In this example, assuming the total process produces (1) 1 kW-hr energy valued at $0.60, and (2) co-products and co-services valued at $0.40, the value of α may be 0.6 (=0.6/(0.6+0.4)). The fraction α may be determined by the relative economic value, weight, molar quantity, volume, or other metric representative of the ratio of the FU to all of the useful outputs.

Alternatively, in some examples, during method 1900, the total direct pecuniary production cost M_ of a functional unit of primary product is calculated instead as shown in Eqn. 7.

$$M = - CP + {\sum }_{i} {\sum }_{j}^{{N}_{i}} {M}_{i , j} \qquad ( Eqn . 7 )$$

In this equation, the allocation variable CP represents the fair-market value of all of the co-products or co-services produced by the identified process in conjunction with an FU. In the example given immediately above, CP would be $0.4, since this is total fair market value of all the co-products and co-services produced in conjunction with a kW-hr of electrical energy.

Returning to FIG. 19, the method 1900 begins at block 1905, when the modeling system sets the total pecuniary cost of the identified process to zero. Next, as shown at block 1907, the modeling system performs blocks 1910-1935 for each sub-process in the identified process.

At block 1910, the modeling system obtains data regarding the direct pecuniary cost of the resources that must be input into the sub-process in order to produce an FU. These resources may include, for example, feedstock, raw materials, fuel/energy, finished supplies, labor, capital expenses/depreciation, other variable expenses, and any other resources. The direct pecuniary cost of each resource may, for example, be determined using its fair-market, wholesale purchase price. The data obtained by the modeling system, may include, for example, the quantity of each resource needed to create an FU and the market price for a given quantity or each resource.

At block 1910, the modeling system may also obtain information necessary to amortize capital expenses, such as capital equipment, over multiple functional units. For example, the modeling system may receive an indication of the expected lifetime of a piece of capital equipment that is utilized for the sub-process. The amortization lifetime may be expressed in any manner that permits the amortization of a capital cost on a per-FU basis. For many autogenous systems, the amortization lifetime may be longer than depletive systems, since regenerative measures implemented by autogenous systems may improve the lifetime of capital investments. Autogenous systems may also have longer amortization lifetimes that result from improved “green” designs that avoid corrosion and similar effects that shorten the lifespan of capital equipment.

If tax subsidies or similar have artificially reduced the fair-market purchase price, the modeling system may also obtain information relating to the tax subsidy so that it may later make a correcting adjustment (e.g., in the social impact vector) to reflect the artificial pricing structure.

The various data obtained at block 1910 may, for example, be provided by a user, another software program, a server, and/or retrieved from a memory (e.g., from the database).

At block 1915, the modeling system uses the obtained information to estimate the total pecuniary production costs required to eventually generate an FU of primary product via the sub-process and to produce the co-products/co-services of the sub-process. To do so, the modeling system sums all of the individual costs of the sub-process that were obtained at block 1910, i.e., it calculates the expression

$${\sum }_{j}^{{N}_{i}} {M}_{i , j}$$

for the sub-process.

At block 1920, the modeling system obtains information about the useful co-products and/or co-services produced by the sub-process. At block 430 the system updates one or more cost allocation variables to reflect the obtained information. For example at block 1920, the modeling system may obtain information about the quantity, composition, and/or value of co-products or co-services that is sufficient to calculate or update one or more of the following allocation variables that were described previously: αᵢ, α, and CP. As described previously, in autogenous systems, most of the outputs of each sub-process are typically captured and put to an economically valuable use. By utilizing byproducts in this manner, autogenous systems reduce the pecuniary cost of the FU of primary product. That cost savings is reflected in the allocation variables.

If the modeling system uses Eqn. 5 or Eqn. 6, at block 1920 the modeling system may obtain information indicating (1) the value of co-products or co-services produced by the sub-process, relative to (2) the value of the outputs that will be used to produce an FU. In such an example, at block 1925, the modeling system may update the variables αᵢ and/or α to reflect these relative values. Instead of relative values, the modeling system may instead obtain and utilize information about the relative quantities, volumes, or similar metrics.

In other examples, at block 1920, the modeling system may receive information indicating the total fair market value of all of the co-products and/or co-services produced by the sub-process. In such an example, at block 1925 the modeling system may update the variable CP to reflect the additional value of the co-products and co-services generated by the sub-process.

At block 1925, the modeling system may also adjust the direct pecuniary production cost of the sub-process to reflect the economic value of the co-products or co-services produced by the sub-process. For example, if the modeling system utilizes Eqn. 5 to describe the pecuniary cost, it may scale the value

$${\sum }_{j}^{{N}_{i}} {M}_{i , j}$$

calculated at block 1915 by the value of the allocation variable αᵢ that was determined at block 1930. In other embodiments (e.g., if Eqns. 6 or 7 are used instead) the modeling system skips block 1925 and at block 1940 later adjusts the total direct pecuniary production cost of the entire process.

At block 1930, the modeling system adds the direct pecuniary production cost of the sub-process to the total direct pecuniary cost of the identified process. If the modeling system utilizes Eqn. 5 to describe the pecuniary cost, it may, for example, add the quantity

$${α}_{i} {\sum }_{j}^{{N}_{i}} {M}_{i , j}$$

to the total cost of the identified process. If instead the modeling system uses Eqn. 6 or Eqn. 7, it may add the quantity

$${\sum }_{j}^{{N}_{i}} {M}_{i , j}$$

to the total cost of the identified process.

At decision block 1935, the modeling system determines if there is another sub-process in the identified process. If there is, the method repeats, starting at block 1910. Otherwise, the method proceeds to block 1940, where if necessary, the modeling system adjusts the total direct pecuniary cost of the identified process to reflect any co-products and co-services that were not accounted for in blocks 1910-1930. For example, if the modeling system uses Eqn. 6, it might scale the total pecuniary cost of the process by a value equivalent to the allocation variable α. As another example, if the modeling system uses Eqn. 7, it might offset the total pecuniary cost of the process by a value equivalent to the allocation variable CP.

The method 1900 then ends.

### 15. Modeling Environmental Impact

FIG. 20 is a flow diagram of a method 2000 for modeling the environmental impact vector V for a FU produced by the identified process. As described above, the k-th entry of the vector, Vₖ represents either (1) the consumption/depletion of a particular finite resource that is attributable to the production of one FU by the identified process, or (2) the emission of a particular pollutant that is attributable to the production of one FU by the identified process. In some examples, Vₖ may be a negative value that reflects, for example, how an autogenous system actively removes and sequesters a pollutant from the environment.

To illustrate: in the example autogenous system shown in FIG. 15, the vector V should reflect (1) the virgin and recycled finite resources consumed (e.g., ore for machinery), and (2) the pollutants emitted, when producing a kW-hr of electrical energy. The vector V should not however, reflect the consumption or emission that should instead be attributed to the production of the useful-co-products shown in Table G, such as methane, hydrogen gas, water, carbon dioxide, carbon monoxide, ash, hydrogen gas, pure “designer” carbon, and useful heat. In this example, the value of V should also reflect the environmental benefits achieved by neutralizing a waste stream that was polluting the environment.

In some examples, during the method 500, for each value k, the modeling system calculates Vₖ as shown in Eqn. 8.

$${V}_{k} = {\sum }_{i} {α}_{i} {v}_{k , i} \qquad ( Eqn . 8 )$$

In Eqn. 8, the value ν_{k,i} represents the total consumption of a particular finite resource (k) or the emission of a particular pollutant (k) that results from creating an FU and its coincident co-products via sub-process i. For example, it may represent the metric-tons of carbon dioxide emitted into the environment during sub-process i. The allocation variable αᵢ shown has the same meaning described previously with respect to Eqn. 5.

In some examples, during method 2000, for each value k, the modeling system instead calculates Vₖ as shown in Eqn. 9. The allocation variable α shown has the same meaning described previously with respect to Eqn. 6.

$${V}_{k} = α {\sum }_{i} {v}_{k , i} \qquad ( Eqn . 9 )$$

Alternatively, in some examples, for each value k, the modeling system calculates Vₖ as shown in Eqn. 10.

$${V}_{k} = {\sum }_{i} [ {v}_{k , i} - a {b}_{k , i} ] \qquad ( Eqn . 10 )$$

In Eqn. 10, the value of the allocation variable ab_{k,i} represents the averted environmental burden associated with the co-products/co-services produced by i-th sub-process. The averted environmental burden is the resource depletion or pollutant emissions that would have resulted had the same co-products been produced by a different baseline process (e.g., a conventional process).

To illustrate: in the example shown in FIG. 15 and Table C, the second TCR sub-process produces (1) a quantity of hydrogen gas that will eventually generate a FU of electrical energy, and (2) a quantity of pure “designer” carbon that may, for example, be manufactured into carbide coatings. As an example, producing the same quantity of pure carbon by a baseline conventional process might result in 5×10⁻⁵ metric-tons of CO2 emissions caused by extraction and refinement steps (as well as the emission of other pollutants). If Vₖ represents the total CO2 emissions attributed to producing an FU of electrical energy by the identified process, then the value of ab_{k,2} might be 5×10⁻⁵ metric-tons CO2.

Alternatively, if it is difficult to allocate the environmental impacts at the level of sub-processes, in some examples, during method 500, for each value k, the modeling system calculates Vₖ as shown in Eqn. 11 or Eqn. 12.

Vₖ=ανₖ (Eqn. 11)

Vₖ=νₖ−abₖ (Eqn. 12)

Here, νₖ represents the total depletion of a particular resource (k) or the total emission of a particular pollutant (k) collectively caused by all of the sub-processes during the production of the FU and coincident co-products (in some instances, it is equivalent to

$${\sum }_{i} {v}_{k , i}$$

In Eq. 11, allocation variable α has the same meaning described previously with respect to Eqn. 6. In Eqn. 12, the allocation variable abₖ represents the total averted burden of all of the co-products and co-services from the identified process. For example, abₖ might represent the total CO2 emissions that would have resulted if all of the co-products and co-services of all of the sub-processes were instead produced using baseline conventional methods.

The modeling system may determine the values of ν_{k,i}, νₖ, ab_{k,i}, and abₖ in the foregoing equations using standard life-cycle inventory and analysis methodologies implemented in commercially available computer programs. For example, the values may be determined using an economic input/output life cycle methodology, such as that described by at http://www.eiolca.net/. Such methodology may be implemented in commercial software products such as GaBi Software, developed by PE International and SimaPro developed by PRé Consultants.

Standard life-cycle analysis methodologies may not account for neutralized waste streams, wherein an autogenous process uses pollutants as inputs and thus removes the pollutants from the environment. Thus, during the method 2000 the modeling system may adjust the results produced by a life cycle analysis by a “pollution credit” that reflects the quantities of pollutants removed from the environment by the identified process.

Referring again to FIG. 20, the method 2000 begins at block 2005, when the modeling system calculates the environmental impacts of producing the FU of primary product and its coincident co-products via the identified process. For example, the modeling system may utilize a life cycle analysis computer program to calculate the process-level environmental impacts (e.g., νₖ) and/or the sub-process-level impacts (e.g., ν_{k,i}). At block 2005, the modeling system may also calculate or otherwise determine the averted burdens at the process-level (e.g., abₖ) and/or at the sub-process-level (e.g., ab_{k,i}).

At block 2010, the modeling system may adjust the environmental impacts calculated at block 2005 in order reflect an “environmental credit” for utilizing a waste stream or other pollutant as an input. These environmental credits may be made at the process or sub-process level. In a hypothetical example, the process shown in FIG. 15 might utilize a kilogram of biomass waste in order to produce an FU of electrical energy; furthermore the hypothetical kilogram of biomass might normally produce 5×10⁻⁵ metric tons of methane due to bacterial decay. In this hypothetical example, when modeling the process shown in FIG. 15, the modeling system might therefore subtract 5×10⁻⁵ metric tons from the entry νₖ that is associated with methane emissions. To provide the environmental credit, the modeling system may offset the existing value of ν_{k,i} or νₖ (e.g., by a negative value), or scale the existing value. Other non-exhaustive examples of environmental credits include credits for: spilt oil used as an input to a system and solid landfill waste used as input to a system.

Although not shown in FIG. 20, if Eqn. 11 or Eqn. 12 is used, the modeling system may skip blocks 2015-2042 altogether. Instead, the modeling system may add to each entry Vₖ the determined value νₖ (adjusted by any credits given at 2010). In such examples, the modeling system may also determine the value of the allocation variable α or abₖ (as described herein) before proceeding to block 2045.

Otherwise, at block 2015, the modeling system repeats, blocks 2020-2042 for each sub-process (i). At block 2020, the modeling system obtains the allocation variable(s) needed to properly calculate the environmental impact vector. For example:

if the modeling system uses Eqn. 8 to calculate the environmental impact vector, the system may obtain a value for the allocation variable αᵢ

if it uses Eqn. 9 or Eqn. 11 then it may obtain a value for the allocation variable α,

if it uses Eqn. 10, then it may obtain a value for the allocation variable ab_{k,i} (for all values of k), or

if it uses Eqn. 12, then it may obtain a value for the allocation variable abₖ (for all values of k).

To obtain one or more of these allocation variables, the modeling system may access values of αᵢ or α that were previously determined during the method of FIG. 19. Alternatively, or additionally, it may calculate these variables in the same manner described previously with respect to FIG. 19. As described previously, the values of abₖ and ab_{k,i} may be obtained from a life cycle analysis at step 2005, or from another source, such as user input, a data server, the database, or another data store.

Next, at block 2025, the modeling system repeats blocks 2030-2040 for each potential environmental impact (k) that was identified at block 2005 and that will be reflected in the environmental impact vector. At block 2030, the modeling system allocates or attributes some portion of the k-th environmental impact caused by the i-th sub-process by using an allocation variable. If the system uses Eqn. 8 to allocate the impact, the modeling system may for example, determine the product αᵢν_{k,i}. If the system uses Eqn. 10 it may instead determine the quantity ν_{k,i}−ab_{k,i} The modeling may not perform block 530 if Eqn. 9 is used, and may instead perform a system-level allocation of the impact at block 2045.

At block 2035, the modeling system may update Vₖ to reflect the allocated environmental impact of the i-th sub-process. For example, the modeling system may add the quantity (αᵢνₖ) or (νₖ−ab_{k,i}) to Vₖ. If instead Eqn. 9 is used, the system may simply add ν_{k,i} to Vₖ.

At decision block 2040, the modeling system determines if there is another, different environmental impact implicated by the sub-process i that must be accounted for. If there is, the method repeats at block 2030. Otherwise, the method proceeds to decision block 2042 where the modeling system determines whether there is another sub-process within the identified process that must be accounted for. If there is, the method repeats starting at block 2020. Otherwise, the method proceeds to block 2045.

At block 2045, the modeling system updates the environmental impact vector V to reflect any process-level allocation. For example, if Eqn. 9 or Eqn. 11 is used, the modeling system may multiply the environmental impact vector V by the value of a obtained previously. As another example, if Eqn. 12 is used, for each value of k, the modeling system may subtract the value abₖ from Vₖ. If the system previously implemented sub-process-level allocation (i.e., Eqn. 8 or Eqn. 10) at blocks 2030-2035, the system may not perform block 2045. After block 2045, the method 2000 ends.

### 16. Modeling the Social Impact

FIG. 21 is flow diagram of a method 2100 for modeling the social cost of a functional unit of product. Like environmental impacts, social impacts (which may be social benefits or detrimental social impacts) may be allocated to the FU and/or useful co-products via one or more methods. For example, social impacts may be allocated in a manner described by one or more of the following equations:

$$\begin{matrix}{S}_{k} = {\sum }_{i} {α}_{i} {s}_{k , i} & ( Eqn . 13 ) \\ {S}_{k} = α {\sum }_{i} {s}_{k , i} & ( Eqn . 14 ) \\ {S}_{k} = α {s}_{k} & ( Eqn . 15 )\end{matrix}$$

In Eqn. 13 and Eqn. 14, the value s_{k,i} represents a particular type of social impact (k) that results from creating an FU and its coincident co-products via sub-process i. For example, it may represent the fractional number of highly-skilled jobs created by utilizing sub-process i instead of via a baseline conventional sub-process. In these equations, sₖ represents the total quantity of a particular type of social impact (k) collectively caused by all of the sub-processes during the production of the FU and coincident co-products (in many instances, it is equivalent to

$${\sum }_{i} {s}_{k , i}$$

). For example, it may represent the fractional number of highly-skilled jobs created by utilizing the identified process instead of via a baseline conventional process. The allocation variables α and αᵢ have the same meanings described above.

Referring again to FIG. 21, the method 2100 begins at block 2105, when the modeling system obtains information relating to the social impacts of producing the FU of primary product and its coincident co-products via the identified process. For example, the modeling system may receive from a user, a computer program, or another data source, the process-level social impacts (e.g., sₖ) and/or the sub-process-level impacts (e.g., s_{k,i}). These social impacts may be obtained in part by using a life cycle analysis computer program described previously or another type of computer program, or the impacts may be provided by a user or retrieved from the database or another source. In some examples, the social impacts may be obtained or derived from the results of social or economic studies. At block 2110, the modeling system may adjust the social impacts obtained at block 2105 in order reflect a “social credit” for utilizing a waste stream or other pollutant as an input to the identified process. These social credits may be made at the process or sub-process level. In a hypothetical example, the process shown in FIG. 15 might utilize a kilogram of biomass waste in order to produce an FU of electrical energy. Furthermore the hypothetical kilogram of biomass might normally result in a 0.005% increase in the incidence of gastrointestinal disease (e.g., thyphoid and Hepatitis A) that is indirectly caused by release of biowaste into the drinking supply. Thus, in this example, the use of a kg of biowaste as an input results in a 0.005% reduction in the incidence of gastrointestinal disease. In this hypothetical example, when modeling the process shown in FIG. 15, the modeling system might therefore credit the entry sₖ or s_{k,i} that is associated with the incidence of gastrointestinal disease. To provide the social credit, the modeling system may offset the existing value of s_{k,i} and/or sₖ obtained at block 2105 by a negative value or by scaling the existing value.

Although not shown in FIG. 21, if Eqn. 15 is used, the modeling system may skip blocks 615-542 altogether. Instead, the modeling system may add to each entry Vₖ the determined value sₖ (adjusted by any credits made at block 2110). In such examples, the modeling system may also determine the value of the allocation variable α (as described herein) before proceeding to block 645.

Otherwise, at block 2115, the modeling system repeats blocks 2120-2142 for each sub-process (i). At block 2120, the modeling system obtains the allocation variable(s) needed to properly calculate the social impact vector. For example:
if the modeling system uses Eqn. 13 to calculate the social impact vector, the system may obtain or update the value for the allocation variable αᵢ
if it uses Eqn. 14 or 15 then it may obtain or update the value for the allocation variable α,

To obtain one or more of these allocation variables, the modeling system may access values of αᵢ or α that were previously determined during the method of FIG. 4. Alternatively, or additionally, it may calculate or update these variables in the same manner described previously with respect to FIG. 19.

Next, at block 2125, the modeling system repeats blocks 630-640 for each social impact (k) for which information was obtained at block 605. At block 2130, the modeling system allocates or attributes some portion of the k-th social impact caused by the i-th sub-process by using an allocation variable. If the system uses Eqn. 13 to allocate the impact, the modeling system may for example determine the product αᵢs_{k,i}. The modeling system may not perform block 2130 if Eqn. 14 or Eqn. 15 is used, and may instead perform a system-level allocation of the impact at block 2145.

At block 2135, the modeling system may update Sₖ to reflect the allocated social impact of the i-th sub-process. For example, the modeling system may add the quantity αᵢs_{k,i} to Sₖ. If instead Eqn. 14 is used, the system may simply add s_{k,i} to Sₖ.

At decision block 2140, the modeling system determines if there is another, different social impact implicated by the sub-process i that must be accounted for. If there is, the method repeats at block 2130. Otherwise, the method proceeds to decision block 2142 where the modeling system determines whether there is another sub-process within the identified process that must be accounted for. If there is, the method repeats starting at block 2120. Otherwise, the method proceeds to block 2145.

At block 2145, the modeling system updates the social impact vector S to reflect any process-level allocation. For example, if Eqn. 14 or Eqn. 15 is used, the modeling system may multiply the social impact vector S by the value of α obtained previously. If the system previously implemented sub-process-level allocation (i.e., Eqn. 13) at blocks 2130-2135, the system may not perform block 2145. After block 2145, the method 2100 ends.

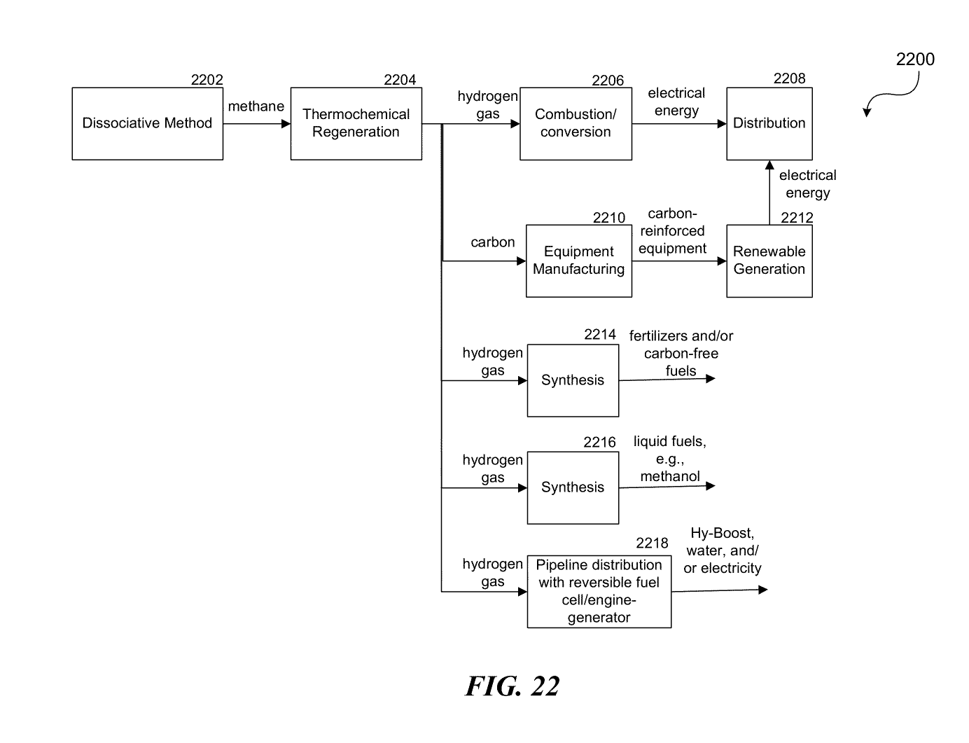

FIG. 22 illustrates block diagrams of aspects of the disclosure including:

1) Dissociation of anything with carbon content that can rot or burn to produce carbon to manufacture equipment to harness renewable energy and thus produce thousands of times more energy.

2) Utilization of such dissociation and or electrolysis to provide hydrogen that can be stored and shipped as liquid fuels such methanol (wet or dry) in existing fuel tanks to provide convenient conversion to thermochemical regeneration and Smart Plug operation.

3) Utilization of such dissociation and/or electrolysis to provide hydrogen for production of designer liquid fuels that provide 130 to 200% greater fuel efficiency and range by thermochemical regeneration and Smart Plug operation.

4) Utilization of such dissociation and/or electrolysis to provide hydrogen for production of carbon free liquid fuels such as ammonia and designer fertilizers.

5) Utilization of such dissociation and/or electrolysis to provide hydrogen for mixed distribution in existing natural gas infrastructure (pipelines and wells etc.) and selective extraction/filtration to deliver hydrogen, Hy-Boost mixtures, water or electricity by a reversible fuel cell or engine-generator.

### 17. Modeling the Harm of Toxic Nuclear Waste

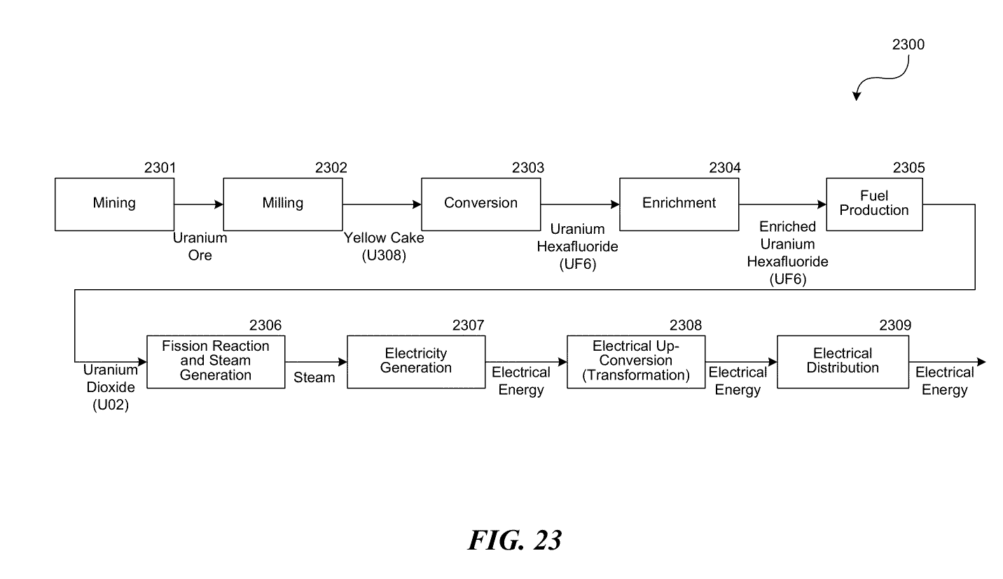

FIG. 23 is a system block diagram of the steps in preparation of nuclear fuel to produce electricity.

### 18. Modeling the Harm of Burning Carbon

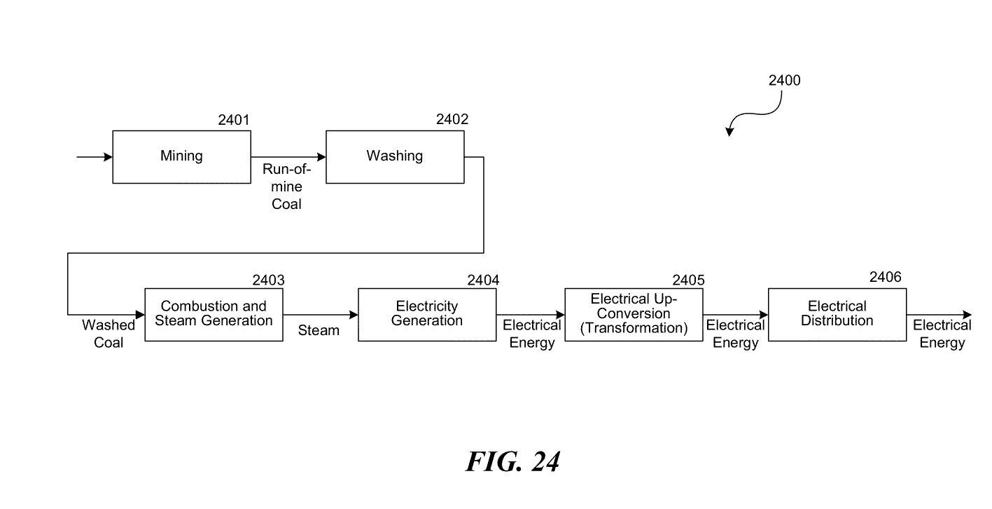

FIG. 24 is a system block of the step in preparation of coal for burning to produce electricity

### 19. Sustainability Certification

FIG. 25 is a system block diagram of Module 7: Sustainability Certification process, as shown in block 1310 (based on items first introduced in FIG. 13). This module is a software program that facilitates a collaborative dialogue with project leaders, decision-makers and community developers who desire approval and public recognition of achieving excellence in sustainability. The business process of certification development and delivery has three parts: Publish Standards, as shown in block 2607; Advocacy for Standards of Sustainability, as shown in block 2504, and Reward Successful Implementation, as shown in block 2506.

The process of Publish Standards, block 2502, involves education and training in the use of those standards as the method of dissemination, and teaching the general public that there are new and emerging paradigms of renewable energy which completely redefine what is possible. In the building of brand (like Diamond Green™ Sustainability) there is a public relations process of establishing a mark which stands for certain standards. The publishing process is one of the ways that the program takes a stand for certain quality standards. Finally there is a collaborative and iterative process of improving Sustainability Indicators and Sustainability standards as participants in the program give their report of what works and doesn't work in their experience.

The process of Advocacy for Standards of Sustainability, block 2504, involves a series of information and education initiatives: First of all, is an affirmation that Science and Critical Thinking are at the bedrock foundation of sustainability, second that social equity and justice are also high values of the program, and third is advocacy for environmental protection and conservation. Dialogue in the public media forum provides opportunities to confront denial of the seriousness of global warming, climate change, pollution, oil spills, depletion of key resources, and the burning of carbon. Third, there is an affirmation the program is one of ongoing empirical measurement. Fourth is education and training specifically about selected advocacy. Fifth, the adoption of new technology enables engagement with social and economic institutions which serve as allies or as barriers to the process.

The Final Step in the business process is Reward Successful Implementation, block 2506. This involves maintenance of the brand program to build credibility and understanding of the sustainability certification, and conducting publicity and tours to reward awardees in their achievement. Demonstrations of the new renewable energy technology are also an important part of public awareness and market positioning.

### 20. Conclusion

From the foregoing, it will be appreciated that specific examples of comprehensive cost modeling systems have been described herein for purposes of illustration, but that various modifications may be made without deviating from the spirit and scope of the system. Accordingly, the system is not limited except as by the appended claims.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the system is not intended to be exhaustive or to limit the system to the precise form disclosed above. While specific embodiments of, and examples for, the system are described above for illustrative purposes, various equivalent modifications are possible within the scope of the system, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the system provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

These and other changes can be made to the system in light of the above Detailed Description. While the above description details certain embodiments of the system and describes the best mode contemplated, no matter how detailed the above appears in text, the system can be practiced in many ways. Details of the system may vary considerably in implementation details, while still being encompassed by the system disclosed herein. As noted above, particular terminology used when describing certain features or aspects of the system should not be taken to imply that the terminology is being redefined herein to be restricted to any specific characteristics, features, or aspects of the system with which that terminology is associated. In general, the terms used in the following claims should not be construed to limit the system to the specific embodiments disclosed in the specification, unless the above Detailed Description section explicitly defines such terms. Accordingly, the actual scope of the system encompasses not only the disclosed embodiments, but also all equivalent ways of practicing or implementing the system under the claims.

While certain aspects of the invention are presented below in certain claim forms, the inventors contemplate the various aspects of the invention in any number of claim forms. For example, although only some aspects of the invention are recited as embodied in a computer-readable medium, other aspects may likewise be embodied in a computer-readable medium. Accordingly, the inventors reserve the right to add additional claims after filing the application to pursue such additional claim forms for other aspects of the invention.

I/We claim:

1. A method for determining a total economic cost of producing a specified functional unit of primary product via a specified autogenous production process, the method comprising:
obtaining a set of pecuniary parameters related to a direct pecuniary production cost of producing the specified functional unit of primary product via the specified autogenous production process;
determining the direct pecuniary production cost of producing the specified functional unit of primary product via the specified autogenous production process using the obtained set of pecuniary parameters;
obtaining a set of environmental impact parameters related to environmental impacts of producing the specified functional unit of primary product via the specified autogenous production process;
determining an environmental impact vector using the obtained set of environmental impact parameters, wherein the environmental impact vector reflects both depletion of finite resources and emissions of pollutants caused by producing the specified functional unit of primary product via the specified autogenous production process; and,
evaluating a valuation function that operates on at least the determined direct pecuniary production cost and environmental impact vector in order to determine a total economic cost of producing the specified functional unit of primary product via the specified autogenous production process.

2. The method of claim 1, further comprising:
obtaining a set of social impact parameters related to social impacts of producing the specified functional unit of primary product via the specified autogenous production process; and,
determining a social impact vector using the obtained set of social impact parameters;
wherein the valuation function also operates on at least the determined social impact vector.

3. The method of claim 2, wherein the social impact vector reflects a social benefit that results by producing the specified functional unit via the specified process instead of producing the specified functional unit by a conventional, baseline process.

4. The method of claim 1, wherein both determining the direct pecuniary production cost and the environmental impact vector further comprise determining and applying an allocation variable, wherein the allocation variable reflects an economic usefulness of any co-products and co-services produced by the specified process.

5. The method of claim 1, wherein determining the environmental impact vector further comprises applying a credit for environmental pollutants utilized as inputs to the specified autogenous production process.

6. The method of claim 1, wherein:
the specified autogenous production process comprises at least two sub-processes;
the specified autogenous production process both:
captures a pollutant produced by a first sub-process; and,
utilizes the captured pollutant to produce a useful co-product via a second sub-process; and,
the determined total economic cost reflects an economic benefit from capturing the pollutant and an economic benefit from utilizing the captured pollutant.

7. The method of claim 1, wherein the specified autogenous production process is decoupled from a global supply chain by utilizing local renewable inputs and producing products usable by a local population.

8. The method of claim 1, wherein:
the set of pecuniary parameters obtained includes an amortization lifetime of capital equipment utilized in the specified autogenous production process; and
the amortization lifetime reflects the benefits of a regenerative method of maintaining the capital equipment that is implemented at least in part by the specified autogenous production process.

9. The method of claim 1, wherein the functional unit is a unit of electrical energy.

10. The method of claim 1, wherein the functional unit is a unit of fuel.

11. The method of claim 1, wherein the specified autogenous production process forms a part of a larger autogenous process that is capable of producing energy, material resources, and nutrient regimes, and wherein at least one co-product of the specified autogenous production process is utilized as an input to another portion of the larger autogenous process.

12. The method of claim 1, wherein the specified autogenous production process comprises at least a dissociation sub-process, a thermochemical regeneration sub-process, and a combustion and electrical conversion sub-process.

13. The method of claim 1, wherein the determined total economic cost reflects an economic benefit from utilizing repurposed capital equipment available from a source that is local to a site where the specified autogenous production process is performed.

14. The method of claim 1, wherein the determined total economic cost reflects an economic benefit from utilizing a biowaste feedstock as input to the specified autogenous production process; and wherein the economic benefit includes both reduced direct pecuniary costs and reduced environmental impact.

15. The method of claim 1, wherein the functional unit is a unit of durable goods.

16. The method of claim 1, wherein the functional unit is a unit of agricultural products.

17. The method of claim 1, wherein the determined total economic cost reflects the economic cost of depleting finite material resources.

18. The method of claim 1, wherein evaluating the valuation function, further comprises applying both:
a first economic weighting vector that represents an approximate economic cost attributable to depleted resources and emitted pollutants; and,
a second economic weighting vector that represents an approximate economic cost or benefit attributable to various social impacts.

19. The method of claim 18, wherein at least some of entries in the first and second economic weighting vectors are generated by empirical or theoretical economic studies.

20. The method of claim 1, wherein evaluating the valuation function further comprises applying non-linear operators to the environmental impact vector.

21. The method of claim 1, further comprising determining a total economic cost of producing the same specified functional unit of primary product via a specified depletive production process, wherein this value is calculated via substantially the same method utilized to determine the total economic cost of producing the specified functional unit of primary product via the specified autogenous production process.

22. A method for modeling a total economic cost of producing a specified functional unit of primary product via a specified production process, the method comprising:
determining one or more allocation variables;
determining a direct pecuniary production cost associated with producing the specified functional unit of primary product via the specified production process, wherein this determination further comprises:
utilizing at least one of the determined allocation variables to identify a portion of direct pecuniary production costs attributable to the production of the specified functional unit;
determining an environmental impact vector, wherein the environmental impact vector reflects both depletion of finite resources and emissions of pollutants caused by producing the specified functional unit of primary product via the specified production process, and wherein this determination further comprises:
utilizing at least one of the determined allocation variables to identify a portion of environmental impacts attributable to the production of the specified functional unit;
determining a social impact vector, wherein this determination further comprises:
utilizing at least one of the determined allocation variables to identify a portion of social impacts attributable to the production of the specified functional unit; and,
evaluating a valuation function that operates on the determined direct pecuniary production cost, environmental impact vector, and social impact vector in order to determine the total economic cost of producing a specified functional unit of primary product via the specified production process.

23. The method of claim 22, wherein determining an environmental impact vector further comprises applying a credit for environmental pollutants utilized as inputs to the specified production process.

24. The method of claim 22, wherein at least one of the determined allocation variables reflects a ratio of various outputs of the specified production process.

25. The method of claim 22, wherein at least one of the determined allocation variables reflects a fair market value of any co-products produced by the specified production process.

26. The method of claim 22, wherein at least one of the determined allocation variables reflects an averted environmental burden associated with a production of the specified functional unit via a baseline, conventional production process.

27. A computer-readable storage medium having computer-executable instructions that, when executed by a computer perform a method for determining a total economic cost of producing a specified functional unit of primary product via a specified autogenous production process, wherein the method comprises:
obtaining a set of pecuniary parameters related to a direct pecuniary production cost of producing the specified functional unit of primary product via the specified autogenous production process;
determining the direct pecuniary production cost of producing the specified functional unit of primary product via the specified autogenous production process using the obtained set of pecuniary parameters;
obtaining a set of environmental impact parameters related to environmental impacts of producing the specified functional unit of primary product via the specified autogenous production process;
determining an environmental impact vector using the obtained set of environmental impact parameters, wherein the environmental impact vector reflects both depletion of finite resources and emissions of pollutants caused by producing the specified functional unit of primary product via the specified autogenous production process; and,
evaluating a valuation function that operates on at least the determined direct pecuniary production cost and environmental impact vector in order to determine a total economic cost of producing the specified functional unit of primary product via the specified autogenous production process.

28. A system for modeling a total economic cost of producing a specified functional unit of primary product via a specified production process, the system comprising:
an allocation module configured to determine one or more allocation variables;
a pecuniary cost module configured to determine a direct pecuniary production cost associated with producing the specified functional unit of primary product via the specified production process, wherein this determination further comprises:
utilizing at least one of the determined allocation variables to identify a portion of direct pecuniary production costs attributable to the production of the specified functional unit;
an environmental impact module configured to determine an environmental impact vector, wherein the environmental impact vector reflects both depletion of finite resources and emissions of pollutants caused by producing the specified functional unit of primary product via the specified production process, and wherein this determination further comprises:
utilizing at least one of the determined allocation variables to identify a portion of environmental impacts attributable to the production of the specified functional unit;
a social impact module configured to determine a social impact vector, wherein this determination further comprises:
utilizing at least one of the determined allocation variables to identify a portion of social impacts attributable to the production of the specified functional unit; and,
a valuation module configured to evaluate a valuation function that operates on the determined direct pecuniary production cost, environmental impact vector, and social impact vector in order to determine the total economic cost of producing a specified functional unit of primary product via the specified production process.
